(19) United States
(12) Patent Application Publication
(10) Pub. No.: US 2016/0035229 A1
(43) Pub. Date: Feb. 4, 2016

(54) EXERCISE ANALYSIS METHOD, EXERCISE ANALYSIS APPARATUS, EXERCISE ANALYSIS SYSTEM, EXERCISE ANALYSIS PROGRAM, PHYSICAL ACTIVITY ASSISTING METHOD, PHYSICAL ACTIVITY ASSISTING APPARATUS, AND PHYSICAL ACTIVITY ASSISTING PROGRAM

(71) Applicant: Seiko Epson Corporation, Shinjuku-ku (JP)

(72) Inventors: Shuji UCHIDA, Shiojiri-shi (JP); Shunichi MIZUOCHI, Matsumoto-shi (JP); Kazumi MATSUMOTO, Shiojiri-shi (JP); Ken WATANABE, Matsumoto-shi (JP); Daisuke SUGIYA, Chino-shi (JP); Akinobu SATO, Fujimi-machi (JP)

(21) Appl. No.: 14/814,468

(22) Filed: Jul. 30, 2015

(30) Foreign Application Priority Data
Jul. 31, 2014 (JP) 2014-157200
Jul. 31, 2014 (JP) 2014-157202
Jun. 5, 2015 (JP) 2015-115209

(51) Int. Cl. G09B 5/00; G09B 21/00

(52) U.S. Cl. CPC G09B 5/00; G09B 21/00

(57) ABSTRACT

An exercise analysis method includes analyzing an exercise of a user by using a detection result from an inertial sensor, and generating a plurality of exercise information pieces of the user during the exercise, presenting a comparison result between at least one of the plurality of exercise information pieces and a reference value which is set in advance during the user's exercise, and presenting at least one of the plurality of exercise information pieces after the user's exercise is finished.

### BACKGROUND

1. Technical Field

The present invention relates to an exercise analysis method, an exercise analysis apparatus, an exercise analysis system, an exercise analysis program, a physical activity assisting method, a physical activity assisting apparatus, and a physical activity assisting program.

2. Related Art

JP-A-2008-237832 discloses a walking navigation system which can diagnose whether or not the way of walking is correct when a user walks for a long period of time wearing constantly used shoes, and can present the bad way of walking to the user during walking in real time.

JP-A-2012-217847 discloses a fitness monitoring method of scheduling training activities on the basis of a user's input operation and of providing an instruction for the training activities.

In order to improve exercise attainments, a user can preferably understand whether or not motions of the user are correct during the exercise, but since a large-sized monitor or the like cannot be used in a restricted environment during the user's exercise, information which can be easily understood by the user is restricted. Therefore, in a case where presented information during the user's exercise is too complex or too much, there is a problem in that the user does not correctly understand the presented information, and the present information is unlikely to be used to improve exercise attainments.

In the method disclosed in JP-A-2012-217847, a target or a schedule can be set, but, for example, a target or a schedule considering a difference between purposes such as a diet and the running way of being efficient in terms of energy cannot be set. The user can preferably understand whether or not motions of the user are correct during an activity, but information which can be easily understood by the user is restricted. Therefore, in a case where presented information during the user's activity is too complex or too much, there is a problem in which the user cannot correctly understand the presented information, and thus the present information is unlikely to be used.

### SUMMARY

An advantage of some aspects of the invention is to provide an exercise analysis method, an exercise analysis apparatus, an exercise analysis system, and an exercise analysis program, capable of assisting a user in improving exercise attainments.

Another advantage of some aspects of the invention is to provide a physical activity assisting method, a physical activity assisting apparatus, and a physical activity assisting program, capable of effectively assisting a user in a physical activity.

The invention can be implemented as the following forms or application examples.

### Application Example 1

An exercise analysis method according to this application example includes: analyzing an exercise of a user by using a detection result from an inertial sensor, and generating a plurality of exercise information pieces of the user during the exercise; presenting a comparison result between at least one of the plurality of exercise information pieces and a reference value which is set in advance during the user's exercise; and presenting at least one of the plurality of exercise information pieces after the user's exercise is finished.

According to the exercise analysis method of this application example, since a comparison result between at least one of a plurality of exercise information pieces and a reference value which is set in advance is presented during the user's exercise, the user can easily utilize the presented information during the exercise. Since information based on some exercise information pieces which are generated during the exercise is presented after the user's exercise is finished, the user can also easily utilize the presented information after the exercise is finished. Therefore, it is possible to assist the user in improving exercise attainments (for example, running performance, a score of time or the like, or unlikelihood of an injury).

### Application Example 2

An exercise analysis method according to this application example includes: analyzing an exercise of a user by using a detection result from an inertial sensor, and generating a plurality of exercise information pieces of the user during the exercise; presenting at least one of the plurality of exercise information pieces during the user's exercise; and presenting at least one of the plurality of exercise information pieces after the user's exercise is finished. The exercise information presented during the user's exercise may include information regarding an advice for improving exercise attainments of the user.

The exercise attainments may be, for example, running performance, a score of time or the like, or unlikelihood of an injury.

According to the exercise analysis method of this application example, an advice corresponding to an exercise state is presented during the user's exercise, and thus it is possible to assist the user in improving exercise attainments.

### Application Example 3

In the exercise analysis method according to the application example, the exercise information presented after the user's exercise is finished may include exercise information which is not presented during the user's exercise among the plurality of exercise information pieces.

According to the exercise analysis method of this application example, information which is not presented during the user's exercise is also provided after the exercise is finished, and thus it is possible to assist the user in improving exercise attainments.

### Application Example 4

In the exercise analysis method according to the application example, the exercise information presented after the user's exercise is finished may include exercise information which is presented during the user's exercise among the plurality of exercise information pieces.

According to the exercise analysis method of this application example, information which is presented during the user's exercise is also presented after the exercise is finished, and thus the user can recognize an exercise state which cannot be recognized during the exercise, after the exercise is finished. Therefore, it is possible to assist the user in improving exercise attainments.

### Application Example 5

In the exercise analysis method according to the application example, the exercise information presented after the user's exercise is finished may include information regarding an advice for improving exercise attainments of the user.

According to the exercise analysis method of this application example, since an advice corresponding to an exercise result is presented after the user's exercise is finished, it is possible to assist the user in improving exercise attainments.

### Application Example 6

In the exercise analysis method according to the application example, the exercise information presented after the user's exercise is finished may include information which is generated after the user's exercise is finished.

According to the exercise analysis method of this application example, information which is not required to be presented during the user's exercise is preferably generated after the exercise is finished, and thus it is possible to reduce a processing load during the exercise.

### Application Example 7

An exercise analysis apparatus according to this application example includes: an exercise information generation unit that analyzes an exercise of a user by using a detection result from an inertial sensor, and generates a plurality of exercise information pieces of the user during the exercise; an output-information-during-exercise generation unit that generates output information during exercise which is output during the user's exercise on the basis of a comparison result between at least one of the plurality of exercise information pieces and a reference value which is set in advance; and an output-information-after-exercise generation unit that generates output information after exercise which is information output after the user's exercise is finished, on the basis of at least one of the plurality of exercise information pieces.

According to the exercise analysis apparatus of this application example, since a comparison result between at least one of a plurality of exercise information pieces and a reference value which is set in advance is output during the user's exercise, the user can easily utilize the presented information during the exercise. Since information based on some exercise information pieces which are generated during the exercise is output after the user's exercise is finished, the user can also easily utilize the presented information after the exercise is finished. Therefore, it is possible to assist the user in improving exercise attainments.

### Application Example 8

An exercise analysis system according to this application example includes: an exercise analysis apparatus that analyzes an exercise of a user by using a detection result from an inertial sensor, and generates a plurality of exercise information pieces of the user during the exercise; a first display apparatus that outputs a comparison result between at least one of the plurality of exercise information pieces and a reference value which is set in advance during the user's exercise; and a second display apparatus that outputs at least one of the plurality of exercise information pieces after the user's exercise is finished.

The first display apparatus and the second display apparatus may be the same apparatus, and may be separate apparatuses.

According to the exercise analysis system of this application example, since the first display apparatus outputs a comparison result between at least one of a plurality of exercise information pieces generated by the exercise analysis apparatus and a reference value which is set in advance during the user's exercise, the user can easily utilize the presented information during the exercise. Since the second display apparatus outputs information based on some exercise information pieces which are generated during the exercise after the user's exercise is finished, the user can also easily utilize the presented information after the exercise is finished. Therefore, it is possible to assist the user in improving exercise attainments.

### Application Example 9

An exercise analysis program according to this application example causes a computer to execute: analyzing an exercise of a user by using a detection result from an inertial sensor, and generating a plurality of exercise information pieces of the user during the exercise; outputting a comparison result between at least one of the plurality of exercise information pieces and a reference value which is set in advance during the user's exercise; and outputting at least one of the plurality of exercise information pieces after the user's exercise is finished.

According to the exercise analysis program of this application example, since a comparison result between at least one of a plurality of exercise information pieces and a reference value which is set in advance is output during the user's exercise, the user can easily utilize the presented information during the exercise. Since information based on some exercise information pieces which are generated during the exercise is output after the user's exercise is finished, the user can also easily utilize the presented information after the exercise is finished. Therefore, it is possible to assist the user in improving exercise attainments.

### Application Example 10

A physical activity assisting method according to this application example includes: detecting a physical activity of a user with a sensor, and performing calculation regarding the physical activity by using a detection result from the sensor; selecting a certain advice mode from a plurality of advice modes in which determination items are set; and determining whether or not a result of the calculation satisfies the determination item which is set in the selected advice mode.

According to the physical activity assisting method of this application example, since it is determined whether or not a determination item set in a selected advice mode is satisfied, it is possible to effectively assist a physical activity of the user.

### Application Example 11

In the physical activity assisting method according to the application example, in a case where the result of the calculation satisfies the determination item which is set in the selected advice mode, advice information for sending a notification of a state of the physical activity may be presented.

According to the physical activity assisting method of this application example, in a case where a determination item set in a selected advice mode is satisfied, advice information for sending a notification of a state of a physical activity of the user is presented, and thus it is possible to effectively assist a physical activity of the user.

### Application Example 12

In the physical activity assisting method according to the application example, the plurality of advice modes may include a plurality of modes in which purposes of the physical activity are different from each other.

According to the physical activity assisting method of this application example, for example, it is possible to present advice information suitable for a purpose of a physical activity of the user.

### Application Example 13

In the physical activity assisting method according to the application example, the plurality of advice modes may include at least a mode of aiming at improving efficiency of the physical activity and a mode of aiming at energy consumption in the physical activity.

According to the physical activity assisting method of this application example, for example, it is possible to present advice information suitable for improving efficiency of a physical activity or advice information suitable for energy consumption in a physical activity.

### Application Example 14

In the physical activity assisting method according to the application example, the plurality of advice modes may include a plurality of modes in which the types of physical activities are different from each other.

According to the physical activity assisting method of this application example, for example, it is possible to present advice information suitable for the type of physical activity of the user.

### Application Example 15

In the physical activity assisting method according to the application example, the types of physical activities may be the types of running.

According to the physical activity assisting method of this application example, for example, it is possible to present advice information suitable for the type of running.

### Application Example 16

In the physical activity assisting method according to the application example, the certain advice mode may be selected on the basis of a purpose of running and a distance of the running.

According to the physical activity assisting method of this application example, for example, it is possible to present advice information suitable for a purpose of running and a distance of the running.

### Application Example 17

In the physical activity assisting method according to the application example may further include determining whether or not a state of the physical activity or the result of the calculation is abnormal by using the result of the calculation; and presenting information indicating that the state of the physical activity or the result of the calculation is abnormal in a case where it is determined that the state of the physical activity or the result of the calculation is abnormal.

According to the physical activity assisting method of this application example, in a case where a state of a physical activity or a calculation result enters an abnormal state during the user's running, it is possible to present the occurrence of the abnormality to user.

### Application Example 18

In the physical activity assisting method according to the application example, the sensor may be an inertial sensor.

### Application Example 19

A physical activity assisting apparatus according to this application example includes: a calculation unit that detects a physical activity of a user with a sensor, and performs calculation regarding the physical activity by using a detection result from the sensor; and a detection unit that selects a certain advice mode from a plurality of advice modes in which determination items are set, and determines whether or not a result of the calculation satisfies the determination item which is set in the selected advice mode.

According to the physical activity assisting apparatus of this application example, since it is determined whether or not a determination item set in a selected advice mode is satisfied, it is possible to effectively assist a physical activity of the user.

### Application Example 20

A physical activity assisting program according to this application example causes a computer to execute: detecting a physical activity of a user with a sensor, and performing calculation regarding the physical activity by using a detection result from the sensor; selecting a certain advice mode from a plurality of advice modes in which determination items are set; and determining whether or not a result of the calculation satisfies the determination item which is set in the selected advice mode.

According to the physical activity assisting program of this application example, since it is determined whether or not a determination item set in a selected advice mode is satisfied, it is possible to effectively assist a physical activity of the user.

### BRIEF DESCRIPTION OF THE DRAWINGS

The invention will be described with reference to the accompanying drawings, wherein like numbers reference like elements.

FIG. 1 is a diagram illustrating a summary of an exercise analysis system of a first embodiment.

FIG. 2 is a functional block diagram illustrating a configuration example of an exercise analysis apparatus and a display apparatus in the first embodiment.

FIG. 3 is a diagram illustrating a configuration example of a sensing data table.

FIG. 4 is a diagram illustrating a configuration example of a GPS data table.

FIG. 5 is a diagram illustrating a configuration example of a geomagnetic data table.

FIG. 6 is a diagram illustrating a configuration example of a calculated data table.

FIG. 7 is a functional block diagram illustrating a configuration example of a processing unit of the exercise analysis apparatus in the first embodiment.

FIG. 8 is a functional block diagram illustrating a configuration example of an inertial navigation calculation unit in the first embodiment.

FIG. 9 is a diagram illustrating an attitude during a user's running.

FIG. 10 is a diagram illustrating a yaw angle during the user's running.

FIG. 11 is a diagram illustrating an example of three-axis accelerations during the user's running.

FIG. 12 is a functional block diagram illustrating a configuration example of an exercise analysis unit in the first embodiment.

FIG. 13 is a diagram illustrating a method of determining timings of landing and taking-off (kicking).

FIG. 14 is a diagram illustrating a method of determining a timing of stepping.

FIG. 15 is a diagram illustrating a relationship between input information and analysis information.

FIG. 16 illustrates an example of an advancing direction acceleration, a vertical acceleration, and a horizontal acceleration.

FIG. 17 illustrates an example of an advancing direction velocity, a vertical velocity, and a horizontal velocity.

FIG. 18 is a diagram illustrating an example of an acceleration in a roll angle, an acceleration in a pitch angle, and an acceleration in a yaw angle.

FIG. 19 is a diagram illustrating an example of a roll angle, a pitch angle, and a yaw angle.

FIG. 20 is a diagram illustrating an example of an advancing direction distance, a vertical distance, and a horizontal distance.

FIG. 21 is a diagram illustrating a method of computing an impact time.

FIG. 22 is a diagram illustrating a method of computing a brake amount 1 in landing.

FIG. 23 is a diagram illustrating a method of computing a brake amount 2 in landing.

FIG. 24 is a diagram illustrating a method of computing a directly-below landing ratio 1.

FIG. 25 is a diagram illustrating a method of computing a directly-below landing ratio 2.

FIG. 26 is a diagram illustrating a method of computing a directly-below landing ratio 3.

FIG. 27 is a diagram illustrating a method of computing a propulsion force 1.

FIG. 28 is a diagram illustrating a method of computing a propulsion force 2.

FIG. 29 is a diagram illustrating a method of computing propulsion efficiency 1.

FIG. 30 is a diagram illustrating a method of computing propulsion efficiency 2.

FIG. 31 is a diagram illustrating a method of computing propulsion efficiency 3.

FIG. 32 is a diagram illustrating a forward tilt angle.

FIGS. 33A and 33B illustrate examples of a relationship between a waist rotation timing and a kicking timing.

FIGS. 34A and 34B illustrate examples of a screen which is displayed during the user's running.

FIG. 35 is a diagram illustrating an example of a whole analysis screen.

FIG. 36 is a diagram illustrating an example of the whole analysis screen.

FIG. 37 is a diagram illustrating an example of a detail analysis screen.

FIG. 38 is a diagram illustrating an example of the detail analysis screen.

FIG. 39 is a diagram illustrating an example of the detail analysis screen.

FIG. 40 is a diagram illustrating an example of a comparison analysis screen.

FIG. 41 is a flowchart illustrating an example of procedures of an exercise analysis process in the first embodiment.

FIG. 42 is a flowchart illustrating an example of procedures of an inertial navigation calculation process in the first embodiment.

FIG. 43 is a flowchart illustrating an example of procedures of a running detection process.

FIG. 44 is a flowchart illustrating an example of procedures of an exercise analysis information generation process.

FIG. 45 is a flowchart illustrating an example of procedures of a running analysis process.

FIG. 46 is a diagram illustrating a summary of a physical activity assisting system of a second embodiment.

FIG. 47 is a functional block diagram illustrating configuration examples of a physical activity assisting apparatus and a display apparatus in the second embodiment.

FIG. 48 is a diagram illustrating a configuration example of an analysis data table.

FIG. 49 is a functional block diagram illustrating a configuration example of a processing unit of the physical activity assisting apparatus in the second embodiment.

FIG. 50 is a functional block diagram illustrating a configuration example of an inertial navigation calculation unit in the second embodiment.

FIG. 51 is a diagram illustrating a correspondence table of an analysis mode, the type of running, an advice mode, and a determination item.

FIG. 52 is a functional block diagram illustrating a configuration example of an exercise analysis unit in the second embodiment.

FIG. 53 is a flowchart illustrating an example of procedures of a running assisting process.

FIG. 54 is a flowchart illustrating an example of procedures of an inertial navigation calculation process in the second embodiment.

FIG. 55 is a flowchart illustrating an example of procedures of a running process.

FIG. 56 is a flowchart illustrating an example of procedures of an exercise analysis process performed in the second embodiment.

FIGS. 57A and 57B illustrate a method of computing a deceleration amount.

FIG. 58 is a diagram illustrating another example of a screen displayed during a user's running.

FIG. 59 is a diagram illustrating another example of the whole analysis screen.

FIG. 60 is a diagram illustrating an example of comparison analysis.

FIG. 61 is a diagram illustrating an example of comparison analysis.

FIG. 62 is a diagram illustrating a configuration example of an exercise analysis system of a modification example.

### DESCRIPTION OF EXEMPLARY EMBODIMENTS

An exercise analysis method of the present embodiment includes analyzing an exercise of a user by using a detection result from an inertial sensor, and generating a plurality of exercise information pieces of the user during the exercise; presenting exercise information which satisfies a predetermined condition among the plurality of exercise information pieces during the user's exercise; and presenting at least one of the plurality of exercise information pieces after the user's exercise is finished.

According to the exercise analysis method of the present embodiment, since information which is generated on the basis of exercise information satisfying a predetermined condition according to an exercise state is presented during the user's exercise, the user can easily utilize the presented information during the exercise. Since information based on some exercise information pieces which are generated during the exercise is presented after the user's exercise is finished, the user can also easily utilize the presented information after the exercise is finished. Therefore, it is possible to assist the user in improving exercise attainments (for example, running performance, a score of time or the like, or unlikelihood of an injury).

In the exercise analysis method of the present embodiment, the predetermined condition may include that an exercise state of the user is better than a reference.

According to the exercise analysis method of the present embodiment, the user can perform an exercise while recognizing that an exercise state of the user is good.

In the exercise analysis method of the present embodiment, the predetermined condition may include that an exercise state of the user is worse than a reference.

According to the exercise analysis method of the present embodiment, the user can perform an exercise while recognizing that an exercise state of the user is bad.

In the exercise analysis method of the present embodiment, the exercise information presented during the user's exercise may include information regarding an advice for improving exercise attainments of the user.

The exercise attainments may be, for example, running performance, a score of time or the like, or unlikelihood of an injury.

According to the exercise analysis method of the present embodiment, an advice corresponding to an exercise state is presented during the user's exercise, and thus it is possible to assist the user in improving exercise attainments.

In the exercise analysis method of the present embodiment, the exercise information presented after the user's exercise is finished may include exercise information which is not presented during the user's exercise among the plurality of exercise information pieces.

According to the exercise analysis method of the present embodiment, information which is not presented during the user's exercise is also provided after the exercise is finished, and thus it is possible to assist the user in improving exercise attainments.

In the exercise analysis method of the present embodiment, the exercise information presented after the user's exercise is finished may include exercise information which is presented during the user's exercise among the plurality of exercise information pieces.

According to the exercise analysis method of the present embodiment, information which is presented during the user's exercise is also presented after the exercise is finished, and thus the user can recognize an exercise state which cannot be recognized during the exercise, after the exercise is finished. Therefore, it is possible to assist the user in improving exercise attainments.

In the exercise analysis method of the present embodiment, the exercise information presented after the user's exercise is finished may include information regarding an advice for improving exercise attainments of the user.

According to the exercise analysis method of the present embodiment, since an advice corresponding to an exercise result is presented after the user's exercise is finished, it is possible to assist the user in improving exercise attainments.

In the exercise analysis method of the present embodiment, the exercise information presented after the user's exercise is finished may include information which is generated after the user's exercise is finished.

According to the exercise analysis method of the present embodiment, information which is not required to be presented during the user's exercise is preferably generated after the exercise is finished, and thus it is possible to reduce a processing load during the exercise.

An exercise analysis apparatus of the present embodiment includes an exercise information generation unit that analyzes an exercise of a user by using a detection result from an inertial sensor, and generates a plurality of exercise information pieces of the user during the exercise; an output-information-during-exercise generation unit that generates output information during exercise which is output during the user's exercise on the basis of at least one exercise information piece satisfying a predetermined condition among the plurality of exercise information pieces; and an output-information-after-exercise generation unit that generates output information after exercise which is information output after the user's exercise is finished on the basis of at least one exercise information piece satisfying a predetermined condition.

According to the exercise analysis apparatus of the present embodiment, since information which is generated on the basis of exercise information satisfying a predetermined condition according to an exercise state is output during the user's exercise, the user can easily utilize the presented information during the exercise. Since information based on some exercise information pieces which are generated during the exercise is output after the user's exercise is finished, the user can also easily utilize the presented information after the exercise is finished. Therefore, it is possible to assist the user in improving exercise attainments.

An exercise analysis system of the present embodiment includes an exercise analysis apparatus that analyzes an exercise of a user by using a detection result from an inertial sensor, and generates a plurality of exercise information pieces of the user; a first display apparatus that outputs exercise information satisfying a predetermined condition among the plurality of exercise information pieces during the user's exercise; and a second display apparatus that outputs at least one of the plurality of exercise information pieces after the user's exercise is finished.

The first display apparatus and the second display apparatus may be the same apparatus, and may be separate apparatuses.

According to the exercise analysis system of the present embodiment, since the first display apparatus outputs exercise information satisfying a predetermined condition among a plurality of exercise information pieces generated by the exercise analysis apparatus during the user's exercise, the user can easily utilize the presented information during the exercise. Since the second apparatus outputs information based on some exercise information pieces which are generated by the exercise analysis apparatus during the exercise after the user's exercise is finished, the user can also easily utilize the presented information after the exercise is finished. Therefore, it is possible to assist the user in improving exercise attainments.

A program of the present embodiment causes a computer to execute analyzing an exercise of a user by using a detection result from an inertial sensor, and generating a plurality of exercise information pieces of the user; outputting exercise information satisfying a predetermined condition among the plurality of exercise information pieces during the user's exercise; and outputting at least one of the plurality of exercise information pieces after the user's exercise is finished.

In the exercise analysis method of the present embodiment, since information which is generated on the basis of exercise information satisfying a predetermined condition according to an exercise state is output during the user's exercise, the user can easily utilize the presented information during the exercise. Since information based on some exercise information pieces which are generated during the exercise is output after the user's exercise is finished, the user can also easily utilize the presented information after the exercise is finished. Therefore, it is possible to assist the user in improving exercise attainments.

A physical activity assisting method of the present embodiment includes performing calculation by using a result of a sensor detecting a physical activity of a user; determining whether or not a result of the calculation satisfies a predetermined condition which corresponds to an advice mode selected on the basis of information input by the user among a plurality of advice modes and which is correlated with a state of the physical activity; and presenting advice information for sending a notification of the state of the physical activity in a case where the result of the calculation satisfies the predetermined condition.

According to the physical activity assisting method of the present embodiment, since advice information for sending a notification of a state of a physical activity of a user is presented in a case where a predetermined condition corresponding to an advice mode selected on the basis of information input by the user is satisfied, it is possible to effectively assist a physical activity of the user.

In the physical activity assisting method of the present embodiment, the plurality of advice modes may include a plurality of modes in which purposes of the physical activity are different from each other.

According to the physical activity assisting method of the present embodiment, it is possible to present advice information suitable for a purpose of a physical activity of the user.

In the physical activity assisting method of the present embodiment, the plurality of advice modes may include at least a mode of aiming at improving efficiency of the physical activity and a mode of aiming at energy consumption in the physical activity.

In the physical activity assisting method of the present embodiment, it is possible to present advice information suitable for improving efficiency of a physical activity or advice information suitable for energy consumption in a physical activity.

According to the physical activity assisting method of the present embodiment, the plurality of advice modes may include a plurality of modes in which the types of physical activities are different from each other.

According to the physical activity assisting method of the present embodiment, it is possible to present advice information suitable for the type of physical activity of the user.

In the physical activity assisting method of the present embodiment, the types of physical activities may be the types of running.

According to the physical activity assisting method of the present embodiment, it is possible to present advice information suitable for the type of running.

In the physical activity assisting method of the present embodiment, items for determining whether or not the predetermined condition is satisfied may be changed with each other depending on an advice mode selected by the user.

According to the physical activity assisting method of the present embodiment, items for determining a predetermined condition may be changed with each other depending on a purpose of a physical activity of the user, and thus it is possible to present more effective advice information.

The physical activity assisting method of the present embodiment may further include determining whether or not a state of the physical activity or the result of the calculation is abnormal by using the result of the calculation; and presenting information indicating that the state of the physical activity or the result of the calculation is abnormal in a case where it is determined that the state of the physical activity or the result of the calculation is abnormal.

According to the physical activity assisting method of the present embodiment, in a case where a state of a physical activity or a calculation result enters an abnormal state during the user's running, it is possible to present the occurrence of the abnormality to user.

In the physical activity assisting method of the present embodiment, the predetermined condition may include a condition corresponding to a state in which a state of the physical activity is worse than a reference state.

For example, the reference state may be a state which is predefined regardless of a user, a state which is defined depending on a sex or an age of a user, and may be a state which is set by a user.

According to the physical activity assisting method of the present embodiment, since advice information is presented in a case where a state of the physical activity is worse than a reference state, it is possible to effectively improve a physical activity of the user.

In contrast, the predetermined condition may include a condition corresponding to a state in which a state of the physical activity is better than a reference state. In the above-described manner, the user can effectively learn a better state of a physical activity.

In the physical activity assisting method of the present embodiment, the sensor may be an inertial sensor.

A physical activity assisting apparatus of the present embodiment includes a calculation unit that performs calculation by using a result of a sensor detecting a physical activity of a user; a determination unit that determines whether or not a result of the calculation satisfies a predetermined condition which corresponds to an advice mode selected on the basis of information input by the user among a plurality of advice modes and which is correlated with a state of the physical activity; and an advice information output unit that outputs advice information for sending a notification of the state of the physical activity in a case where the result of the calculation satisfies the predetermined condition.

According to the physical activity assisting apparatus of the present embodiment, since advice information for sending a notification of a state of a physical activity of a user is output in a case where a predetermined condition corresponding to an advice mode selected on the basis of information input by the user is satisfied, it is possible to effectively assist a physical activity of the user.

A program of the present embodiment causes a computer to execute performing calculation by using a result of a sensor detecting a physical activity of a user; determining whether or not a result of the calculation satisfies a predetermined condition which corresponds to an advice mode selected on the basis of information input by the user among a plurality of advice modes and which is correlated with a state of the physical activity; and outputting advice information for sending a notification of the state of the physical activity in a case where the result of the calculation satisfies the predetermined condition.

According to the physical activity assisting apparatus of the present embodiment, since advice information for sending a notification of a state of a physical activity of a user is output in a case where a predetermined condition corresponding to an advice mode selected on the basis of information input by the user is satisfied, it is possible to effectively assist a physical activity of the user.

Hereinafter, preferred embodiments of the invention will be described in detail with reference to the drawings. The embodiments described below are not intended to improperly limit the configuration of the invention disclosed in the appended claims. It cannot be said that all constituent elements described below are essential constituent elements of the invention.

### 1. First Embodiment

### 1-1 Summary of Exercise Analysis System

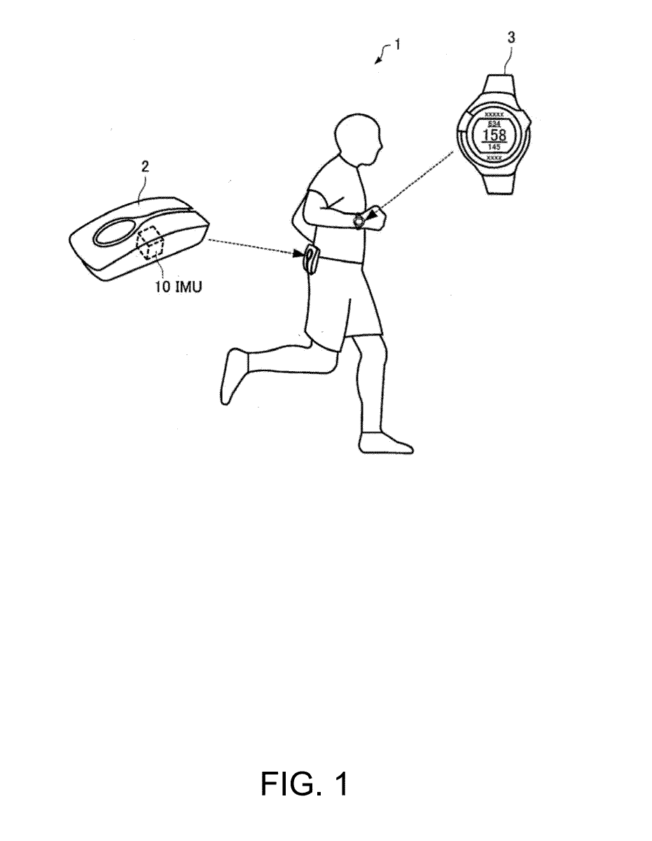

FIG. 1 is a diagram for explaining a summary of an exercise analysis system 1 according to a first embodiment. As illustrated in FIG. 1, the exercise analysis system 1 of the first embodiment includes an exercise analysis apparatus 2 and a display apparatus 3. The exercise analysis apparatus 2 is mounted on a body part (for example, a right waist, a left waist, or a central part of the waist) of a user. The exercise analysis apparatus 2 has an inertial measurement unit (IMU) 10 built thereinto, recognizes a motion of the user in running (including walking), computes velocity, a position, attitude angles (a roll angle, a pitch angle, and a yaw angle), and the like, and analyzes a user's exercise so as to generate exercise analysis information. In the present embodiment, the exercise analysis apparatus 2 is mounted on the user so that one detection axis (hereinafter, referred to as a z axis) of the inertial measurement unit (IMU) 10 substantially matches the gravitational acceleration direction (vertically downward direction) in a state in which the user stands still. The exercise analysis apparatus 2 transmits at least a part of the generated exercise analysis information to the display apparatus 3.

The display apparatus 3 is a wrist type (wristwatch type) portable information apparatus and is mounted on a user's wrist or the like. However, the display apparatus 3 may be a portable information apparatus such as a head mounted display (HMD) or a smart phone. The user operates the display apparatus 3 before running or during running, so as to instruct the exercise analysis apparatus 2 to start or finish measurement (an inertial navigation calculation process or an exercise analysis process which will be described later). The user operates the display apparatus 3 after the running, so as to instruct the exercise analysis apparatus 2 to start or finish a running analysis process (which will be described later). The display apparatus 3 transmits a command for instructing measurement to be started or finished, a command for instructing the running analysis process to be started or finished, and the like to the exercise analysis apparatus 2.

If a command for starting measurement is received, the exercise analysis apparatus 2 causes the inertial measurement unit (IMU) 10 to start measurement, and analyzes a user's running on the basis of a measurement result so as to generate exercise analysis information. The exercise analysis apparatus 2 transmits the generated exercise analysis information to the display apparatus 3. The display apparatus 3 receives the exercise analysis information, and presents the received exercise analysis information to the user in various forms such as text, graphics, sound, and vibration. The user can recognize the exercise analysis information via the display apparatus 3 during running.

If a command for instructing the running analysis process to be started is received, the exercise analysis apparatus 2 analyzes past running by using exercise analysis information generated during the past running, and transmits information regarding an analysis result to the display apparatus 3 or an information apparatus such as a personal computer or a smart phone (not illustrated). The display apparatus 3 or the information apparatus receives the information regarding the analysis result, and presents the received exercise analysis information to the user in various forms such as text, graphics, sound, and vibration. The user can recognize the analysis result of the past running via the display apparatus 3 or the information apparatus.

Data communication between the exercise analysis apparatus 2 and the display apparatus 3 may be wireless communication or wired communication.

In the present embodiment, hereinafter, as an example, a detailed description will be made of a case where the exercise analysis apparatus 2 generates exercise analysis information during the user's running exercise (running), but the exercise analysis system 1 of the present embodiment is also applicable to a case where exercise analysis information is generated in exercises other than running.

### 1-2. Coordinate Systems

Coordinate systems necessary in the following description are defined.
Earth centered earth fixed frame (e frame): right handed three-dimensional orthogonal coordinates in which the center of the earth is set as an origin, and a z axis is taken so as to be parallel to the axis of the earth
Navigation frame (n frame): three-dimensional orthogonal coordinates in which a moving body (user) is set as an origin, and an x axis is set to the north, a y axis is set to the east, and a z axis is set to the gravitational direction
Body frame (b frame): three-dimensional orthogonal coordinates using a sensor (the inertial measurement unit (IMU) 10) as a reference
Moving frame (m frame): right handed three-dimensional orthogonal coordinates in which a moving body (user) is set as an origin, and an advancing direction of the moving body (user) is set as an x axis

### 1-3. Configuration of Exercise Analysis System

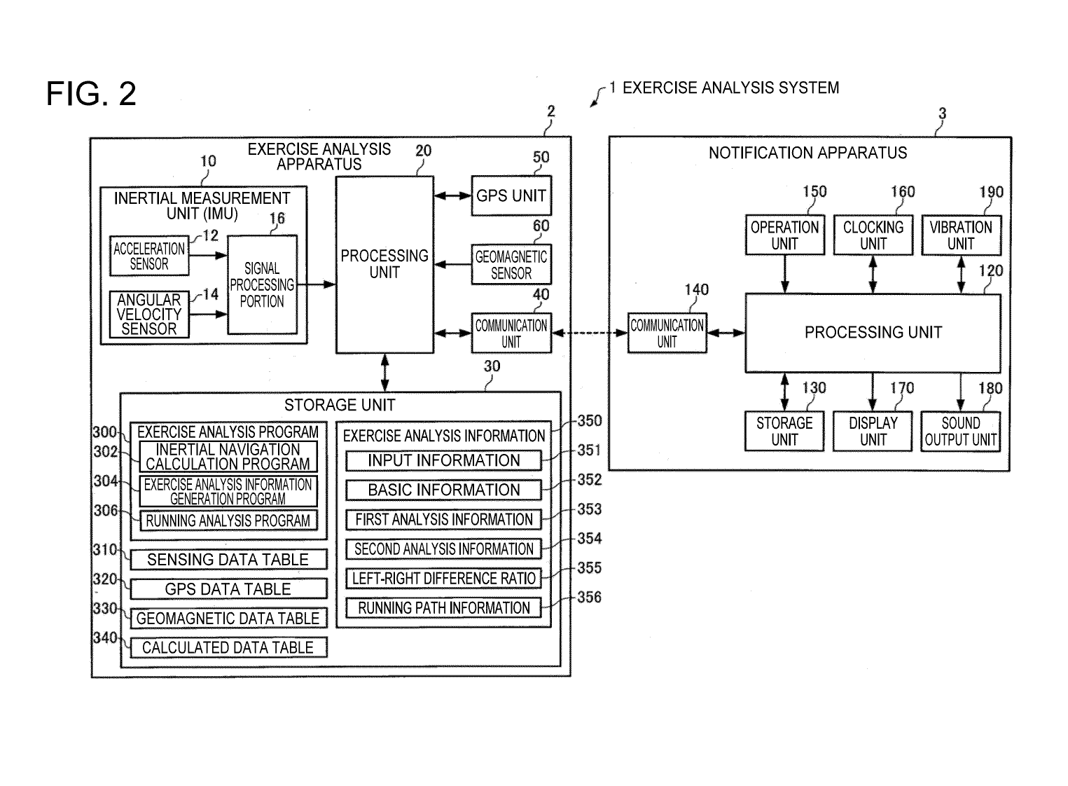

FIG. 2 is a functional block diagram illustrating a configuration example of the exercise analysis apparatus 2 and the display apparatus 3 in the first embodiment. As illustrated in FIG. 2, the exercise analysis apparatus 2 includes the inertial measurement unit (IMU) 10, a processing unit 20, a storage unit 30, a communication unit 40, a global positioning system (GPS) unit 50, and a geomagnetic sensor 60. However, the exercise analysis apparatus 2 of the present embodiment may have a configuration in which some of the constituent elements are deleted or changed, or other constituent elements may be added thereto.

The inertial measurement unit 10 (an example of an inertial sensor) includes an acceleration sensor 12, an angular velocity sensor 14, and a signal processing portion 16.

The acceleration sensor 12 detects respective accelerations in the three-axis directions which intersect each other (ideally, perpendicular to each other), and outputs a digital signal (acceleration data) corresponding to magnitudes and directions of the detected three-axis accelerations.

The angular velocity sensor 14 detects respective angular velocities in the three-axis directions which intersect each other (ideally, perpendicular to each other), and outputs a digital signal (angular velocity data) corresponding to magnitudes and directions of the detected three-axis angular velocities.

The signal processing portion 16 receives the acceleration data and the angular velocity data from the acceleration sensor 12 and the angular velocity sensor 14, respectively, adds time information thereto, stores the data items and the time information in a storage unit (not illustrated), generates sensing data in which the stored acceleration data, angular velocity data and time information conform to a predetermined format, and outputs the sensing data to the processing unit 20.

The acceleration sensor 12 and the angular velocity sensor 14 are ideally installed so as to match three axes of a sensor coordinate system (b frame) with the inertial measurement unit 10 as a reference, but, in practice, an error occurs in an installation angle. Therefore, the signal processing portion 16 performs a process of converting acceleration data and the angular velocity data into data of the sensor coordinate system (b frame) by using a correction parameter which is calculated in advance according to the installation angle error. Instead of the signal processing portion 16, the processing unit 20 to be described later may perform the process.

The signal processing portion 16 may perform a temperature correction process on the acceleration sensor 12 and the angular velocity sensor 14. Instead of the signal processing portion 16, the processing unit 20 to be described later may perform the temperature correction process, and a temperature correction function may be incorporated into the acceleration sensor 12 and the angular velocity sensor 14.

The acceleration sensor 12 and the angular velocity sensor 14 may output analog signals, and, in this case, the signal processing portion 16 may A/D convert an output signal from the acceleration sensor 12 and an output signal from the angular velocity sensor 14 so as to generate sensing data.

The GPS unit 50 receives a GPS satellite signal which is transmitted from a GPS satellite which is one type of positioning satellite, performs positioning computation by using the GPS satellite signal so as to calculate a position and velocity (which is a vector including a magnitude and a direction) of the user in n frames, and outputs GPS data in which time information or positioning accuracy information is added to the calculated results to the processing unit 20. A method of calculating a position or velocity or a method of generating by using GPS is well known, and thus detailed description thereof will be omitted.

The geomagnetic sensor 60 detects respective geomagnetisms in the three-axis directions which intersect each other (ideally, perpendicular to each other), and outputs a digital signal (geomagnetic data) corresponding to magnitudes and directions of the detected three-axis geomagnetisms. Here, the geomagnetic sensor 60 may output an analog signal, and, in this case, the processing unit 20 may A/D converts an output signal from the geomagnetic sensor 60 so as to generate geomagnetic data.

The processing unit 20 is constituted of, for example, a central processing unit (CPU), a digital signal processor (DSP), or an application specific integrated circuit (ASIC), and performs various calculation processes or control processes according to various programs stored in the storage unit 30. Particularly, the processing unit 20 receives sensing data, GPS data, and geomagnetic data from the inertial measurement unit 10, the GPS unit 50, and the geomagnetic sensor 60, respectively, and calculates a velocity, a position, an attitude angle, and the like of the user by using the data. The processing unit 20 performs various calculation processes by using the calculated information so as to analyze exercise of the user and to generate various pieces of exercise analysis information which will be described later. The processing unit 20 transmits some (output information during running or output information after running which will be described later) of the generated pieces of exercise analysis information to the display apparatus 3 via the communication unit 40, and the display apparatus 3 outputs the received exercise analysis information in a form of text, an image, sound, vibration, or the like.

The storage unit 30 is constituted of, for example, recording media including various IC memories such as a read only memory (ROM), a flash ROM, and a random access memory (RAM), a hard disk, and a memory card.

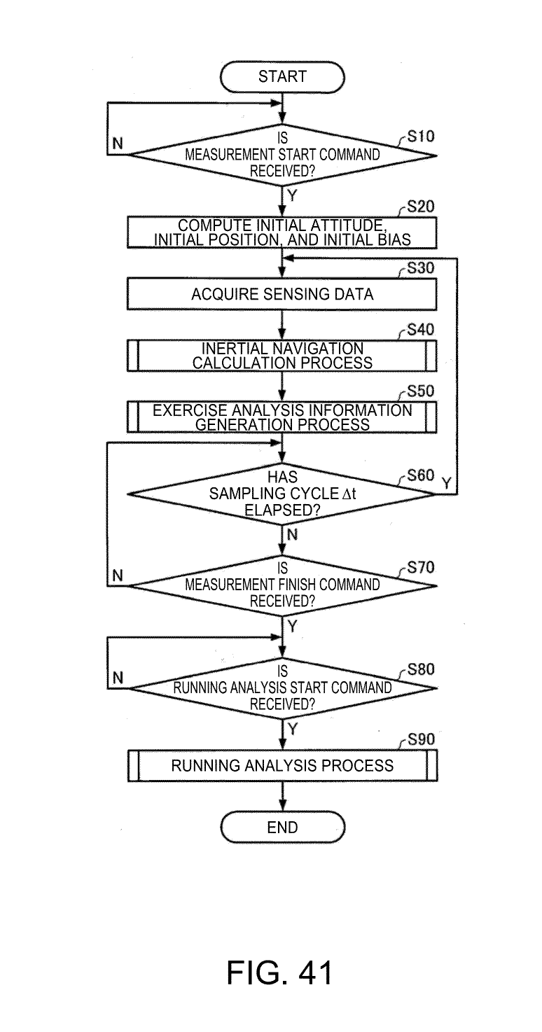

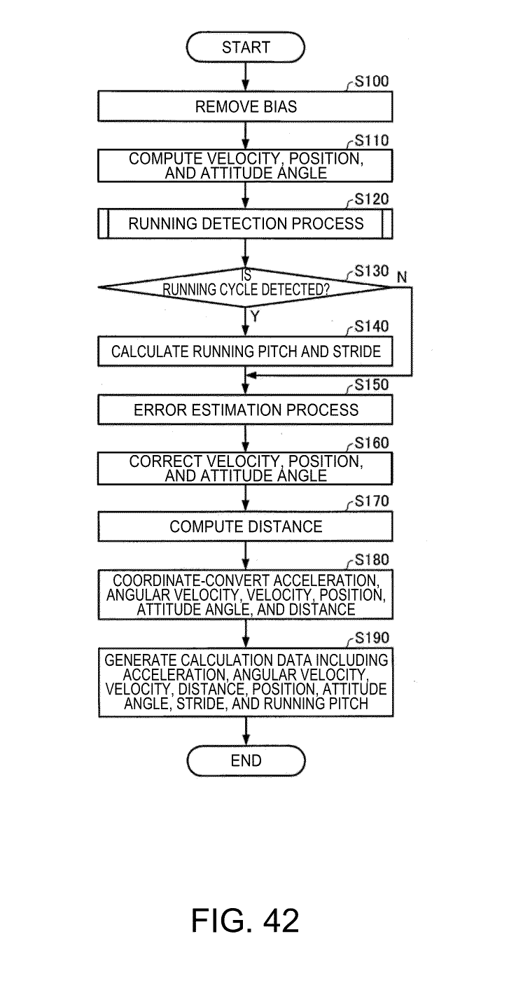

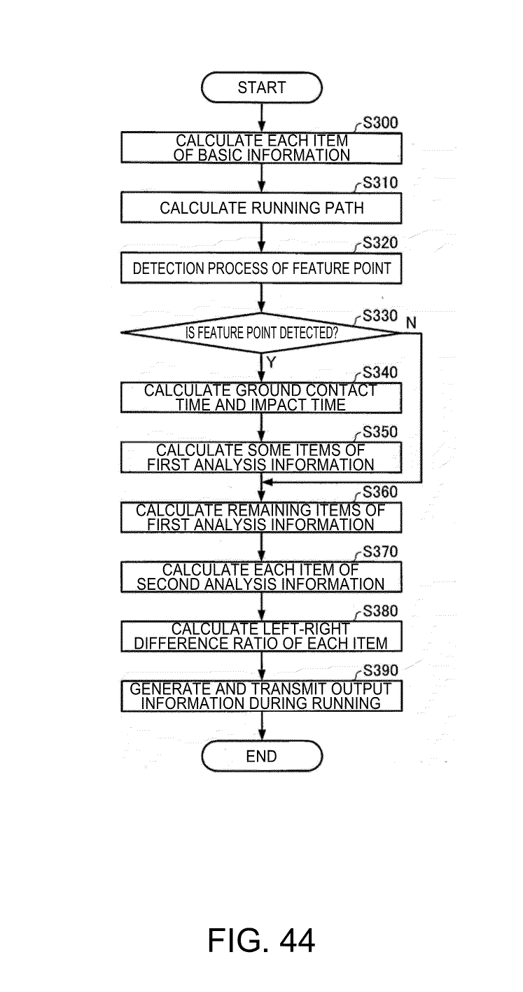

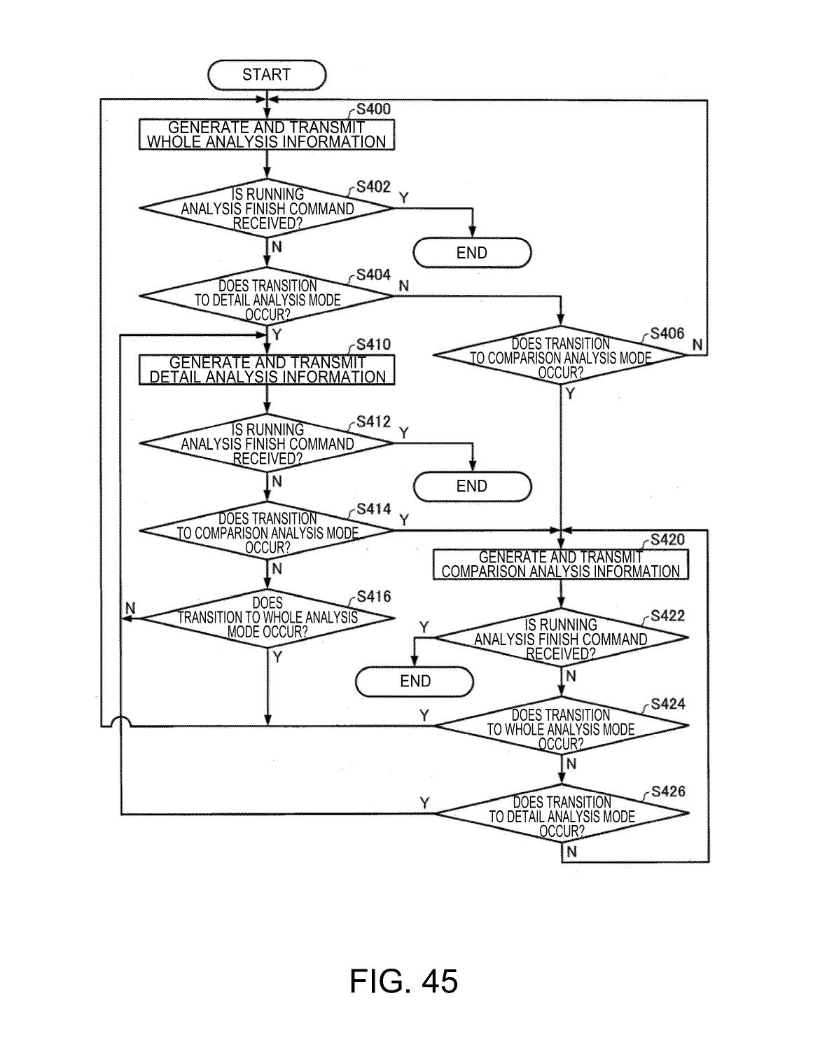

The storage unit 30 stores an exercise analysis program 300 which is read by the processing unit 20 and is used to perform an exercise analysis process (refer to FIG. 41). The exercise analysis program 300 includes, as sub-routines, an inertial navigation calculation program 302 for performing an inertial navigation calculation process (refer to FIG. 42), an exercise analysis information generation program 304 for performing an exercise analysis information generation process (refer to FIG. 44), and a running analysis program 306 for performing a running analysis process (refer to FIG. 45).

The storage unit 30 stores a sensing data table 310, a GPS data table 320, a geomagnetic data table 330, a calculated data table 340, exercise analysis information 350, and the like.

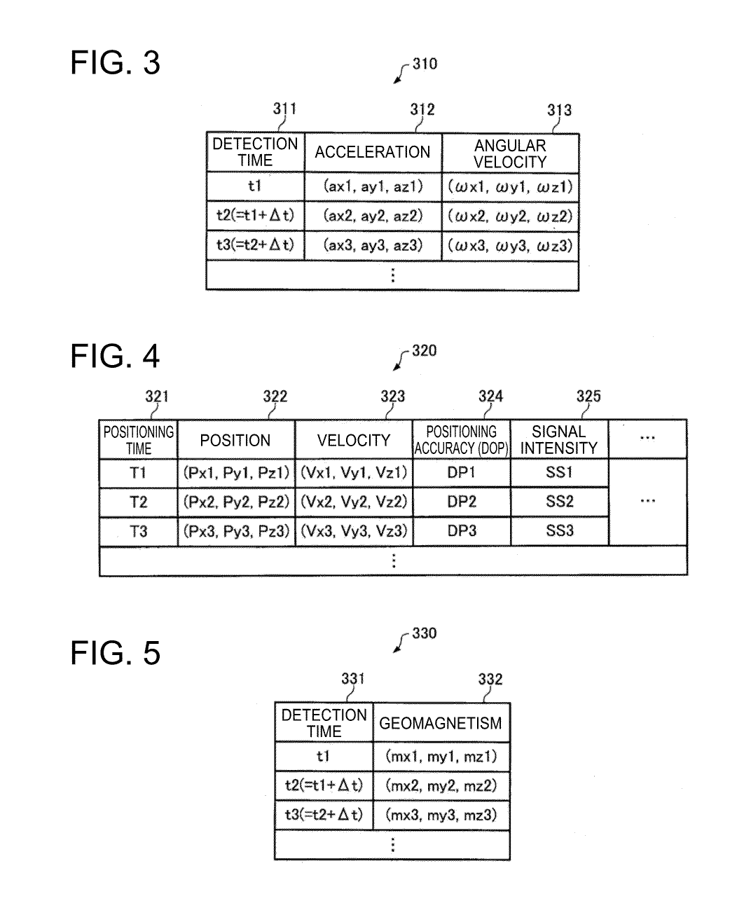

The sensing data table 310 is a data table which stores sensing data (a detection result in the inertial measurement unit 10) received by the processing unit 20 from the inertial measurement unit 10 in a time series. FIG. 3 is a diagram illustrating a configuration example of the sensing data table 310. As illustrated in FIG. 3, the sensing data table 310 is configured so that sensing data items in which the detection time 311 in the inertial measurement unit 10, an acceleration 312 detected by the acceleration sensor 12, and an angular velocity 313 detected by the angular velocity sensor 14 are correlated with each other are arranged in a time series. When measurement is started, the processing unit 20 adds new sensing data to the sensing data table 310 whenever a sampling cycle Δt (for example, 20 ms or 10 ms) elapses. The processing unit 20 corrects an acceleration bias and an angular velocity bias which are estimated according to error estimation (which will be described later) using the extended Karman filter, and updates the sensing data table 310 by overwriting the corrected acceleration and angular velocity to the sensing data table.

The GPS data table 320 is a data table which stores GPS data (a detection result in the GPS unit (GPS sensor) 50) received by the processing unit 20 from the GPS unit 50 in a time series. FIG. 4 is a diagram illustrating a configuration example of the GPS data table 320. As illustrated in FIG. 4, the GPS data table 320 is configured so that GPS data items in which the time 321 at which the GPS unit 50 performs positioning computation, a position 322 calculated through the positioning computation, a velocity 323 calculated through the positioning computation, positioning accuracy (dilution of precision (DOP)) 323, a signal intensity 325 of a received GPS satellite signal, and the like are correlated with each other are arranged in a time series. When measurement is started, the processing unit 20 adds GPS data whenever the GPS data is acquired (for example, every second in an asynchronous manner with acquisition timing of sensing data) so as to update the GPS data table 320.

The geomagnetic data table 330 is a data table which stores geomagnetic data (a detection result in the geomagnetic sensor) received by the processing unit 20 from the geomagnetic sensor 60 in a time series. FIG. 5 is a diagram illustrating a configuration example of the geomagnetic data table 330. As illustrated in FIG. 5, the geomagnetic data table 330 is configured so that geomagnetic data items in which the detection time 331 in the geomagnetic sensor 60 and a geomagnetism 332 detected by the geomagnetic sensor 60 are correlated with each other are arranged in a time series. When measurement is started, the processing unit 20 adds new geomagnetic data to the geomagnetic data table 330 whenever the sampling cycle Δt (for example, 10 ms) elapses.

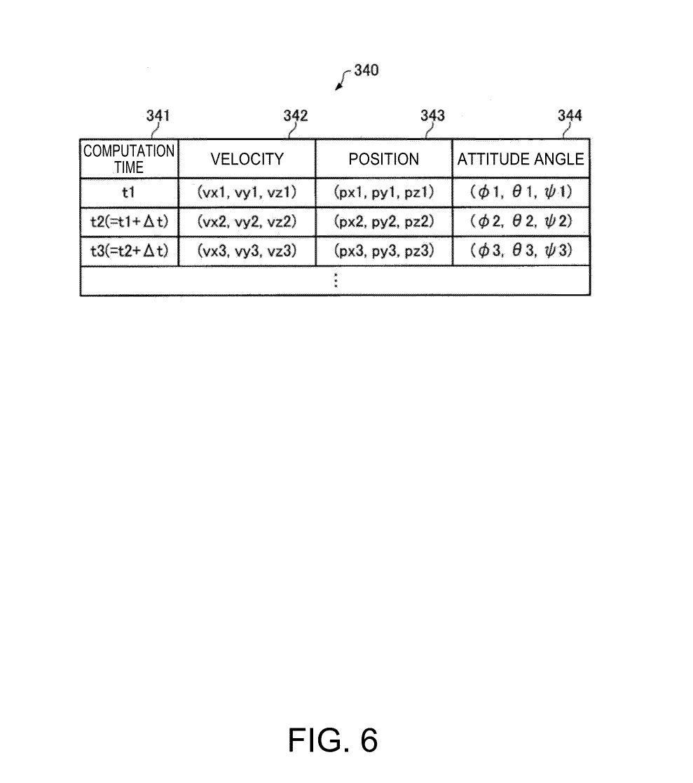

The calculated data table 340 is a data table which stores a velocity, a position, and an attitude angle calculated by the processing unit 20 by using the sensing data in a time series. FIG. 6 is a diagram illustrating a configuration example of the calculated data table 340. As illustrated in FIG. 6, the calculated data table 340 is configured so that calculated data items in which the time 341 at which the processing unit 20 performs computation, a velocity 342, a position 343, and an attitude angle 344 are correlated with each other are arranged in a time series. When measurement is started, the processing unit 20 calculates a velocity, a position, and an attitude angle whenever new sensing data is acquired, that is, the sampling cycle Δt elapses, and adds new calculated data to the calculated data table 340. The processing unit 20 corrects a velocity, a position, and an attitude angle by using a velocity error, a position error, and an attitude angle error which are estimated according to error estimation using the extended Karman filter, and updates the calculated data table 340 by overwriting the corrected velocity, position and attitude angle to the calculated data table.

The exercise analysis information 350 is various information pieces regarding the exercise of the user, and includes each item of input information 351, each item of basic information 352, each item of first analysis information 353, each item of second analysis information 354, each item of left-right difference ratio 355, running path information 356, and the like, generated by the processing unit 20. Details of the various information pieces will be described later.

FIG. 2 is referred to again. The communication unit 40 performs data communication with a communication unit 140 of the display apparatus 3, and performs a process of receiving some exercise analysis information (output information during running or output information after running to be described later) generated by the processing unit 20 and transmitting the exercise analysis information to the display apparatus 3, a process of receiving a command (a command for starting or finishing measurement, a command for starting or finishing the running analysis process, or the like) transmitted from the display apparatus 3 and sending the command to the processing unit 20, and the like.

The display apparatus 3 includes a processing unit 120, a storage unit 130, the communication unit 140, an operation unit 150, a clocking unit 160, a display unit 170, a sound output unit 180, and a vibration unit 190. However, the display apparatus 3 of the present embodiment may have a configuration in which some of the constituent elements are deleted or changed, or other constituent elements may be added thereto.

The processing unit 120 is constituted of, for example, a CPU, a DSP, or an ASIC, and performs various calculation processes or control processes according to a program stored in the storage unit 130. For example, the processing unit 120 performs various processes (a process of sending a command for starting or finishing measurement or a command for starting or finishing the running analysis process to the communication unit 140, a process of performing display or outputting sound corresponding to the operation data, and the like) corresponding to operation data received from the operation unit 150; a process of receiving output information during running or output information after running from the communication unit 140 and sending text data or image data corresponding to the output information during running or the output information after running to the display unit 170; a process of sending sound data corresponding to the output information during running or the output information after running to the sound output unit 180; and a process of sending vibration data corresponding to the output information during running to the vibration unit 190. The processing unit 120 performs a process of generating time image data corresponding to time information received from the clocking unit 160 and sending the time image data to the display unit 170, and the like.

The storage unit 130 is constituted of a recording medium such as a ROM, a flash ROM, a hard disk, or a memory card which stores a program or data required for the processing unit 120 to perform various processes, and a RAM (for example, various IC memories) serving as a work area of the processing unit 120.

The communication unit 140 performs data communication with the communication unit 40 of the exercise analysis apparatus 2, and performs a process of receiving a command (a command for starting or finishing measurement, a command for starting or finishing the running analysis process, or the like) corresponding to operation data from the processing unit 120 and transmitting the command to the communication unit 40 of the exercise analysis apparatus 2, a process of receiving output information during running or output information after running transmitted from the communication unit 40 of the exercise analysis apparatus 2 and sending the information to the processing unit 120, and the like.

The operation unit 150 performs a process of acquiring operation data (operation data such as starting or finishing of measurement or selection of display content) from the user and sending the operation data to the processing unit 120. The operation unit 150 may be, for example, a touch panel type display, a button, a key, or a microphone.

The clocking unit 160 performs a process of generating time information such as year, month, day, hour, minute, and second. The clocking unit 160 is implemented by, for example, a real time clock (RTC) IC.

The display unit 170 displays image data or text data sent from the processing unit 120 as text, a graph, a table, animation, or other images. The display unit 170 is implemented by, for example, a display such as a liquid crystal display (LCD), an organic electroluminescent (EL) display, or an electrophoretic display (EPD), and may be a touch panel type display. A single touch panel type display may implement functions of the operation unit 150 and the display unit 170.

The sound output unit 180 outputs sound data sent from the processing unit 120 as sound such as voice or buzzer sound. The sound output unit 180 is implemented by, for example, a speaker or a buzzer.

The vibration unit 190 vibrates in response to vibration data sent from the processing unit 120. This vibration is transmitted to the display apparatus 3, and the user wearing the display apparatus 3 can feel the vibration. The vibration unit 190 is implemented by, for example, a vibration motor.

### 1-4. Functional Configuration of Processing Unit

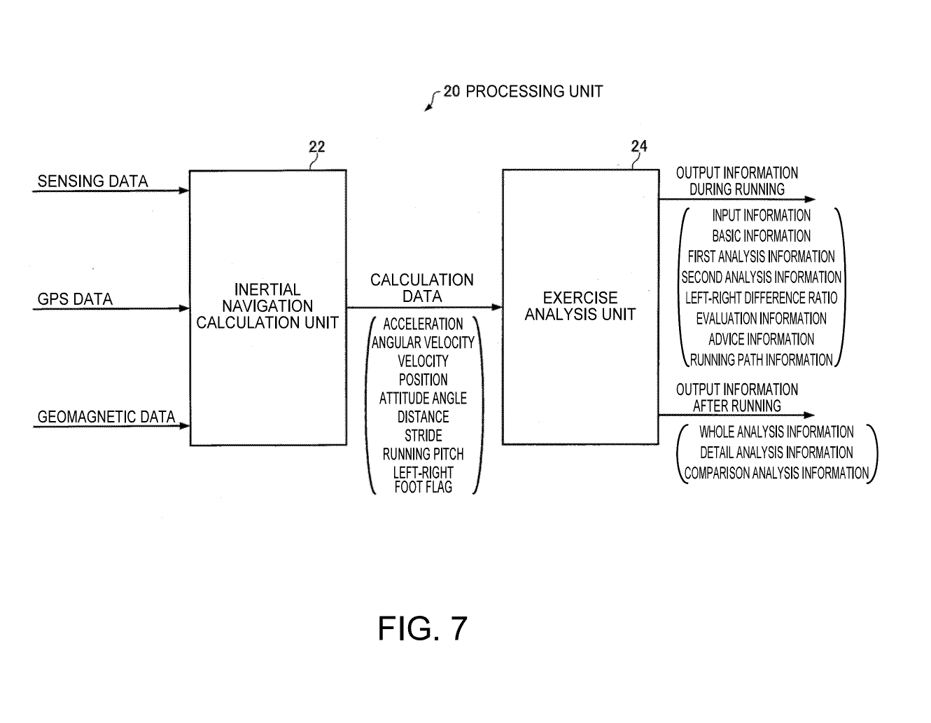

FIG. 7 is a functional block diagram illustrating a configuration example of the processing unit 20 of the exercise analysis apparatus 2 in the first embodiment. In the present embodiment, the processing unit 20 functions as an inertial navigation calculation unit 22 and an exercise analysis unit 24 by executing the exercise analysis program 300 stored in the storage unit 30.

The inertial navigation calculation unit 22 performs inertial navigation calculation by using sensing data (a detection result in the inertial measurement unit 10), GPS data (a detection result in the GPS unit 50), and geomagnetic data (a detection result in the geomagnetic sensor 60), so as to calculate an acceleration, an angular velocity, a velocity, a position, an attitude angle, a distance, a stride, and a running pitch, and outputs calculation data including the calculation results. The calculation data output from the inertial navigation calculation unit 22 is stored in the storage unit 30. Details of the inertial navigation calculation unit 22 will be described later.

The exercise analysis unit 24 analyzes the exercise of the user by using the calculation data (the calculation data stored in the storage unit 30) output from the inertial navigation calculation unit 22, and generates a plurality of exercise information pieces (each item of input information, each item of basic information, each item of first analysis information, each item of second analysis information, each item of left-right difference ratio, running path information, and the like, which will be described later) for improving running attainments (example of exercise attainments) of the user. The running attainments may be, for example, running performance, a score of time or the like, or unlikelihood of an injury. The exercise analysis unit 24 generates the output information during running which is output during running by using one or more items of the plurality of exercise information pieces. The exercise analysis information including the plurality of exercise information pieces is stored in the storage unit 30. The exercise analysis unit 24 performs the running analysis process by using the exercise analysis information after the user finishes the running, and generates the output information after running which is output after the running is finished. Details of the exercise analysis unit 24 will be described later.

### 1-5. Functional Configuration of Inertial Navigation Calculation Unit

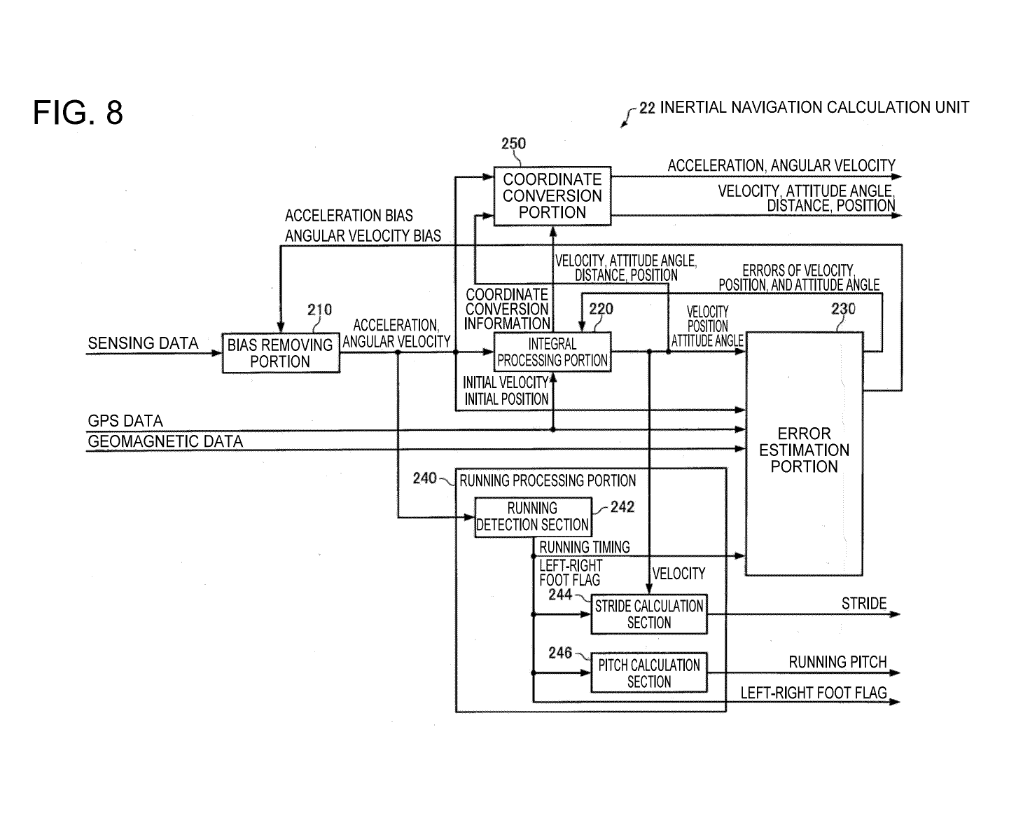

FIG. 8 is a functional block diagram illustrating a configuration example of the inertial navigation calculation unit 22. In the present embodiment, the inertial navigation calculation unit 22 includes a bias removing portion 210, an integral processing portion 220, an error estimation portion 230, a running processing portion 240, and a coordinate conversion portion 250. However, the inertial navigation calculation unit 22 of the present embodiment may have a configuration in which some of the constituent elements are deleted or changed, or other constituent elements may be added thereto.

The bias removing portion 210 subtracts an acceleration bias bₐ and an angular velocity bias b_{ω} estimated by the error estimation portion 230 from three-axis accelerations and three-axis angular velocities included newly acquired sensing data, so as to perform a process of correcting the three-axis accelerations and the three-axis angular velocities. Since estimated values of the acceleration bias bₐ and the angular velocity bias b_{ω} are present in an initial state right after measurement is started, the bias removing portion 210 computes initial biases by using sensing data from the inertial measurement unit (IMU) 10 assuming that an initial state of the user is a stoppage state.

The integral processing portion 220 performs a process of calculating a velocity v^{e}, a position p^{e}, and attitude angles (a roll angle φ_{be}, a pitch angle θ_{be}, and a yaw angle ψ_{be}) of the e frame on the basis of the accelerations and the angular velocities corrected by the bias removing portion 210. Specifically, first, the integral processing portion 220 sets an initial velocity to zero assuming that an initial state of the user is a stoppage state, or calculates an initial velocity by using the velocity included in the GPS data and also calculates an initial position by using the position included in the GPS data. The integral processing portion 220 specifies a gravitational acceleration direction on the basis of the three-axis accelerations of the b frame corrected by the bias removing portion 210 so as to calculate initial values of the roll angle φ_{be} and the pitch angle θ_{be}, also calculates an initial value of the yaw angle ψ_{be} on the basis of the velocity including the GPS data, and sets the calculated initial values as initial attitude angles of the e frame. In a case where the GPS data cannot be obtained, an initial value of the yaw angle ψ_{be} is set to, for example, zero. The integral processing portion 220 calculates an initial value of a coordinate conversion matrix (rotation matrix) C_{b}^{e} from the b frame into the e frame, expressed by Equation (1) on the basis of the calculated initial attitude angles.

$${C}_{b}^{e} = [ \begin{matrix}cos {θ}_{be} \cdot cos {ϕ}_{be} & cos {θ}_{be} \cdot sin {ϕ}_{be} & - sin {θ}_{be} \\ \begin{matrix}sin {φ}_{be} \cdot sin {θ}_{be} \cdot cos {ϕ}_{be} - \\ cos {φ}_{be} \cdot sin {ϕ}_{be}\end{matrix} & sin {φ}_{be} \cdot sin {θ}_{be} \cdot sin {ϕ}_{be} + cos {φ}_{be} \cdot cos {ϕ}_{be} & sin {φ}_{be} \cdot cos {θ}_{be} \\ \begin{matrix}cos {φ}_{be} \cdot sin {θ}_{be} \cdot cos {ϕ}_{be} + \\ sin {φ}_{be} \cdot sin {ϕ}_{be}\end{matrix} & cos {φ}_{be} \cdot sin {θ}_{be} \cdot sin {ϕ}_{be} - sin {φ}_{be} \cdot cos {ϕ}_{be} & cos {φ}_{be} \cdot cos {θ}_{be}\end{matrix} ] \qquad ( 1 )$$

Then, the integral processing portion 220 integrates the three-axis angular velocities corrected by the bias removing portion 210 so as to calculate the coordinate conversion matrix C_{b}^{e}, and calculates attitude angles by using Equation (2).

$$[ \begin{matrix}{φ}_{be} \\ {θ}_{be} \\ {ϕ}_{be}\end{matrix} ] = [ \begin{matrix}arctan 2 ( {C}_{b}^{e} ( 2 , 3 ) , {C}_{b}^{e} ( 3 , 3 ) ) \\ - arcsin {C}_{b}^{e} ( 1 , 3 ) \\ arctan 2 ( {C}_{b}^{e} ( 1 , 2 ) , {C}_{b}^{e} ( 1 , 1 ) )\end{matrix} ] \qquad ( 2 )$$

The integral processing portion 220 converts the three-axis accelerations of the b frame corrected by the bias removing portion 210 into three-axis accelerations of the e frame by using the coordinate conversion matrix C_{b}^{e}, and removes an gravitational acceleration component therefrom for integration so as to calculate the velocity v^{e} of the e frame. The integral processing portion 220 integrates the velocity v^{e} of the e frame so as to calculate the position p^{e} of the e frame.

The integral processing portion 220 performs a process of correcting the velocity v^{e}, the position p^{e}, and the attitude angles by using a velocity error δv^{e}, a position error δp^{e}, and attitude angle errors ε^{e} estimated by the error estimation portion 230, and also performs a process of computing a distance by integrating the corrected velocity v^{e}.

The integral processing portion 220 also calculates a coordinate conversion matrix C_{b}^{m} from the b frame into the m frame, a coordinate conversion matrix Cₑ^{m} from the e frame into the m frame, and a coordinate conversion matrix Cₑⁿ from the e frame into the n frame. The coordinate conversion matrices are used for a coordinate conversion process in the coordinate conversion portion 250 which will be described later as coordinate conversion information.

The error estimation portion 230 estimates an error of an index indicating a state of the user by using the velocity and/or the position, and the attitude angles calculated by the integral processing portion 220, the acceleration or the angular velocity corrected by the bias removing portion 210, the GPS data, the geomagnetic data, and the like. In the present embodiment, the error estimation portion 230 uses the velocity, the attitude angles, the acceleration, the angular velocity, and the position as indexes indicating a state of the user, and estimates errors of the indexes by using the extended Karman filter. In other words, the error estimation portion 230 uses an error (velocity error) δv^{e} of the velocity v^{e} calculated by the integral processing portion 220, errors (attitude angle errors) ε^{e} of the attitude angles calculated by the integral processing portion 220, the acceleration bias bₐ, the angular velocity bias b_{ω}, and an error (position error) δp^{e} of the position p^{e} calculated by the integral processing portion 220, as state variables of the extended Karman filter, and a state vector X is defined as in Equation (3).

$$X = [ \begin{matrix}δ {v}^{e} \\ {ɛ}^{e} \\ {b}_{a} \\ {b}_{ω} \\ δ {p}^{e}\end{matrix} ] \qquad ( 3 )$$

The error estimation portion 230 predicts state variables (errors of the indexes indicating a state of the user) included in the state vector X by using a predication formula of the extended Karman filter. The predication formulae of the extended Karman filter are expressed as in Equation (4). In Equation (4), the matrix Φ is a matrix which associates the previous state vector X with the present state vector X, and is designed so that some elements thereof change every moment while reflecting attitude angles, a position, and the like. Q is a matrix indicating process noise, and each element thereof is set to an appropriate value. P is an error covariance matrix of the state variables.

X=ΦX

P=ΦPΦ^{T}+Q (4)

The error estimation portion 230 updates (corrects) the predicted state variables (errors of the indexes indicating a state of the user) by update formulae of the extended Karman filter. The update formulae of the extended Karman filter are expressed as in Equation (5). Z and H are respectively an observation vector and an observation matrix, and the update formulae (5) indicate that the state vector X is corrected by using a difference between the actual observation vector Z and a vector HX predicted from the state vector X. R is a covariance matrix of observation errors, and may have predefined constant values, and may be dynamically changed. K is a Karman gain, and K increases as R decreases. From Equation (5), as K increases (R decreases), a correction amount of the state vector X increases, and thus P decreases.

K=PH^{T}(HPH^{T}+R)⁻¹

X=X+K(Z−HX)

P=(I−KH)P (5)

An error estimation method (a method of estimating the state vector X) may include, for example, the following methods.

An error estimation method using correction on the basis of attitude angle errors:

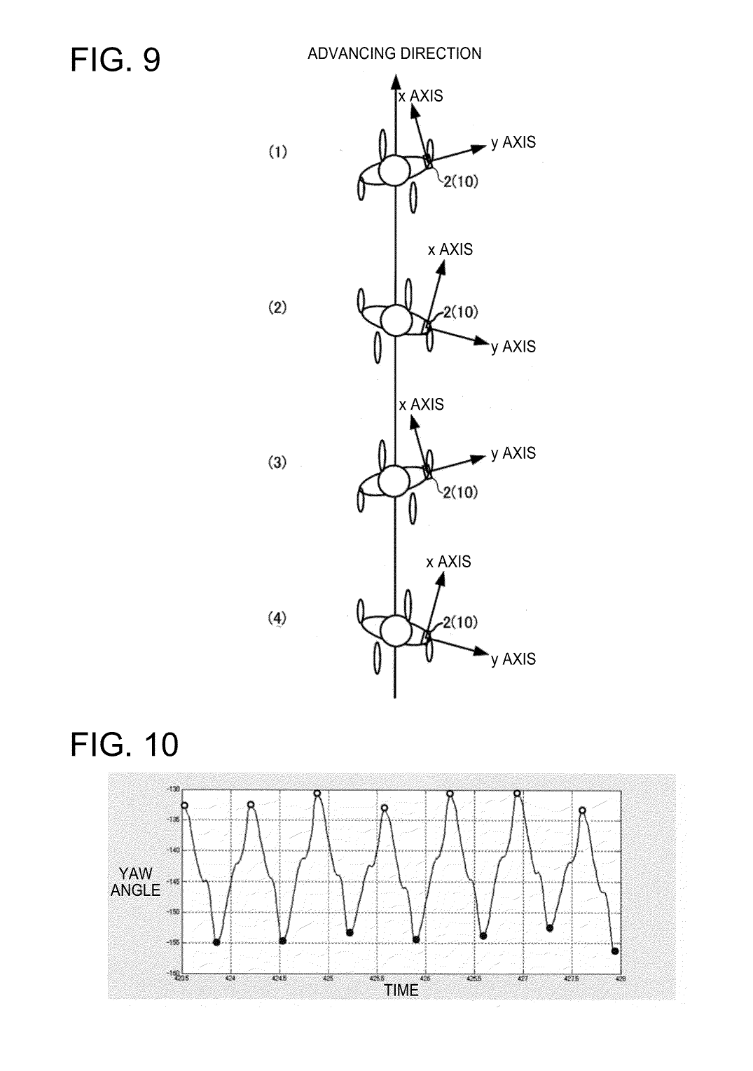

FIG. 9 is an overhead view of movement of the user in a case where the user wearing the exercise analysis apparatus 2 on the user's right waist performs a running motion (going straight). FIG. 10 is a diagram illustrating an example of a yaw angle (azimuth angle) calculated by using a detection result in the inertial measurement unit 10 in a case where there user performs the running motion (going straight), in which a transverse axis expresses time, and a longitudinal axis expresses a yaw angle (azimuth angle).

An attitude of the inertial measurement unit 10 relative to the user changes at any time due to the running motion of the user. In a state in which the user takes a step forward with the left foot, as illustrated in (1) or (3) of FIG. 9, the inertial measurement unit 10 is tilted to the left side with respect to the advancing direction (the x axis of the m frame). In contrast, in a state in which the user takes a step forward with the right foot, as illustrated in (2) or (4) of FIG. 9, the inertial measurement unit 10 is tilted to the right side with respect to the advancing direction (the x axis of the m frame). In other words, the attitude of the inertial measurement unit 10 periodically changes every two left and right steps due to the running motion of the user. In FIG. 10, for example, the yaw angle is the maximum in a state in which the user takes a step forward with the right foot (0 in FIG. 10), and is the minimum in a state in which the user takes a step forward with the left foot (• in FIG. 10). Therefore, an error can be estimated assuming that the previous (two steps before) attitude angle is the same as the present attitude angle, and the previous attitude angle is a true attitude angle. In this method, the observation vector Z of Equation (5) is a difference between the previous attitude angle and the present attitude angle calculated by the integral processing portion 220, and the state vector X is corrected on the basis of a difference between the attitude angle error ε^{e} and an observed value according to the update formulae (5) so that an error is estimated.

An error estimation method using correction based on the angular velocity bias:

This method is a method of estimating an error assuming that the previous (two steps before) attitude angle is the same as the present attitude angle, and the previous attitude angle is not required to be a true attitude angle. In this method, the observation vector Z of Equation (5) is an angular velocity bias by using the previous attitude angle and the present attitude angle calculated by the integral processing portion 220, and the state vector X is corrected on the basis of a difference between the angular velocity bias b_{ω} and an observed value according to the update formulae (5).

An error estimation method using correction based on azimuth angle error:

This method is a method of estimating an error assuming that the previous (two steps before) yaw angle (azimuth angle) is the same as the present yaw angle (azimuth angle), and the previous yaw angle (azimuth angle) is a true yaw angle (azimuth angle). In this method, the observation vector Z of Equation (5) is a difference between the previous yaw angle and the present yaw angle calculated by the integral processing portion 220, and the state vector X is corrected on the basis of a difference between an azimuth angle error ε_{z}^{e} and an observed value according to the update formulae (5) so that an error is estimated.

An error estimation method using correction based on stoppage:

This method is a method of estimating an error assuming that a velocity is zero when the user stops. In this method, the observation vector Z is a difference between a velocity v^{e} calculated by the integral processing portion 220 and zero, and the state vector X is corrected on the basis of the velocity error εv^{e} according to the update formulae (5) so that an error is estimated.

An error estimation method using correction based on stoppage:

This method is a method of estimating an error assuming that a velocity is zero and an attitude change is also zero when the user stops. In this method, the observation vector Z is an error of the velocity v^{e} calculated by the integral processing portion 220 and a difference between the previous attitude angle and the present attitude angle calculated by the integral processing portion 220, and the state vector X is corrected on the basis of the velocity error δv^{e} and the attitude angle error ε^{e} according to the update formulae (5) so that an error is estimated.

An error estimation method using correction based on an observed value of GPS:

This method is a method of estimating an error assuming that the velocity v^{e}, the position p^{e}, or the yaw angle ψ_{be} calculated by the integral processing portion 220 is the same as a velocity, a position, or an azimuth angle (a velocity, a position, or an azimuth angle after being converted into the e frame) which is calculated by using GPS data. In this method, the observation vector Z is a difference between a velocity, a position, or a yaw angle calculated by the integral processing portion 220 and a velocity, a positional velocity, or an azimuth angle calculated by using the GPS data, and the state vector X is corrected on the basis of a difference between the velocity error δv^{e}, the position error δp^{e}, or the azimuth angle errors ε_{z}^{e}, and an observed value according to the update formulae (5) so that an error is estimated.

An error estimation method using correction based on an observed value in geomagnetic sensor:

This method is a method of estimating an error assuming that the yaw angle ψ_{be} calculated by the integral processing portion 220 is the same as an azimuth angle (an azimuth angle after being converted into the e frame) calculated from the geomagnetic sensor. In this method, the observation vector Z is a difference between a yaw angle calculated by the integral processing portion 220 and an azimuth angle calculated by using geomagnetic data, and the state vector X is corrected on the basis of a difference between the azimuth angle errors ε_{z}^{e} and an observed value according to the update formulae (5) so that an error is estimated.

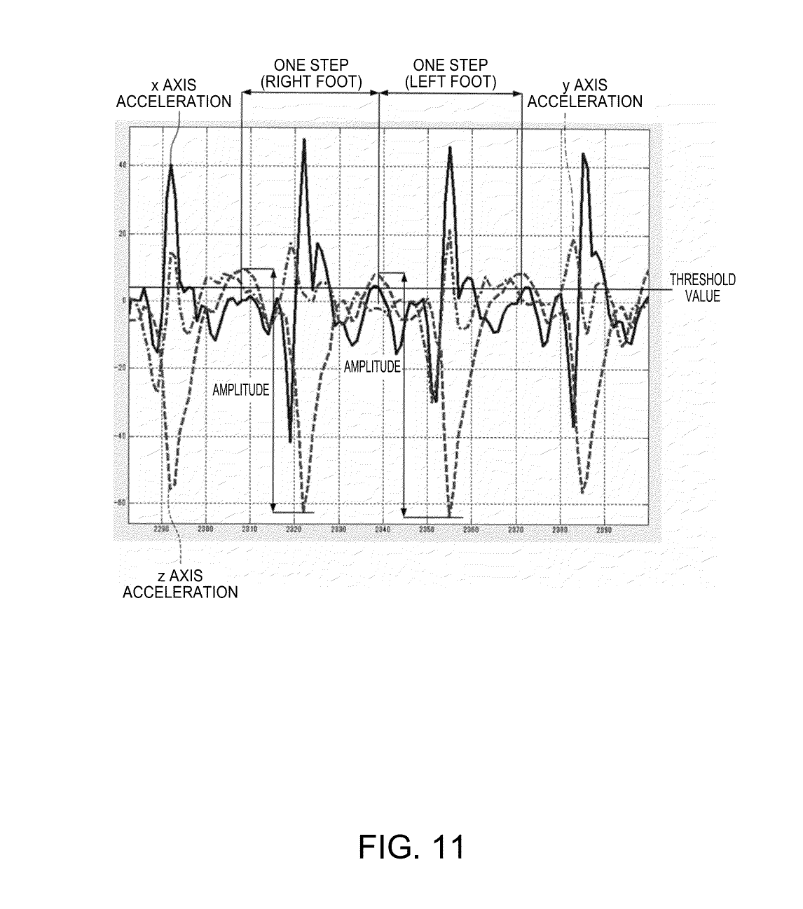

Referring to FIG. 8 again, the running processing portion 240 includes a running detection section 242, a stride calculation section 244, and a pitch calculation section 246. The running detection section 242 performs a process of detecting a running cycle (running timing) of the user by using a detection result (specifically, sensing data corrected by the bias removing portion 210) in the inertial measurement unit 10. As described with reference to FIGS. 9 and 10, since the user's attitude periodically changes (every two left and right steps) while the user is running, an acceleration detected by the inertial measurement unit 10 also periodically changes. FIG. 11 is a diagram illustrating an example of three-axis accelerations detected by the inertial measurement unit 10 during the user's running. In FIG. 11, a transverse axis expresses time, and a longitudinal axis expresses an acceleration value. As illustrated in FIG. 11, the three-axis accelerations periodically change, and, particularly, it can be seen that the z axis (the axis in the gravitational direction) acceleration changes periodically and regularly. The z axis acceleration reflects an acceleration obtained when the user moves vertically, and a time period from the time when the z axis acceleration becomes the maximum value which is equal to or greater than a predetermined threshold value to the time when the z axis acceleration becomes the maximum value which is equal to or greater than the predetermined threshold value next corresponds to a time period of one step. One step in a state in which the user takes a step forward with the right foot and one step in a state in which the user takes a step forward with the left foot are alternately taken in a repeated manner.

Therefore, in the present embodiment, the running detection section 242 detects alternatively a right foot running cycle and a left foot running cycle whenever the z axis acceleration (corresponding to an acceleration obtained when the user moves vertically) detected by the inertial measurement unit 10 becomes the maximum value which is equal to or greater than the predetermined threshold value. In other words, the running detection section 242 outputs a timing signal indicating that a running cycle is detected a left-right foot flag (for example, an ON flag for the right foot, and an OFF flag for the left foot) indicating the corresponding running cycle whenever the z axis acceleration detected by the inertial measurement unit 10 becomes the maximum value which is equal to or greater than the predetermined threshold value. However, in practice, since a high frequency noise component is included in the three-axis accelerations detected by the inertial measurement unit 10, the running detection section 242 applies a low-pass filter to the three-axis accelerations, and detects a running cycle by using a z axis acceleration from which noise is removed.

Since it may not be known whether the user starts to run from the right foot or the left foot, and a wrong running cycle may be detected during running, the running detection section 242 preferably comprehensively determines whether a running cycle is a left foot running cycle or a right foot running cycle by also using information (for example, attitude angles) other than the z axis acceleration.

The stride calculation section 244 calculates a stride for each of the left and right foots by using a timing signal for the running cycle and the left-right foot flag output from the running detection section 242, and a velocity or a position calculated by the integral processing portion 220, and outputs the stride for each of the left and right foots. In other words, the stride calculation section 244 integrates a velocity for each sampling cycle Δt in a time period from the start of the running cycle to the start of the next running cycle (alternatively, computes a difference between a position at the time when the running cycle is started and a position at the time when the next running cycle is started) so as to calculate and output a stride.

The pitch calculation section 246 performs a process of calculating the number of steps for one minute by using the timing signal for the running cycle output from the running detection section 242, and outputting the number of steps as a running pitch. In other words, the pitch calculation section 246 computes the number of steps per second by taking an inverse number of the running cycle, and calculates the number of steps for one minute (running pitch) by multiplying the number of steps per second by 60.

The coordinate conversion portion 250 performs a coordinate conversion process of converting the three-axis accelerations and the three-axis angular velocities of the b frame corrected by the bias removing portion 210 into three-axis accelerations and three-axis angular velocities of the m frame, respectively, by using the coordinate conversion information (coordinate conversion matrix C_{b}^{m}) from the b frame into the m frame, calculated by the integral processing portion 220. The coordinate conversion portion 250 performs a coordinate conversion process of converting the velocities in the three-axis directions, the attitude angles about the three axes, and the distances in the three-axis directions of the e frame calculated by the integral processing portion 220 into velocities in the three-axis directions, attitude angles about the three axes, and distances in the three-axis directions of the m frame, respectively, by using the coordinate conversion information (coordinate conversion matrix Cₑ^{m}) from the e frame into the m frame, calculated by the integral processing portion 220. The coordinate conversion portion 250 performs a coordinate conversion process of converting the position of the e frame calculated by the integral processing portion 220 into a position of the n frame, respectively, by using the coordinate conversion information (coordinate conversion matrix Cₑⁿ) from the e frame into the n frame, calculated by the integral processing portion 220.

The inertial navigation calculation unit 22 outputs calculation data (stores the calculation data in the storage unit 30) including information regarding the accelerations, the angular velocities, the velocities, the position, the attitude angles, and the distances having undergone the coordinate conversion in the coordinate conversion portion 250, and the stride, the running pitch, and the left-right foot flag calculated by the running processing portion 240.

### 1-6. Functional Configuration of Exercise Analysis Unit

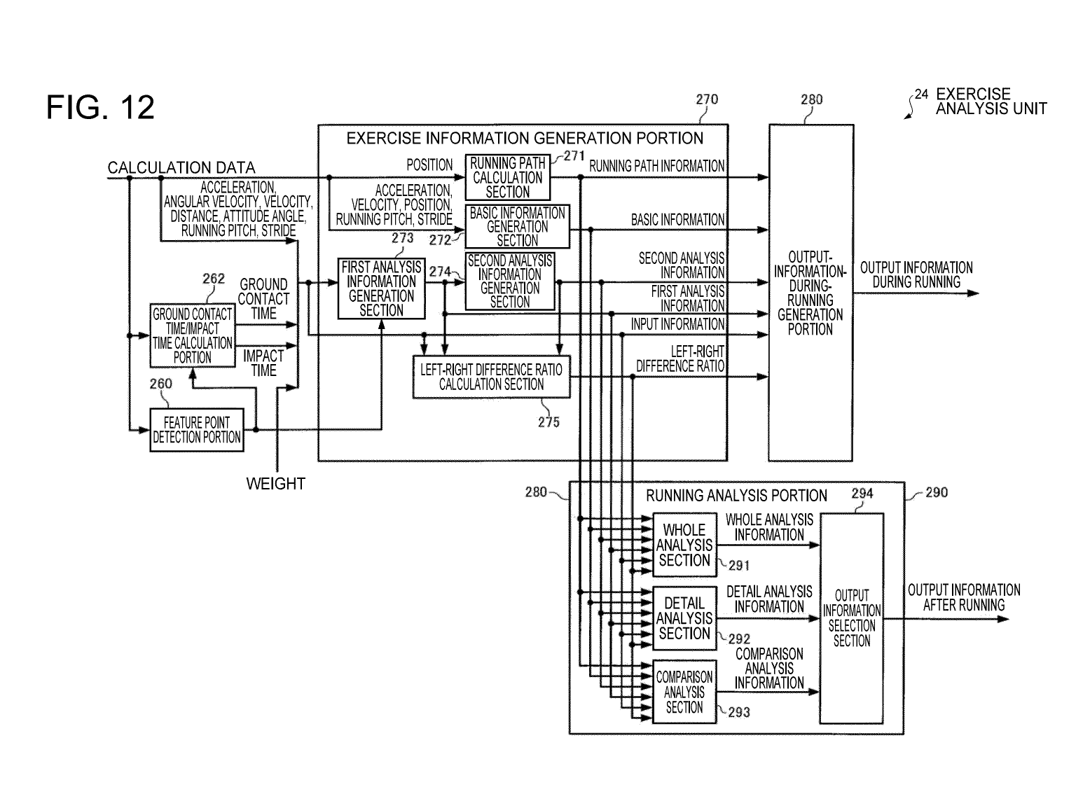

FIG. 12 is a functional block diagram illustrating a configuration example of the exercise analysis unit 24 in the first embodiment. In the present embodiment, the exercise analysis unit 24 includes a feature point detection portion 260, a ground contact time/impact time calculation portion 262, an exercise information generation portion 270, an output-information-during-running generation portion 280, and a running analysis portion 290. However, the exercise analysis unit 24 of the present embodiment may have a configuration in which some of the constituent elements are deleted or changed, or other constituent elements may be added thereto.

The feature point detection portion 260 performs a process of detecting a feature point in the running exercise of the user by using the calculation data. The feature point in the exercise of the user is a data part corresponding to a feature portion of an action (in the present embodiment, a running exercise) of the user. The feature point is, for example, landing (a timing at which the user's foot lands on the ground), stepping (a timing at which the user's weight is applied to the foot most), or taking-off (also referred to as kicking) (a timing at which the user's foot leaves the ground). Specifically, the feature point detection portion 260 separately detects a feature point at the running cycle for the right foot and a feature point at the running cycle for the left foot by using the left-right foot flag included in the calculation data.

The ground contact time/impact time calculation portion 262 performs a process of calculating each value of a ground contact time and an impact time with the timing at which the feature point is detected by the feature point detection portion 260 as a reference, by using the calculation data. For example, the ground contact time/impact time calculation portion 262 determines whether the present calculation data corresponds to calculation data for the right foot running cycle or calculation data for the left foot running cycle on the basis of the left-right foot flag included in the calculation data, and calculates each value of the ground contact time and the impact time with the timing at which the feature point is detected by the feature point detection portion 260 as a reference, for each of the right foot running cycle and the left foot running cycle. Details of definition and a calculation method of the ground contact time and the impact time will be described later.

The exercise information generation portion 270 includes a running path calculation section 271, a basic information generation section 272, a first analysis information generation section 273, a second analysis information generation section 274, and a left-right difference ratio calculation section 275, and performs a process of analyzing exercise of the user so as to generate a plurality of exercise information pieces for improving running attainments of the user, by using some calculation data or input information. Here, the input information is information which is input to the first analysis information generation section 273, and includes respective items of the running pitch, the stride, the accelerations in the three-axis directions of the m frame, the angular velocities about the three axes thereof, the velocities in the three-axis directions thereof, the distances in the three-axis directions thereof, and the attitude angles about the three axes thereof, included in the calculation data, the ground contact time and the impact time calculated by the ground contact time/impact time calculation portion 262, and a user's weight. Specifically, the exercise information generation portion 270 performs a process of analyzing exercise of the user with a timing at which the feature point is detected by the feature point detection portion 260 as a reference by using the input information, and of generating, as exercise information pieces, each item of the basic information, each item of the first analysis information, each item of the second analysis information, each item of the left-right difference ratio, the running path information, and the like.

The running path calculation section 271 performs a process of calculating a running path of the user in n frames by using time-series information regarding positions of the n frames included in the calculation data and of generating running path information which is one of the exercise information pieces.

The basic information generation section 272 performs a process of generating basic information regarding the exercise of the user by using the information regarding the acceleration, the velocity, the position, the stride, and the running pitch included in the calculation data. Here, the basic information includes respective items such as the running pitch, the stride, the running velocity, the elevation, the running distance, and the running time (lap time). Each item of the basic information is a single exercise information piece. Specifically, the basic information generation section 272 outputs the running pitch and the stride included in the calculation data as a running pitch and a stride of the basic information. The basic information generation section 272 calculates exercise information such as the present value or an average value during running of the running velocity, the elevation, the running distance, and the running time (lap time) by using some or all of the acceleration, the velocity, the position, the running pitch, and the stride included in the calculation data.

The first analysis information generation section 273 performs a process of analyzing the exercise of the user with the timing at which the feature point is detected by the feature point detection portion 260 as a reference, by using the input information, so as to generate first analysis information. Here, the first analysis information includes respective items such as brake amounts in landing (a brake amount 1 in landing and a brake amount 2 in landing), directly-below landing ratios (a directly-below landing ratio 1, a directly-below landing ratio 2, and a directly-below landing ratio 3), propulsion forces (a propulsion force 1 and a propulsion force 2), propulsion efficiency (propulsion efficiency 1, propulsion efficiency 2, propulsion efficiency 3, and propulsion efficiency 4), an amount of energy consumption, a landing impact, running performance, a forward tilt angle, and timing coincidence. Each item of the first analysis information indicates a running state (an example of an exercise state) of the user, and is a single piece of exercise information. Details of the content of each item and a computation method of the first analysis information will be described later.

In the present embodiment, the first analysis information generation section 273 calculates values of some of the items of the first analysis information by using the input information at the timing at which the feature point is detected by the feature point detection portion 260. The first analysis information generation section 273 calculates values of at least some of the items of the first analysis information by using the input information at a timing at which the next feature point is detected after the feature point is detected by the feature point detection portion 260 (the timing may be a time period between the two same feature points (for example, between landing and the next landing) or between two different feature points (for example, between landing and taking-off)).

The first analysis information generation section 273 calculates a value of each item of the first analysis information for the respective left and right sides of the user's body. Specifically, the first analysis information generation section 273 calculates each item included in the first analysis information for the right foot running cycle and the left foot running cycle depending on whether the feature point detection portion 260 has detected the feature point at the right foot running cycle or the feature point at the left foot running cycle. The first analysis information generation section 273 calculates an average value or a total value of the left and right sides for each item included in the first analysis information.

The second analysis information generation section 274 performs a process of generating second analysis information by using the first analysis information generated by the first analysis information generation section 273. Here, the second analysis information includes respective items such as energy loss, energy efficiency, and a burden on the body. Each item of the second analysis information is a single exercise information piece. Details of the content of each item and a calculation method of the second analysis information will be described later. The second analysis information generation section 274 calculates a value of each item of the second analysis information for the right foot running cycle and the left foot running cycle. The second analysis information generation section 274 calculates an average value or a total value of the left and right sides for each item included in the second analysis information.

The left-right difference ratio calculation section 275 performs a process of calculating a left-right difference ratio which is an index indicating a balance between the left and right sides of the user's body by using values at the right foot running cycle and values at the left foot running cycle with respect to the running pitch, the stride, the ground contact time, and the impact time included in the input information, all the items of the first analysis information, and all the items of the second analysis information. The left-right difference ratio of each item is a single exercise information piece. Details of the content and a computation method of the left-right difference ratio will be described later.

The output-information-during-running generation portion 280 performs a process of generating output information during running which is information which is output during the user's running, by using a plurality of exercise information pieces including the running path information, each item of the basic information, each item of the input information, each item of the first analysis information, each item of the second analysis information, the left-right difference ratio of each item, and the like.

In the present embodiment, the output-information-during-running generation portion 280 compares at least one of a plurality of exercise information pieces with a reference value which is set in advance, and generates output information during running on the basis of a comparison result. Specifically, the output-information-during-running generation portion 280 may generate the output information during running on the basis of at least one exercise information piece which satisfies a predetermined condition among the plurality of exercise information pieces. The predetermined condition is a condition regarding whether or not the exercise information is correct. As the predetermined condition, a running state of the user may be better than a criterion, and a running state of the user may be worse than a reference. For example, the output-information-during-running generation portion 280 may output only the best items, and, conversely, may output the worst items, as the output information during running. For example, the output information during running may be an item in which the extent of improvement (improvement in exercise information) in a running state of the user is greater than a reference, and may be an item in which the extent of deterioration (deterioration in exercise information) in a running state is equal to or greater than a reference. Alternatively, each item may be divided in stages and may be evaluated, and, as the output information during running, only items with the highest evaluation (for example, a rank 1 of ranks 1 to 5) may be output, and, conversely, only items with the lowest evaluation (for example, a rank 5 of ranks 1 to 5) may be output. The output-information-during-running generation portion 280 may include, as the output information during running, evaluation information (evaluation in stages, or the like) for evaluating a running state of the user, or advice information regarding an advice for improving running attainments of the user or an advice for improving a running state of the user.

For example, in a case where a value of the propulsion efficiency included in the first analysis information satisfies a predetermined condition (within a reference range or out of the reference range), the output-information-during-running generation portion 280 may generate output information during running including information for performing a notification that a numerical value of the propulsion efficiency or the propulsion efficiency is higher (lower) than a reference value. Alternatively, the output-information-during-running generation portion 280 may generate output information during running including evaluation information indicating that the propulsion efficiency is high or advice information for improving the propulsion efficiency.

The output-information-during-running generation portion 280 may generate output information during running by processing some or all of the various information pieces without being changed, and may generate output information during running by combining some or all of the various information pieces with each other.

The processing unit 20 transmits the output information during running to the display apparatus 3. The display apparatus 3 receives the output information during running so as to generate data such as corresponding to images, sound, or vibration, and presents (delivers) the data to the user via the display unit 170, the sound output unit 180, and the vibration unit 190.

The running analysis portion 290 includes a whole analysis section 291, a detail analysis section 292, a comparison analysis section 293, and an output information selection section 294, and performs a process of generating output information after running (an example of output information after an exercise) which is information which is output after the user finishes running, on the basis of at least one exercise information piece of the plurality of exercise information pieces (the running path information, each item of the basic information, each item of the input information, each item of the first analysis information, each item of the second analysis information, the left-right difference ratio of each item, and the like) stored in the storage unit 30.

The whole analysis section 291 performs a process of wholly analyzing (generally analyzing) past running of the user by using the various exercise information pieces stored in the storage unit 30, so as to generate whole analysis information which is information indicating an analysis result. Specifically, the whole analysis section 291 performs an average value calculation process, a process of selecting a final value when running is finished, a process of determining whether or not the value is better (or worse) than a reference value or whether or not an improvement ratio is higher (or lower) than a reference value, and the like, on some or all exercise information pieces in running on the date selected by the user. The whole analysis section 291 performs a process or the like of calculating (or selecting) an average value (or a final value) for each running date, on a predetermined item which is set in advance or an item selected by the user. The whole analysis section 291 performs a process or the like of selecting running path information in running on the date selected by the user.

The detail analysis section 292 performs a process of analyzing past running of the user in detail by using the various exercise information pieces stored in the storage unit 30, so as to generate detail analysis information which is information indicating an analysis result. Specifically, the detail analysis section 292 performs a process of selecting values of some or all of the items of the various exercise information pieces at a time point selected by the user or a process of generating time-series data of an item selected by the user, on running on the date selected by the user. The detail analysis section 292 performs a process of selecting running path information in running on the date selected by the user, a process of calculating a running position at a time point selected by the user, or a process of calculating time-series data of the left-right difference ratio of a predetermined item or an item selected by the user. The detail analysis section 292 performs a process or the like of evaluating running attainments in running on the date selected by the user and of generating information regarding an evaluation result or information regarding advices of a method for improving a running type, a method for reducing time, or a training instruction.

The comparison analysis section 293 performs a process or the like of comparing a plurality of past running results of the user with each other for analysis, or comparing a past running result of the user with a running result of another user for analysis, by using the various exercise information pieces stored in the storage unit 30, so as to generate comparison analysis information which is information indicating an analysis result. Specifically, the comparison analysis section 293 performs a process of generating comparison analysis information which is the same as the detail analysis information on running for each of a plurality of dates selected by the user, or a process of generating comparison analysis information which is the same as detail analysis information on running on the date selected by the user and past running of another user.

The output information selection section 294 performs a process of selecting any one of the whole analysis information, the detail analysis information, and the comparison analysis information in response to a user's selection operation and of outputting the selected information as output information after running.

The output information after running may include exercise information which is not output during the user's running among the plurality of exercise information pieces, that is, exercise information which is not included in the output information during running. Alternatively, the output information after running may include exercise information which is output during the user's running among the plurality of exercise information pieces, that is, exercise information included in the output information during running. The output information after running may include information regarding an advice for improving running attainments of the user or an advice for improving a running state of the user. The output information after running may include information (information other than exercise information generated by the exercise information generation portion 270 during the user's running) which is generated by the running analysis portion 290 after the user finishes running.

The processing unit 20 transmits the output information after running to the display apparatus 3 or an information apparatus such a personal computer or a smart phone (neither thereof illustrated). The display apparatus 3 or the information apparatus receives the output information after running so as to generate data such as corresponding to images, sound, or vibration, and presents (delivers) the data to the user via the display unit, the sound output unit, and the vibration unit.

### 1-7. Detection of Feature Point

During the user's running, the user repeatedly performs operations such as landing by taking a step forward with the right foot, stepping, taking-off (kicking), then, landing by taking a step forward with the left, stepping, and taking-off (kicking). Therefore, the landing, the stepping, and the taking-off (kicking) may be understood as feature points of running. The exercise can be evaluated whether the exercise is good or bad on the basis of input information in such feature points or input information from the feature point to the next feature point. Therefore, in the present embodiment, the feature point detection portion 260 detects three feature points including the landing, the stepping, and the taking-off (kicking) in the user's running, and the ground contact time/impact time calculation portion 262 calculates the ground contact time or the impact time on the basis of a timing of the landing or the taking-off (kicking). The first analysis information generation section 273 calculates some items of the first analysis information by using input information in the feature point or input information from the feature point to the next feature point.

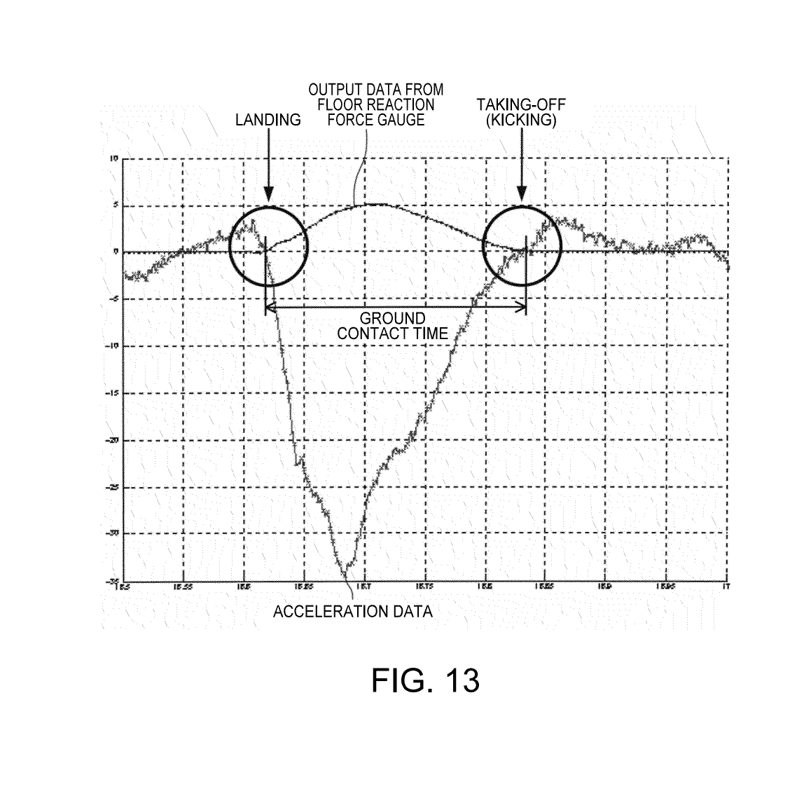

A method of determining timings of the landing and the taking-off (kicking) will be described with reference to FIG. 13. FIG. 13 is a graph of acceleration data acquired when a floor reaction force gauge is installed on the ground, and a subject wearing an apparatus into which a three-axis acceleration sensor is built on the subject's waist runs. In FIG. 13, a transverse axis expresses time, and a longitudinal axis expresses acceleration. In FIG. 13, output date of the floor reaction force gauge is also displayed in parallel. Since a detected value of the floor reaction force gauge changes only when the foot contacts the ground, when data of the floor reaction force gauge is compared with acceleration data, it can be seen from FIG. 13 that a landing timing can be determined as being a point where a vertical acceleration (a detected value in the z axis of the acceleration sensor) changes from a positive value to a negative value. A taking-off (kicking) timing can be determined as being a point where a vertical acceleration (a detected value in the z axis of the acceleration sensor) changes from a negative value to a positive value. As illustrated in FIG. 13, the ground contact time can be computed as a difference between a time point of the taking-off and a time point of the landing.

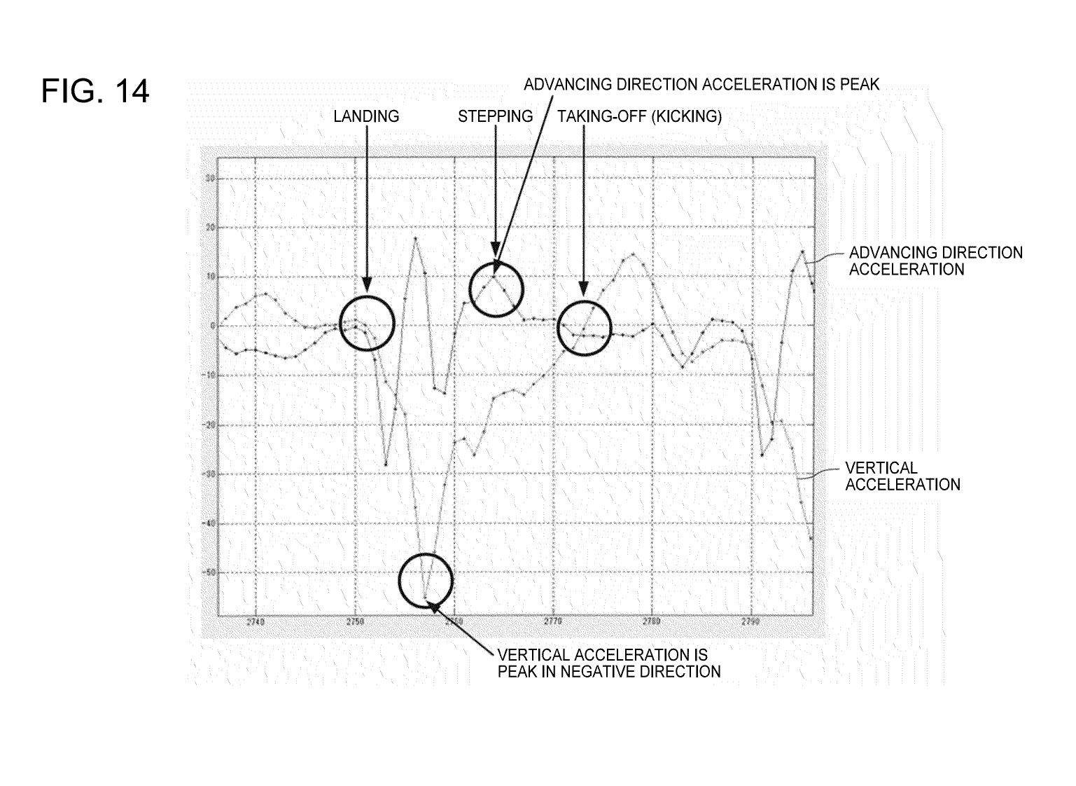

With reference to FIG. 14, a description will be made of a method of determining a stepping timing. In FIG. 14, a transverse axis expresses time, and a longitudinal axis expresses acceleration. As illustrated in FIG. 14, after the landing (a point where a vertical acceleration changes from a positive value to a negative value), a point where an advancing direction acceleration has a peak from a point where the vertical acceleration has a peak in the negative direction can be determined as being the stepping timing.

### 1-8. Details of Input Information and Analysis Information

### 1-8-1. Relationship Between Input Information and Analysis Information

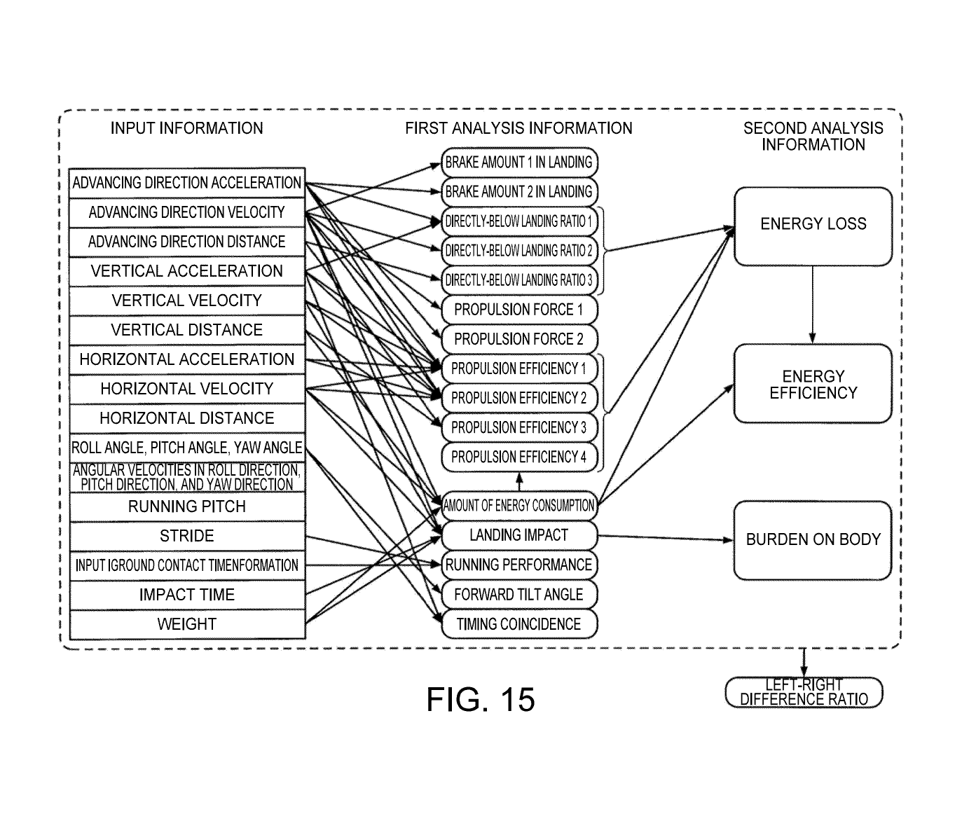

FIG. 15 is a diagram illustrating a relationship between input information and analysis information (the first analysis information, the second analysis information, and the left-right difference ratio).

The input information includes respective items such as the “advancing direction acceleration”, the “advancing direction velocity”, the “advancing direction distance”, the “vertical acceleration”, the “vertical velocity”, the “vertical distance”, the “horizontal acceleration”, the “horizontal velocity”, the “horizontal distance”, the “attitude angles (a roll angle, a pitch angle, and a yaw angle)”, the “angular velocities (in a roll direction, a pitch direction, and a yaw direction)”, the “running pitch”, the “stride”, the “ground contact time”, the “impact time”, and the “weight”.

The first analysis information include items such as the “break amount 1 in landing”, the “break amount 2 in landing”, the “directly-below landing ratio 1”, the “directly-below landing ratio 2”, the “directly-below landing ratio 3”, the “propulsion force 1”, the “propulsion force 2”, the “propulsion efficiency 1”, the “propulsion efficiency 2”, the “propulsion efficiency 3”, “propulsion efficiency 4”, the “amount of energy consumption”, the “landing impact”, the “running performance”, the “forward tilt angle”, and “timing coincidence”. The respective items excluding the “propulsion efficiency 4” included in the first analysis information are calculated by using at least one item of the input information. The “propulsion efficiency 4” is calculated by using the amount of energy consumption. FIG. 15 shows the items of the first analysis information, which are calculated by using the items of the input information with the arrows. For example, the “directly-below landing ratio 1” is calculated by using the advancing direction acceleration and the vertical velocity.

The second analysis information includes items such as the “energy loss”, the “energy efficiency”, and the “burden on the body”. The respective items included in the second analysis information are calculated by using at least one item of the first analysis information. FIG. 15 shows the items of the second analysis information, which are calculated by using the items of the first analysis information with the arrows. For example, the “energy loss” is calculated by using the “directly-below landing ratios (directly-below landing ratios 1 to 3)” and the “propulsion efficiency (propulsion efficiency 1 to 4)”.

The left-right difference ratio is an index indicating a balance between the left and right sides of the user's body, and is calculated for the “running pitch”, the “stride”, the “ground contact time”, the “impact time”, all of the items of the first analysis information, and all of the items of the second analysis information.

### 1-8-2. Input Information

Hereinafter, a description will be made of details of each item of the input information.

### Advancing Direction Acceleration, Vertical Acceleration, and Horizontal Acceleration

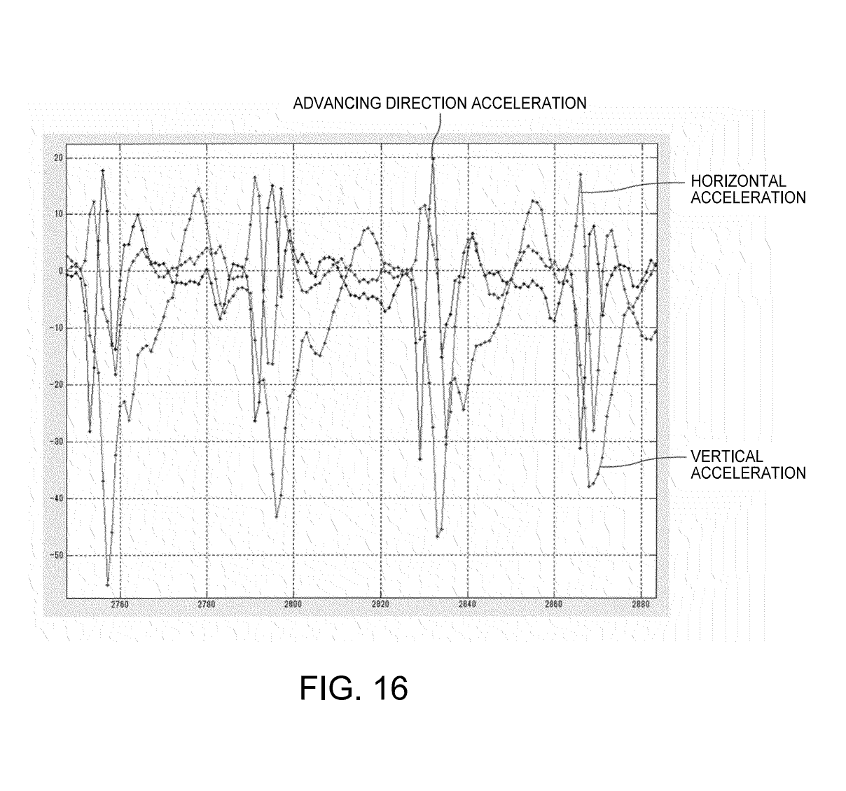

The “advancing direction” is an advancing direction (the x axis direction of the m frame) of the user, the “vertical direction” is a perpendicular direction (the z axis direction of the m frame), and the “horizontal direction” is a direction (the y axis direction of the m frame) perpendicular to both the advancing direction and the vertical direction. The advancing direction acceleration, the vertical acceleration, and the horizontal acceleration are respectively an acceleration in the x axis direction of the m frame, an acceleration in the z axis direction thereof, and an acceleration in the y axis direction thereof, and are calculated by the coordinate conversion portion 250. FIG. 16 illustrates an example of a graph in which the advancing direction acceleration, the vertical acceleration, and the horizontal acceleration during the user's running are calculated at a cycle of 10 ms.

### Advancing Direction Velocity, Vertical Velocity, and Horizontal Velocity

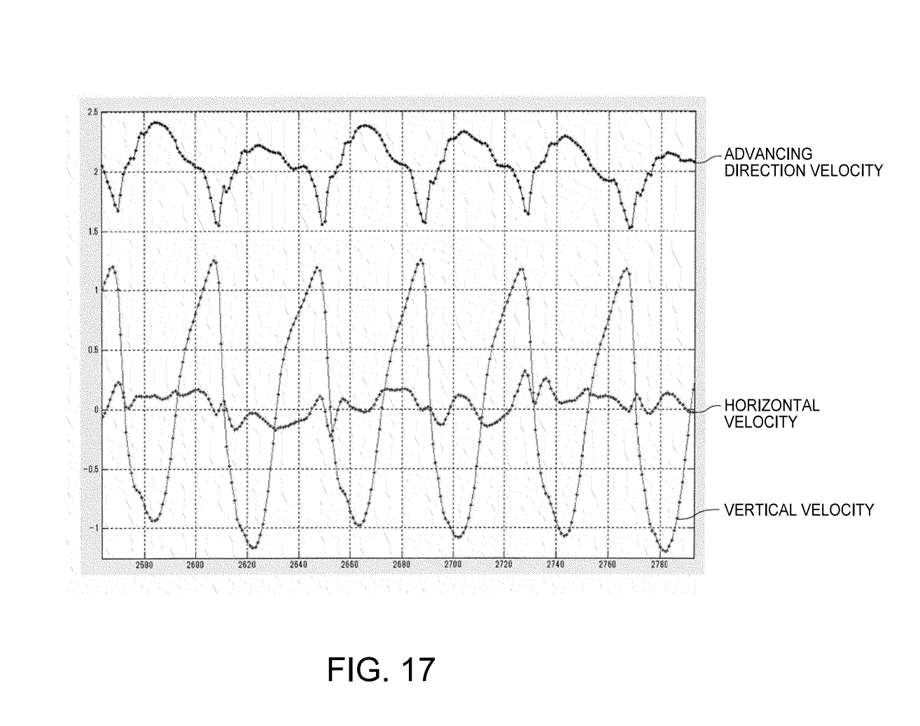

The advancing direction velocity, the vertical velocity, and the horizontal velocity are respectively a velocity in the x axis direction of the m frame, a velocity in the z axis direction thereof, and a velocity in the y axis direction thereof, and are calculated by the coordinate conversion portion 250. Alternatively, the advancing direction velocity, the vertical velocity, and the horizontal velocity may be respectively calculated by integrating the advancing direction acceleration, the vertical acceleration, and the horizontal acceleration. FIG. 17 illustrates an example of a graph in which the advancing direction velocity, the vertical velocity, and the horizontal velocity during the user's running are calculated at a cycle of 10 ms.

### Angular Velocities (in Roll Direction, Pitch Direction, and Yaw Direction)

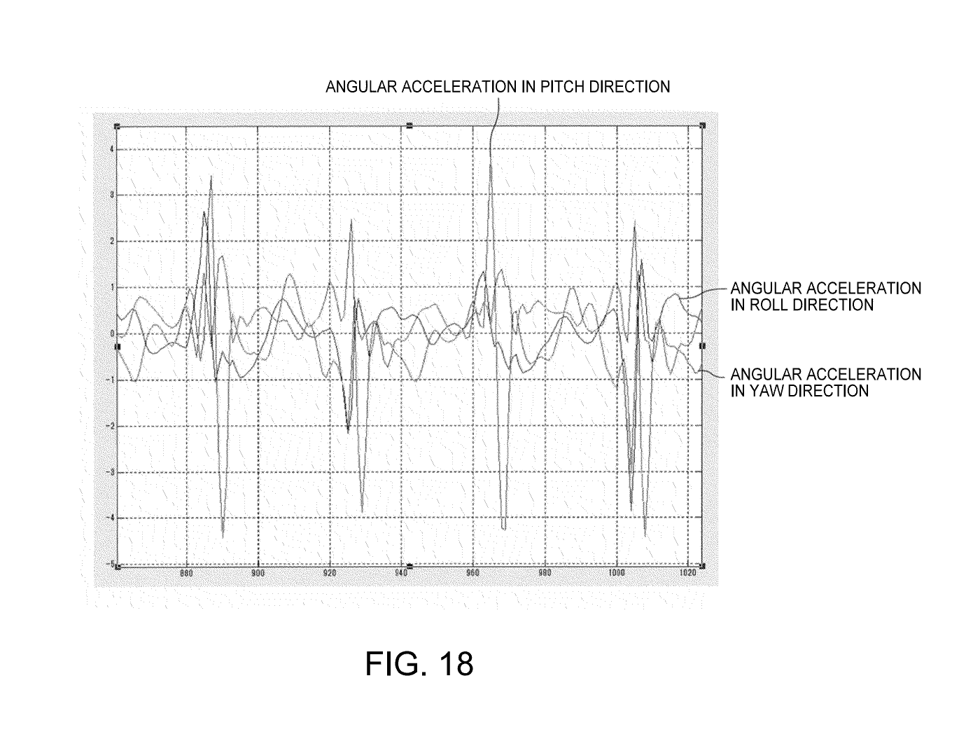

The angular velocity in the roll direction, the angular velocity in the pitch direction, and the angular velocity in the yaw direction are respectively an angular velocity about the x axis of the m frame, an angular velocity about the y axis thereof, and an angular velocity about the z axis thereof, and are calculated by the coordinate conversion portion 250. FIG. 18 illustrates an example of a graph in which the angular velocity in the roll direction, the angular velocity in the pitch direction, and the angular velocity in the yaw direction during the user's running are calculated at a cycle of 10 ms.

### Attitude Angles (Roll Angle, Pitch Angle, and Yaw Angle)

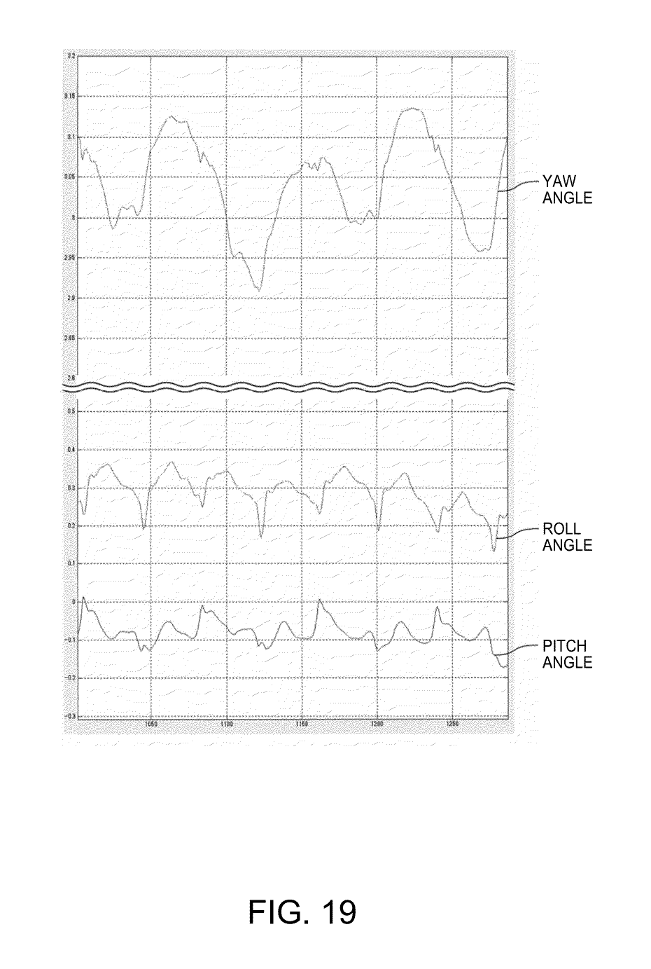

The roll angle, the pitch angle, and the yaw angle are respectively an attitude angle about the x axis of the m frame, an attitude angle about the y axis thereof, and an attitude angle about the z axis thereof, output from the coordinate conversion portion 250, and are calculated by the coordinate conversion portion 250. Alternatively, the roll angle, the pitch angle, and the yaw angle may be respectively calculated by integrating (performing rotation calculation on) the angular velocity in the roll direction, the angular velocity in the pitch direction, and the angular velocity in the yaw direction. FIG. 19 illustrates an example of a graph in which the roll angle, the pitch angle, and the yaw angle during the user's running are calculated at a cycle of 10 ms.

### Advancing Direction Distance, Vertical Distance, and Horizontal Distance

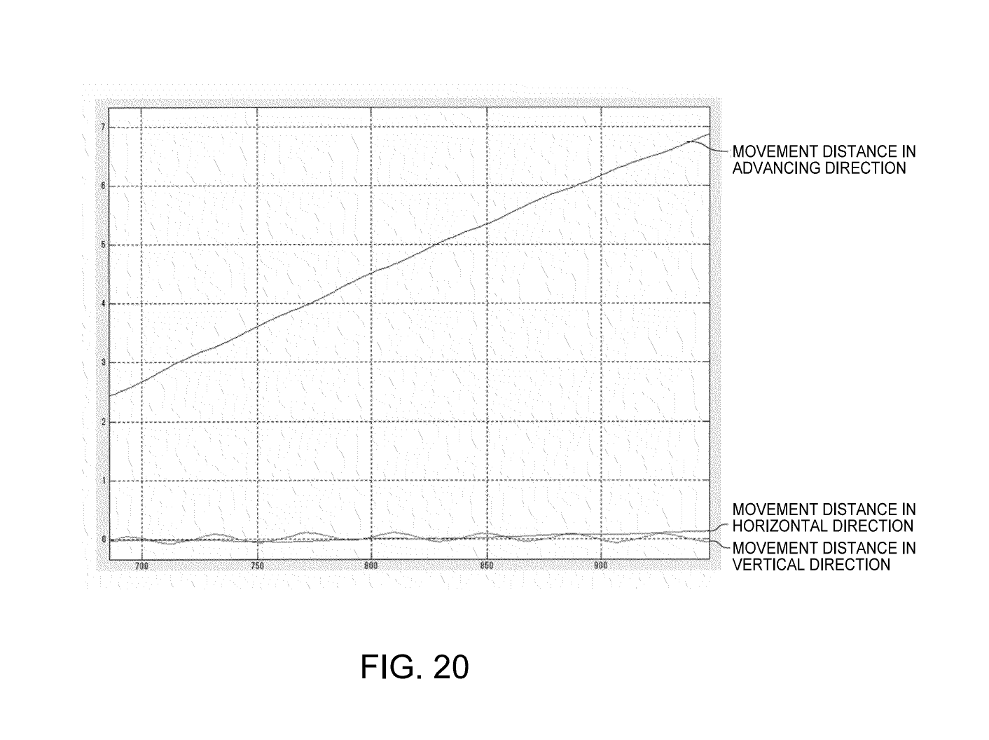

The advancing direction distance, the vertical distance, and the horizontal distance are respectively a movement distance in the x axis direction of the m frame, a movement distance in the y axis direction thereof, and a movement distance in the z direction thereof from a desired position (for example, a position right before the user's running), and are calculated by the coordinate conversion portion 250. FIG. 20 illustrates an example of a graph in which the advancing direction distance, the vertical distance, and the horizontal distance during the user's running are calculated at a cycle of 10 ms.

### Running Pitch

The running pitch is an exercise index defined as the number of steps per one minute, and is calculated by the pitch calculation section 246. Alternatively, the running pitch may be calculated by dividing an advancing direction distance for one minute by the number of steps.

### Stride

The stride is an exercise index defined as one step, and is calculated by the stride calculation section 244. Alternatively, the stride may be calculated by dividing an advancing direction distance for one minute by the running pitch.

### Ground Contact Time

The ground contact time is an exercise index defined as time taken from landing to taking-off (kicking) (refer to FIG. 13), and is calculated by the ground contact time/impact time calculation portion 262. The taking-off (kicking) indicates the time when the toe leaves the ground. The ground contact time has a high correlation with a running speed, and may thus be used as running performance of the first analysis information.

### Impact Time

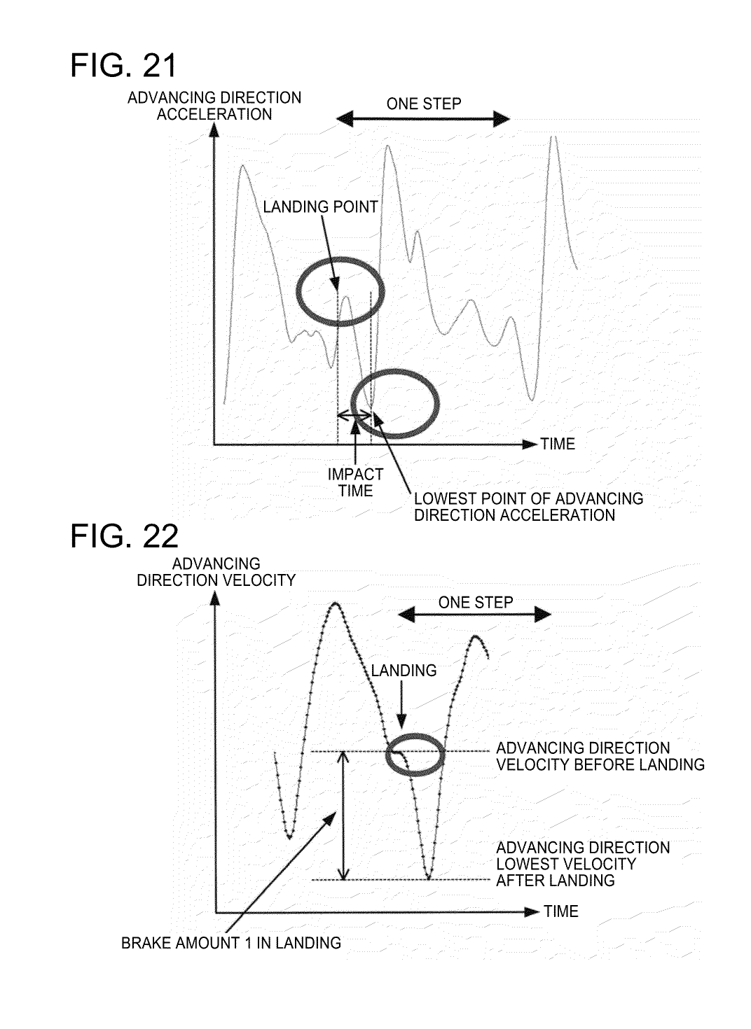

The impact time is an exercise index defined as time when an impact caused by landing is being applied to the body, and is calculated by the ground contact time/impact time calculation portion 262. A method of computing the impact time will be described with reference to FIG. 21. In FIG. 21, a transverse axis expresses time, and a longitudinal axis expresses advancing direction acceleration. As illustrated in FIG. 21, the impact time may be computed as the impact time=(time point at which advancing direction acceleration is the minimum during one step−a time point of landing).

### Weight

The weight is a user's weight, and a numerical value thereof is input by the user operating the operation unit 150 before running.

### 1-8-3. First Analysis Information

Hereinafter, a description will be made of details of each item of the first analysis information calculated by the first analysis information generation section 273.

### Brake Amount 1 in Landing

The brake amount 1 in landing is an exercise index defined as an amount of velocity which is reduced due to landing. A method of computing the brake amount 1 in landing will be described with reference to FIG. 22. In FIG. 22, a transverse axis expresses time, and a longitudinal axis expresses advancing direction velocity. As illustrated in FIG. 22, the brake amount 1 in landing may be computed as (advancing direction velocity before landing)−(advancing direction lowest velocity after landing). The velocity in the advancing direction is reduced due to landing, and the lowest point in the advancing direction velocity after the landing during one step is the advancing direction lowest velocity.

### Brake Amount 2 in Landing

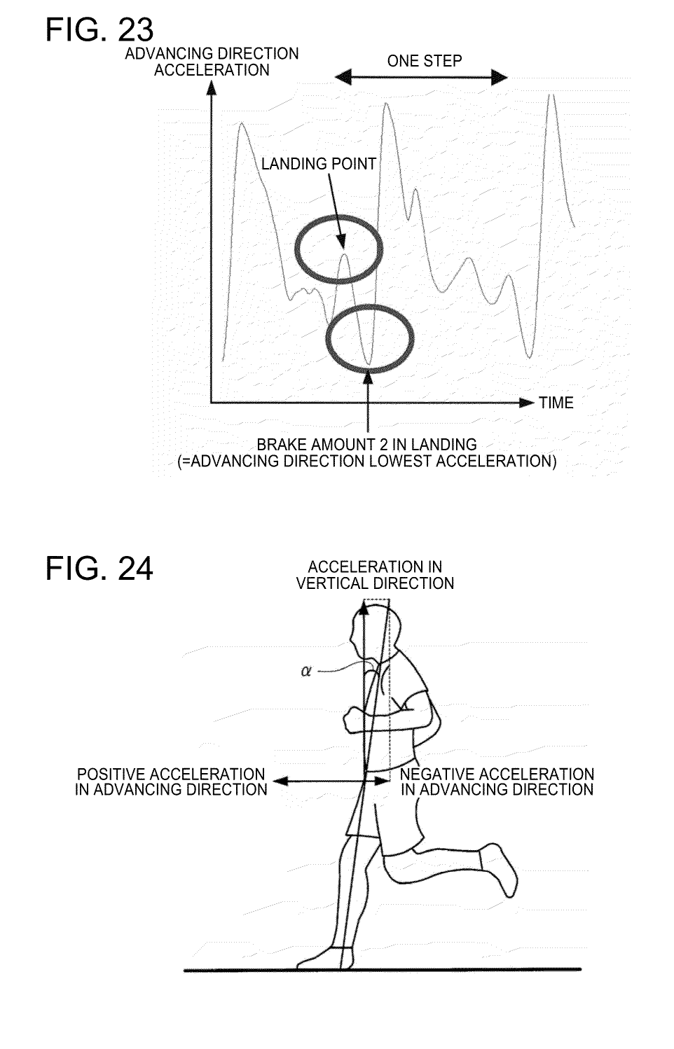

The brake amount 2 in landing is an exercise index defined as an amount of the lowest acceleration in the advancing direction, caused by landing. A description will be made of a method of computing the brake amount 2 in landing with reference to FIG. 23. In FIG. 23, a transverse axis expresses time, and a longitudinal axis expresses advancing direction acceleration. As illustrated in FIG. 23, the brake amount 2 in landing matches the advancing direction lowest acceleration after landing during one step. The lowest point of the advancing direction acceleration after landing during one step is the advancing direction lowest acceleration.

### Directly-Below Landing Ratio 1

The directly-below landing ratio 1 is an exercise index which expresses whether landing is performed directly below the body. If the landing is performed directly under the body, a brake amount is reduced at the time of landing, and thus efficient running can be performed. Typically, since a brake amount increases according to velocity, only the brake amount is not sufficient as indexes, but the directly-below landing ratio 1 is an index which can be expressed in a ratio, and thus the same evaluation can be performed even if velocity changes by using the directly-below landing ratio 1. A description will be made of method of computing the directly-below landing ratio 1 with reference to FIG. 24. As illustrated in FIG. 24, if the advancing direction acceleration (negative acceleration) and the vertical acceleration in landing are used, and α is set as α=arctan(advancing direction acceleration in landing/vertical acceleration in landing), the directly-below landing ratio 1 may be computed as the directly-below landing ratio 1=cos α×100(%). Alternatively, an ideal angle α′ may be calculated by using data of a plurality of people who run fast, and the directly-below landing ratio 1 may be computed as the directly-below landing ratio 1={1−|(α′−α)/α′|}×100(%).

### Directly-Below Landing Ratio 2

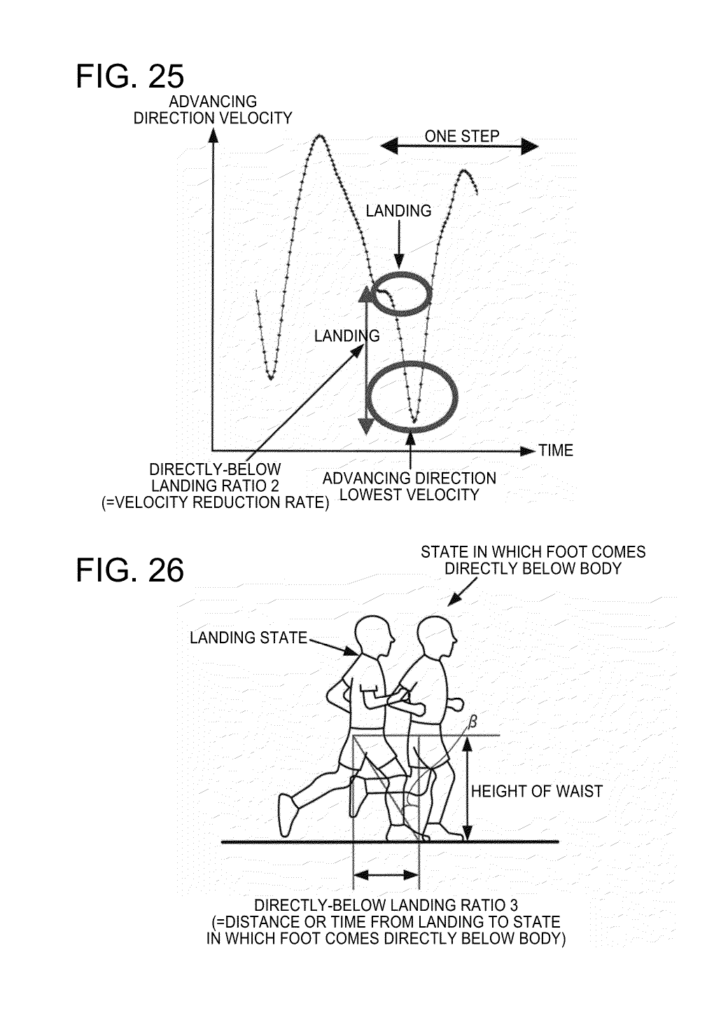

The directly-below landing ratio 2 is an exercise index which expresses whether or not landing is performed directly below the body as the extent in which velocity is reduced in landing. A description will be made of a method of computing the directly-below landing ratio 2 with reference to FIG. 25. In FIG. 25, a transverse axis expresses time, and a longitudinal axis expresses advancing direction velocity. As illustrated in FIG. 25, the directly-below landing ratio 2 is computed as the directly-below landing ratio 2=(advancing direction lowest velocity after landing/advancing direction velocity right before landing)×100(%).

### Directly-Below Landing Ratio 3

The directly-below landing ratio 3 is an exercise index which expresses whether or not landing is performed directly below the body as a distance or time until the foot comes directly under the body from landing. A description will be made of a method of computing the directly-below landing ratio 3 with reference to FIG. 26. As illustrated in FIG. 26, the directly-below landing ratio 3 may be computed as the directly-below landing ratio 3=(advancing direction distance when the foot comes directly below the body)−(advancing direction distance in landing), or the directly-below landing ratio 3=(time point when the foot comes directly below the body)−(time point in landing). Here, as illustrated in FIG. 14, there is a timing at which the vertical acceleration has a peak in the negative direction after landing (a point where the vertical acceleration changes from a positive value to a negative value), and this timing may be determined as being a timing (time point) at which the foot comes directly below the body.

In addition, as illustrated in FIG. 26, the directly-below landing ratio 3 may be defined as the directly-below landing ratio 3=β=arctan(the distance until the foot comes directly below the body/the height of the waist). Alternatively, the directly-below landing ratio 3 may be defined as the directly-below landing ratio 3=(1−the distance until the foot comes directly below the body/a movement distance from landing to kicking)×100(%) (a ratio occupied by the distance until the foot comes directly below the body in the movement distance during the foot's contact on the ground). Alternatively, the directly-below landing ratio 3 may be defined as the directly-below landing ratio 3=(1−the time until the foot comes directly below the body/movement time from landing to kicking)×100(%) (a ratio occupied by the time until the foot comes directly below the body in the movement time during the foot's contact on the ground).

### Propulsion Force 1

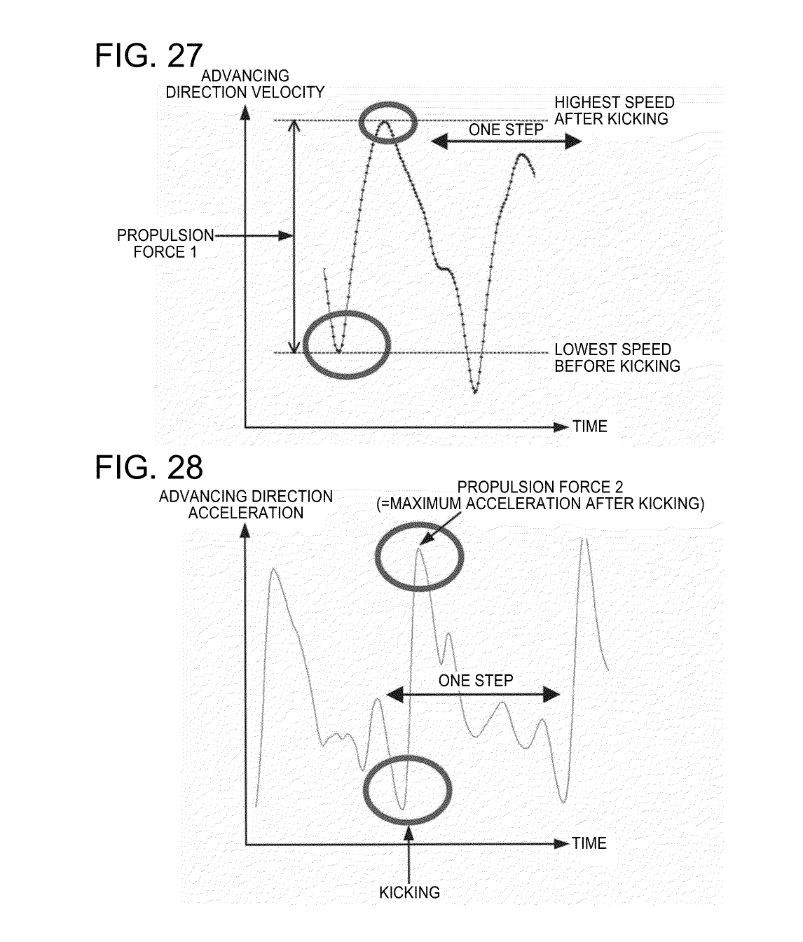

The propulsion force 1 is an exercise index defined as a velocity amount which is increased in the advancing direction by kicking the ground. A description will be made of a method of computing the propulsion force 1 with reference to FIG. 27. In FIG. 27, a transverse axis expresses time, and a longitudinal axis expresses advancing direction velocity. As illustrated in FIG. 27, the propulsion force 1 may be computed as the propulsion force 1=(advancing direction highest velocity after kicking)−(advancing direction lowest velocity before kicking).

### Propulsion Force 2

The propulsion force 2 is an exercise index defined as the maximum acceleration which is increased in the advancing direction by kicking the ground. A description will be made of a method of computing the propulsion force 2 with reference to FIG. 28. In FIG. 28, a transverse axis expresses time, and a longitudinal axis expresses advancing direction acceleration. As illustrated in FIG. 28, the propulsion force 2 matches the advancing direction maximum acceleration after kicking during one step.

### Propulsion Efficiency 1

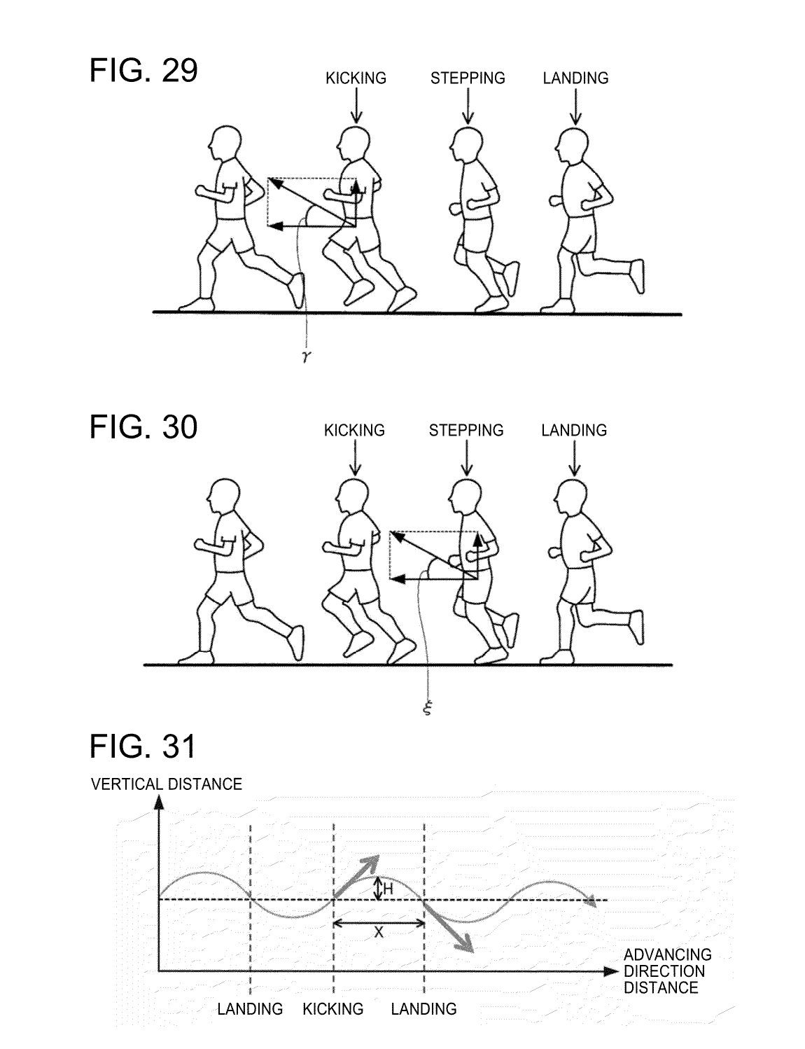

The propulsion efficiency 1 is an exercise index indicating whether or not a kicking force is efficiently converted into a propulsion force. If a useless vertical movement and a useless horizontal movement are removed, efficient running is possible. Generally, since the vertical movement and the horizontal movement increase according to velocity, only the vertical movement and the horizontal movement are not sufficient, but the propulsion efficiency 1 is an index which can be expressed in a ratio, and thus the same evaluation can be performed even if velocity changes by using the propulsion efficiency 1. The propulsion efficiency 1 is computed for each of the vertical direction and the horizontal direction. A description will be made of a method of computing the propulsion efficiency 1 with reference to FIG. 29. As illustrated in FIG. 29, if the vertical acceleration and the advancing direction acceleration in kicking are used, and γ is set as γ=arctan(vertical acceleration in kicking/advancing direction acceleration in kicking), the vertical propulsion efficiency 1 may be computed as the propulsion efficiency 1=cos γ×100(%). Alternatively, an ideal angle γ′ may be calculated by using data of a plurality of people who run fast, and the vertical propulsion efficiency 1 may be computed as the vertical propulsion efficiency 1={1−|(γ′−γ)/γ′|}×100(%). Similarly, if the horizontal acceleration and the advancing direction acceleration in kicking are used, and δ is set as δ=arctan(horizontal acceleration in kicking/advancing direction acceleration in kicking), the horizontal propulsion efficiency 1 may be computed as the propulsion efficiency 1=cos δ×100(%). Alternatively, an ideal angle δ′ may be calculated by using data of a plurality of people who run fast, and the horizontal propulsion efficiency 1 may be computed as horizontal propulsion efficiency 1={1−|(δ′−δ)/δ′|}×100(%).

In addition, the vertical propulsion efficiency 1 may be calculated by replacing γ with arctan(vertical velocity in kicking/advancing direction velocity in kicking). Similarly, the horizontal propulsion efficiency 1 may be calculated by replacing δ with arctan(horizontal velocity in kicking/advancing direction velocity in kicking).

### Propulsion Efficiency 2

The propulsion efficiency 2 is an exercise index indicating whether or not a kicking force is efficiently converted into a propulsion force by using an angle of acceleration in stepping. A description will be made of a method of computing the propulsion efficiency 2 with reference to FIG. 30. As illustrated in FIG. 30, if the vertical acceleration and the advancing direction acceleration in stepping are used, and ξ is set as ξ=arctan(vertical acceleration in stepping/advancing direction acceleration in stepping), the vertical propulsion efficiency 2 may be computed as the propulsion efficiency 2=cos ξ×100(%). Alternatively, an ideal angle ξ′ may be calculated by using data of a plurality of people who run fast, and the vertical propulsion efficiency 2 may be computed as the vertical propulsion efficiency 2={1−|(ξ′−ξ)/ξ′|}×100(%). Similarly, if the horizontal acceleration and the advancing direction acceleration in kicking are used, and η is set as η=arctan(horizontal acceleration in stepping/advancing direction acceleration in stepping), the horizontal propulsion efficiency 2 may be computed as the propulsion efficiency 2=cos η×100(%). Alternatively, an ideal angle η′ may be calculated by using data of a plurality of people who run fast, and the horizontal propulsion efficiency 2 may be computed as horizontal propulsion efficiency 2={1−|(η′−η)/η′|}×100(%).

In addition, the vertical propulsion efficiency 2 may be calculated by replacing ξ with arctan(vertical velocity in stepping/advancing direction velocity in stepping). Similarly, the horizontal propulsion efficiency 2 may be calculated by replacing η with arctan(horizontal velocity in stepping/advancing direction velocity in stepping).

### Propulsion Efficiency 3

The propulsion efficiency 3 is an exercise index indicating whether or not a kicking force is efficiently converted into a propulsion force by using an angle of rushing. A description will be made of a method of computing the propulsion efficiency 3 with reference to FIG. 31. In FIG. 31, a transverse axis expresses an advancing direction distance, and a longitudinal axis expresses a vertical distance. As illustrated in FIG. 31, if the highest arrival point (½ of the amplitude of the vertical distance) in the vertical direction during one step is denoted by H, and an advancing direction distance from kicking to landing is denoted by X, the propulsion efficiency 3 may be computed by using Equation (6).

$$Propulsion Efficiency 3 = arcsin ( \sqrt{\frac{16 {H}^{2}}{{X}^{2} + 16 {H}^{2}}} ) \qquad ( 6 )$$

### Propulsion Efficiency 4

The propulsion efficiency 4 is an exercise index indicating whether or not a kicking force is efficiently converted into a propulsion force by using a ratio of energy used to go forward in the advancing direction to total energy which is generated during one step. The propulsion efficiency 4 is computed as the propulsion efficiency 4=(energy used to go forward in the advancing direction/energy used for one step)×100(%). This energy is a sum of potential energy and kinetic energy.

### Amount of Energy Consumption

The amount of energy consumption is an exercise index defined as an amount of energy which is consumed for one-step advancing, and also indicates a result obtained by integrating an amount of energy consumed for one-step advancing for a running period. The amount of energy consumption is computed as the amount of energy consumption=(an amount of energy consumption in the vertical direction)+(an amount of energy consumption in the advancing direction)+(an amount of energy consumption in the horizontal direction). Here, the amount of energy consumption in the vertical direction is computed as the amount of energy consumption in the vertical direction=(weight×gravity×vertical distance). The amount of energy consumption in the advancing direction is computed as the amount of energy consumption in the advancing direction=[weight×{(advancing direction highest velocity after kicking)²−(advancing direction lowest velocity after landing)²}/2]. The amount of energy consumption in the horizontal direction is computed as the amount of energy consumption in the horizontal direction=[weight×{(horizontal direction highest velocity after kicking)−(horizontal direction lowest velocity after landing)²}/2].

### Landing Impact

The landing impact is an exercise index indicating to what extent an impact is applied to the body due to landing. The landing impact is computed as the landing impact=(an impact force in the vertical direction)+(an impact force in the advancing direction)+(an impact force in the horizontal direction). Here, the impact force in the vertical direction is computed as the impact force in the vertical direction=(weight×vertical velocity in landing/impact time). The impact force in the advancing direction is computed as the impact force in the advancing direction={weight×(advancing direction velocity before landing−advancing direction lowest velocity after landing)/impact time}. The impact force in the horizontal direction is computed as the impact force in the horizontal direction={weight×(horizontal velocity before landing−horizontal lowest velocity after landing)/impact time}.

### Running Performance

The running performance is an exercise index indicating a user's running force. For example, it is known that there is a correlation between a ratio of a stride and ground contact time, and a running record (time) (“As for Ground Contact Time and Taking-Off Time in Race on 100 m Track”, Journal of Research and Development for Future Athletics. 3(1):1-4, 2004.). The running performance is computed as the running performance=(stride/ground contact time).

### Forward Tilt Angle

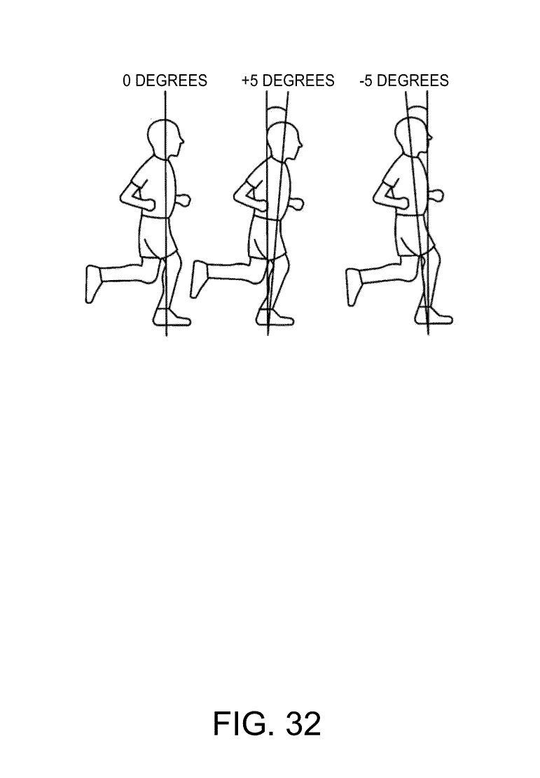

The forward tilt angle is an exercise index indicating to what extent the user's body is tilted with respect to the ground. As illustrated in FIG. 32, if the forward tilt angle is set to 0 degrees when the user stands vertically to the ground (the left part), the forward tilt angle has a positive value when the user bends forward (the central part), and the forward tilt angle has a negative value when the user bends backward (the right part). The forward tilt angle is obtained by converting a pitch angle of the m frame so as to cause the same specification. Since the exercise analysis apparatus 2 (the inertial measurement unit 10) is mounted on the user, and may be already tilted at this time, the forward tilt angle is assumed to be 0 degrees in the left part of FIG. 32 during stoppage, and may be computed by using an amount of change therefrom.

### Timing Coincidence

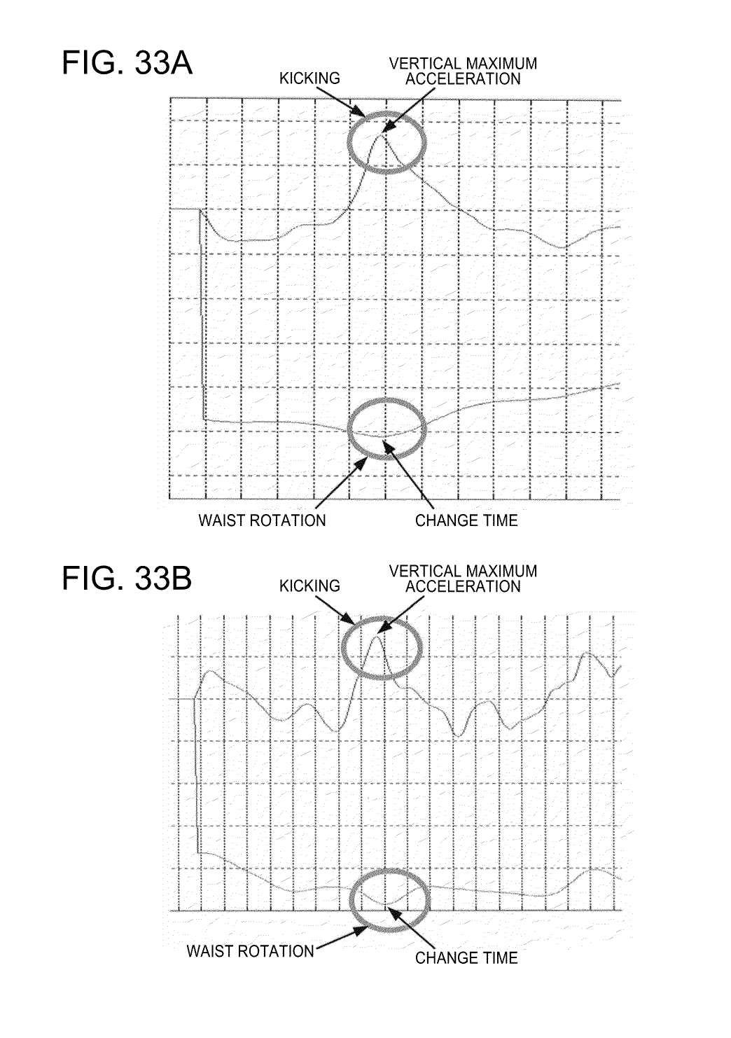

The timing coincidence is an exercise index indicating how close to a good timing a timing of a user's feature point is. For example, an exercise index indicating how close to a kicking timing a timing of waist rotation is. In the way of the slow turnover of the legs, since, when one leg reaches the ground, the other leg remains behind the body still, a case where a waist rotation timing comes after kicking may be determined as being the slow turnover the legs. In FIG. 33A, a waist rotation timing substantially matches a kicking timing, and thus this can be said to be good running. On the other hand, in FIG. 33B, a waist rotation timing is later than a kicking timing, and thus this can be said to be in the way of the slow turnover of the legs.

### 1-8-4. Second Analysis Information

Hereinafter, a description will be made of details of each item of the second analysis information calculated by the second analysis information generation section 274.

### Energy Loss

The energy loss is an exercise index indicating an amount of energy which is wastefully used with respect to an amount of energy consumed for one-step advancing, and also indicates a result obtained by integrating an amount of energy which is wastefully used with respect to an amount of energy consumed for one-step advancing for a running period. The energy loss is computed as the energy loss={amount of energy consumption×(100−directly-below landing ratio)×(100−propulsion efficiency}. Here, the directly-below landing ratio is any one of the directly-below landing ratios 1 to 3, and the propulsion efficiency is any one of the propulsion efficiency 1 to the propulsion efficiency 4.

### Energy Efficiency

The energy efficiency is an exercise index indicating whether or not the energy consumed for one-step advancing is efficiently used as energy for going forward in the advancing direction, and also indicates a result obtained by integrating the energy for a running period. The energy efficiency is computed as the energy efficiency={(amount of energy consumption−energy loss)/(amount of energy consumption)}.

### Burden on Body

The burden on the body is an exercise index indicating to what extent impacts are accumulated in the body by accumulating a landing impact. An injury occurs due to accumulation of impacts, and thus likelihood of an injury can be determined by evaluating the burden on the body. The burden on the body is computed as the burden on the body=(burden on right leg+burden on left leg). The burden on the right leg may be computed by integrating landing impacts on the right leg. The burden on the left leg may be computed by integrating landing impacts on the left leg. Here, as the integration, both integration during running and integration from the past are performed.

### 1-8-5. Left-Right Difference Ratio (Left-Right Balance)

The left-right difference ratio is an exercise index indicating to what extent there is a difference between the left and right sides of the body for the running pitch, the stride, the ground contact time, the impact time, each item of the first analysis information, and each item of the second analysis information, and is assumed to indicate to what extent the left leg is deviated relative to the right leg. The left-right difference ratio is computed as the left-right difference ratio=(numerical value for left leg/numerical value for right leg×100(%)). The numerical value is a numerical value of each of the running pitch, the stride, the ground contact time, the impact time, the brake amount, the propulsion force, the directly-below landing ratio, the propulsion efficiency, the velocity, the acceleration, the movement distance, the forward tilt angle, the waist rotation angle, the waist rotation angular velocity, the amount of being tilted toward the left and right sides, the impact time, the running performance, the amount of energy consumption, the energy loss, the energy efficiency, the landing impact, and the burden on the body. The left-right difference ratio also includes an average value or a variance of the respective numerical values.

### 1-9. Feedback During Running

### 1-9-1. Feedback Information

The output-information-during-running generation portion 280 outputs the basic information such as the running pitch, the stride, the running velocity, the elevation, the running distance, and the running time, as the output information during running. The output-information-during-running generation portion 280 outputs, as the output information during running, each value of the present information such as the ground contact time, the brake amount in landing, the directly-below landing ratio, the propulsion efficiency, the ground contact time, the forward tilt angle, the timing coincidence, the running performance, the energy efficiency, and the left-right difference ratio, or an average value (movement average value) corresponding to several steps (for example, ten steps). The output-information-during-running generation portion 280 outputs, as the output information during running, information in which the numerical values are graphed in a time series, and time-series information of the amount of energy consumption and the burden on the body (accumulated damage). The output-information-during-running generation portion 280 outputs, as the output information during running, information for evaluating a running state of the user, advice information for improving a running state of the user, advice information for improving running attainments of the user, running path information, and the like. The output information during running is presented (feedback) to the user during the user's running.

### 1-9-2. Feedback Timing

The output-information-during-running generation portion 280 may output the output information during running at all time during running. Alternatively, in a case where a numerical value of a predetermined item exceeds a threshold value (reference value), the output-information-during-running generation portion 280 may output information regarding the exceeding state, the item whose numerical value exceeds the threshold value, or the worst item. Alternatively, in a case where a numerical value of a predetermined item does not exceed a threshold value (reference value), the output-information-during-running generation portion 280 may output information regarding a state in which the numerical value does not exceed the threshold value, the item whose numerical value does not exceed the threshold value, or the best item. Alternatively, the output-information-during-running generation portion 280 may output information selected by the user at all times during running. Alternatively, in a case where information selected by the user exceeds a threshold value (reference value), the output-information-during-running generation portion 280 may output the exceeding state and a numerical value thereof. Alternatively, in a case where information selected by the user does not exceed a threshold value, the output-information-during-running generation portion 280 may output a state in which the information does not exceed the threshold value, and a numerical value thereof.

### 1-9-3. Feedback Method

The output information during running output from the output-information-during-running generation portion 280 may be displayed on a screen of the display unit 170 of the display apparatus 3 so as to be fed back to the user. Alternatively, the output information during running may be fed back in voice from the sound output unit 180 of the display apparatus 3. Alternatively, the content regarding a timing such as a waist rotation timing, a pitch, or a kicking timing may be fed back in short sound such as “beep beep” from the sound output unit 180 of the display apparatus 3. Alternatively, the user may be instructed to view the content displayed on the display unit 170 by using sound or vibration from the sound output unit 180 or the vibration unit 190 of the display apparatus 3.

### 1-9-4. Specific Examples of Feedback

### Running Pitch

It may be determined whether or not the running pitch is within a reference range (equal to or higher than a lower limit threshold value, or equal to or lower than an upper limit threshold value) which is set in advance, and, in a case where the running pitch is lower than the lower limit threshold value, display or voice such as the content that “the pitch is decreasing” may be performed on the display unit 170 or may be output from the sound output unit 180, and, in a case where the running pitch is higher than the upper limit threshold value, display or voice such as the content that the content that “the pitch is increasing” may be performed on the display unit 170 or may be output from the sound output unit 180. Alternatively, in a case where the running pitch is lower than the lower limit threshold value, sound or vibration of a slow tempo may be output from the sound output unit 180 or the vibration unit 190, and in a case where the running pitch is higher than the upper limit threshold value, sound or vibration of a fast tempo may be output, so that a tempo of sound or vibration switches in each case.

If the running pitch is not included in the reference range, display or voice of an advice for causing the running pitch to enter the reference range, such as the content that “the pitch is decreasing; intentionally increase the pitch by slightly narrowing a stride”, or “the pitch is increasing; intentionally decrease the pitch by slightly widening a stride”, may be performed on the display unit 170 or may be output from the sound output unit 180.

In a case of outputting information regarding the running pitch, for example, a numerical value of the present running pitch or an average value corresponding to several steps may be displayed on the display unit 170, and sound of a tempo or a length corresponding to the running pitch, or music corresponding to the running pitch may be output from the sound output unit 180. For example, an inverse number of the running pitch (time per step) may be calculated, and short sound for each step may be output.

### Stride

It may be determined whether or not the stride is within a reference range (equal to or higher than a lower limit threshold value, or equal to or lower than an upper limit threshold value) which is set in advance, and, in a case where the stride is lower than the lower limit threshold value, display or voice such as the content that “stride is shortening” may be performed on the display unit 170 or may be output from the sound output unit 180, and, in a case where the stride is higher than the upper limit threshold value, display or voice such as the content that the content that “stride is lengthening” may be performed on the display unit 170 or may be output from the sound output unit 180. Alternatively, in a case where the stride is lower than the lower limit threshold value, sound or vibration of a slow tempo may be output from the sound output unit 180 or the vibration unit 190, and in a case where the running pitch is higher than the upper limit threshold value, sound or vibration of a fast tempo may be output, so that a tempo of sound or vibration switches in each case.

Alternatively, if the stride is not included in the reference range, display or voice of an advice for causing the stride to enter the reference range, such as the content that “the stride is decreasing; intentionally increase the stride by slightly narrowing the stride”, or “the stride is increasing; intentionally decrease the stride by slightly widening the stride”, may be performed on the display unit 170 or may be output from the sound output unit 180.

In a case of outputting information regarding the stride, for example, a numerical value of the present stride or an average value corresponding to several steps may be displayed on the display unit 170, and sound of a tempo or a length corresponding to the stride, or music corresponding to the stride may be output from the sound output unit 180.

### Ground Contact Time

In a case where an average value of the ground contact time improves during running, display or voice of an advice that “the running performance increases; let's exercise continuously in this state” may be performed on the display unit 170 or may be output from the sound output unit 180.

In a case of outputting information regarding the ground contact time, for example, the present ground contact time or an average value corresponding to several steps may be displayed on the display unit 170, and sound of a tempo or a length corresponding to the ground contact time, or music corresponding to the ground contact time may be output from the sound output unit 180. However, since the user recognizes a numerical value of the ground contact time but hardly determines whether this numerical value indicates a right state or a wrong state, for example, it may be determined to which level of, for example, 10 levels a numerical value of the ground contact time belongs by using, for example, a predefined threshold value, and a level the ground contact time of the user may be fed back as 1 to 10.

### Brake Amount 1 in Landing

In a case where the brake amount 1 in landing is compared with a threshold value which is set in advance, and is higher than the threshold value, it may be determined that the brake amount is too large, and display or voice such as the content that “the brake amount is increasing; there is a possibility of waist-falling running way”, may be performed on the display unit 170 or may be output from the sound output unit 180. Alternatively, in a case where the brake amount 1 in landing is higher than the threshold value, sound or vibration other than voice may be output.

Alternatively, in a case where the brake amount 1 in landing is higher than the threshold value, display or voice of an advice such as the content that “the brake amount is increasing; if the brake amount is large, efficiency is reduced, and thus danger of being injured also increases” or “there is a possibility of waist-falling running way; pay attention to the pelvis, and set the foot directly below the body so that the waist falls in landing” may be performed on the display unit 170 or may be output from the sound output unit 180.

In a case of outputting information regarding the brake amount 1 in landing, for example, a numerical value of the present brake amount 1 in landing or an average value corresponding to several steps may be displayed on the display unit 170, and sound with a volume corresponding to the brake amount 1 in landing may be output from the sound output unit 180.

### Brake Amount 2 in Landing

In the same manner as in the brake amount 1 in landing, in a case where the brake amount 2 in landing is higher than a threshold value, it is fed back that the brake amount is too large. Alternatively, in a case where the brake amount 2 in landing is higher than the threshold value, the same advice as in the brake amount 1 in landing may be fed back. In a case of outputting the information regarding the brake amount 2 in landing, in the same manner as in the brake amount 1 in landing, a numerical value of the brake amount 2 in landing or an average value corresponding to several steps may be displayed, and sound with a volume corresponding to the brake amount 2 in landing may be output.

### Directly-Below Landing Ratio 1

Alternatively, in a case where the directly-below landing ratio 1 is compared with a threshold value which is set in advance, and is lower than the threshold value, it may be determined that directly-below landing is not performed, and display or voice such as the content that “the directly-below landing ratio is decreasing” or “directly-below landing is not performed” may be performed on the display unit 170 or may be output from the sound output unit 180. Alternatively, in a case where the directly-below landing ratio 1 is lower than the threshold value, sound or vibration other than voice may be output.

Alternatively, in a case where the directly-below landing ratio 1 is lower than the threshold value, display or voice of an advice such as the content that “the directly-below landing ratio is decreasing; if the directly-below landing is not performed, this causes an increase in the brake amount and an increase in vertical movement, and thus efficiency of running is reduced; intentionally put the waist firmly by stretching the backbone”, may be performed on the display unit 170 or may be output from the sound output unit 180.

In a case of outputting information regarding the directly-below landing ratio 1, for example, a numerical value of the present directly-below landing ratio 1 or an average value corresponding to several steps may be displayed on the display unit 170, and sound with a volume corresponding to the directly-below landing ratio 1 may be output from the sound output unit 180.

### Directly-Below Landing Ratio 2

In the same manner as in the directly-below landing ratio 1, in a case where the directly-below landing ratio 2 is lower than a threshold value, it is fed back that the directly-below landing is not performed. Alternatively, in a case where the directly-below landing ratio 2 is lower than the threshold value, the same advice as in the directly-below landing ratio 1 may be fed back. In a case of outputting information regarding the directly-below landing ratio 2, in the same manner as in the directly-below landing ratio 1, a numerical value of the directly-below landing ratio 2 or an average value corresponding to several steps may be displayed, and sound with a volume corresponding to the directly-below landing ratio 2 may be output.

### Directly-Below Landing Ratio 3

In the same manner as in the directly-below landing ratio 1, in a case where the directly-below landing ratio 3 is lower than a threshold value, it is fed back that the directly-below landing is not performed. Alternatively, in a case where the directly-below landing ratio 3 is lower than the threshold value, the same advice as in the directly-below landing ratio 1 may be fed back. In a case of outputting information regarding the directly-below landing ratio 3, in the same manner as in the directly-below landing ratio 1, a numerical value of the directly-below landing ratio 3 or an average value corresponding to several steps may be displayed, and sound with a volume corresponding to the directly-below landing ratio 3 may be output.

### Propulsion Force 1

In a case where the propulsion force 1 is compared with a threshold value which is set in advance, and is lower than the threshold value, it may be determined that propulsion force decreases, and display or voice such as the content that “the propulsion force is decreasing” or “there is a possibility that a kicking force may act upward” may be performed on the display unit 170 or may be output from the sound output unit 180. Alternatively, in a case where the propulsion force 1 is lower than the threshold value, sound or vibration other than voice may be output.

Alternatively, in a case where the propulsion force 1 is lower than the threshold value, display or voice of an advice such as the content that “there is a possibility that a kicking force may act upward; run in such a state of capturing the ground with the entire sole instead of kicking”, may be performed on the display unit 170 or may be output from the sound output unit 180.

In a case of outputting information regarding the propulsion force 1, for example, a numerical value of the present propulsion force 1 or an average value corresponding to several steps may be displayed on the display unit 170, and sound with a volume corresponding to the propulsion force 1 may be output from the sound output unit 180.

### Propulsion Force 2

In the same manner as in the propulsion force 1, or in a case where the propulsion force 2 is lower than a threshold value, it is fed back that the propulsion force decreases. Alternatively, in a case where the propulsion force 2 is lower than the threshold value, the same advice as in the propulsion force 1 may be fed back. In a case of outputting information regarding the propulsion force 2, a numerical value of the propulsion force 2 or an average value corresponding to several steps may be displayed, and sound with a volume corresponding to the propulsion force 2 may be output.

### Propulsion Efficiency 1

In a case where the propulsion efficiency 1 is compared with a threshold value which is set in advance, and is lower than the threshold value, it may be determined that the vertical movement or the horizontal movement is too large, and display or voice such as the content that “the propulsion efficiency is decreasing” or “the vertical movement or the horizontal movement is large”, may be performed on the display unit 170 or may be output from the sound output unit 180. Alternatively, in a case where the propulsion efficiency 1 is lower than the threshold value, sound or vibration other than voice may be output.

Alternatively, in a case where the propulsion efficiency 1 is lower than the threshold value, display or voice such as the content that “the vertical movement or the horizontal movement is large; if you kicks excessively, you takes such a form as springing up, and a burden on the calves increases; therefore, run in such a state of capturing the ground with the entire sole”, may be performed on the display unit 170 or may be output from the sound output unit 180.

In a case of outputting information regarding the propulsion efficiency 1, for example, the present propulsion efficiency 1 or an average value corresponding to several steps may be displayed on the display unit 170, and sound with a volume corresponding to the propulsion efficiency 1 may be output from the sound output unit 180. However, since the user recognizes a numerical value of the propulsion efficiency 1 but hardly determines whether this numerical value indicates a right state or a wrong state, for example, a direction corresponding to the present propulsion efficiency 1 of the user and a direction corresponding to ideal propulsion efficiency 1 (about 45 degrees) may be displayed so as to overlap each other (or may be displayed in parallel to each other).

### Propulsion Efficiency 2

In the same manner as in the propulsion efficiency 1, in a case where the propulsion efficiency 2 is lower than a threshold value, it is fed back that the vertical movement or the horizontal movement is too large. Alternatively, in a case where the propulsion efficiency 2 is lower than the threshold value, the same advice as in the propulsion efficiency 1 may be fed back. In a case of outputting information regarding the propulsion efficiency 2, a numerical value of the propulsion efficiency 2 or an average value corresponding to several steps may be displayed, and sound with a volume corresponding to the propulsion efficiency 2 may be output.

### Propulsion Efficiency 3

In the same manner as in the propulsion efficiency 1, in a case where the propulsion efficiency 3 is lower than a threshold value, it is fed back that the vertical movement or the horizontal movement is too large. Alternatively, in a case where the propulsion efficiency 3 is lower than the threshold value, the same advice as in the propulsion efficiency 1 may be fed back. In a case of outputting information regarding the propulsion efficiency 3, a numerical value of the propulsion efficiency 3 or an average value corresponding to several steps may be displayed, and sound with a volume corresponding to the propulsion efficiency 3 may be output.

### Propulsion Efficiency 4

In the same manner as in the propulsion efficiency 1, in a case where the propulsion efficiency 4 is lower than a threshold value, it is fed back that the vertical movement or the horizontal movement is too large. Alternatively, in a case where the propulsion efficiency 4 is lower than the threshold value, the same advice as in the propulsion efficiency 1 may be fed back. In a case of outputting information regarding the propulsion efficiency 4, a numerical value of the propulsion efficiency 4 or an average value corresponding to several steps may be displayed, and sound with a volume corresponding to the propulsion efficiency 4 may be output.

### Amount of Energy Consumption

In a case where the amount of energy consumption is compared with a threshold value which is set in advance, and is higher than the threshold value, it may be determined that the amount of useless energy consumption is too large, and display or voice such as the content that “the amount of energy consumed for one step is increasing”, may be performed on the display unit 170 or may be output from the sound output unit 180. Alternatively, in a case where the amount of energy consumption is higher than the threshold value, sound or vibration other than voice may be output.

Alternatively, in a case where the amount of energy consumption is higher than the threshold value, for example, display or voice of an advice such as the content that “the amount of energy consumed for one step is increasing; minimize useless energy consumption through efficient running”, may be performed on the display unit 170 or may be output from the sound output unit 180.

In a case of outputting information regarding the amount of energy consumption, for example, the amount of energy consumption hitherto may be displayed on the display unit 170, and sound with a volume corresponding to the amount of energy consumption may be output from the sound output unit 180.

### Landing Impact

In a case where the landing impact is compared with a threshold value which is set in advance, and is higher than the threshold value, it may be determined that the level of useless landing impact is too high, and display or voice such as the content that “the level of landing impact is high”, may be performed on the display unit 170 or may be output from the sound output unit 180. Alternatively, in a case where the level of landing impact is higher than the threshold value, sound or vibration other than voice may be output.

Alternatively, in a case where the landing impact is higher than the threshold value, for example, display or voice of an advice such as the content that “the landing impact is serious; if impacts are accumulated, this may lead to an injury; carefully run so as to minimize the vertical movement and to cause the foot to land directly below the body”, may be performed on the display unit 170 or may be output from the sound output unit 180.

In a case of outputting information regarding the landing impact, for example, a numerical value of the present landing impact or an average value corresponding to several steps may be displayed on the display unit 170, and sound with a volume corresponding to the landing impact may be output from the sound output unit 180.

### Running Performance

In a case where an average value of the running performance improves during running, display or voice of an advice that “the running performance increases; let's exercise continuously in this state” may be performed on the display unit 170 or may be output from the sound output unit 180.

In a case of outputting information regarding the running performance, for example, a numerical value of the present running performance or an average value corresponding to several steps may be displayed on the display unit 170, and sound with a volume corresponding to the propulsion force 1 may be output from the sound output unit 180. However, since the user recognizes a numerical value of the running performance but hardly determines whether this numerical value indicates a right state or a wrong state, for example, it may be determined to which level of, for example, 10 levels a numerical value of the running performance belongs by using, for example, a predefined threshold value, and a level the running performance of the user may be fed back as 1 to 10.

### Forward Tilt Angle

It may be determined whether or not the forward tilt angle is within a reference range (equal to or higher than a lower limit threshold value, or equal to or lower than an upper limit threshold value) which is set in advance, and, in a case where the forward tilt angle is lower than the lower limit threshold value, display or voice such as the content that “you are running in a state of being tilted backward” may be performed on the display unit 170 or may be output from the sound output unit 180, and, in a case where the forward tilt angle is higher than the upper limit threshold value, display or voice such as the content that the content that “you are running in a state of being tilted forward much” may be performed on the display unit 170 or may be output from the sound output unit 180. Alternatively, in a case where the forward tilt angle is lower than the lower limit threshold value, sound with a small volume or weak vibration may be output from the sound output unit 180 or the vibration unit 190, and in a case where the forward tilt angle is higher than the upper limit threshold value, sound with a large volume or strong vibration may be output, so that a volume or vibration strength switches in each case.

Alternatively, if the forward tilt angle is not included in the reference range, display or voice of an advice for causing the forward tilt angle to enter the reference range, such as the content that “you are running in a state of being tilted backward; there is a possibility of stooping slightly; intentionally put the body directly on the top of the pelvis and move the centroid to the stepping foot”, may be performed on the display unit 170 or may be output from the sound output unit 180.

In a case of outputting information regarding the forward tilt angle, for example, a numerical value of the present forward tilt angle or an average value corresponding to several steps may be displayed on the display unit 170, and sound with a volume corresponding to the forward tilt angle may be output from the sound output unit 180. However, since the user recognizes a numerical value of the forward tilt angle but hardly determines whether this numerical value indicates a right state or a wrong state, for example, an image showing the present attitude of the user and an image showing an ideal attitude (an attitude tilted forward by about 5 degrees to 10 degrees) may be displayed so as to overlap each other (or may be displayed in parallel to each other).

### Timing Coincidence

It may be determined whether or not the timing coincidence is within a reference range (equal to or higher than a lower limit threshold value, or equal to or lower than an upper limit threshold value) which is set in advance, and, in a case where the timing coincidence is not included in the reference range, display or voice indicating that the timing coincidence is not included in the reference range may be performed on the display unit 170 or may be output from the sound output unit 180. Alternatively, in a case where the timing coincidence is not included in the reference range, a volume or vibration strength may be output in a switching manner from the sound output unit 180 or the vibration unit 190.

Alternatively, if the timing coincidence is not included in the reference range, display or voice of an advice for causing the timing coincidence to enter the reference range may be performed on the display unit 170 or may be output from the sound output unit 180.

As an example, regarding the timing coincidence between a waist rotation timing and a kicking timing, for example, a numerical value (a positive or negative numerical value) of a difference between the present waist rotation timing and the kicking timing or an average value corresponding to several steps may be displayed, or sound with a volume corresponding to the numerical value of the difference may be output. Alternatively, in a case where the difference between the waist rotation timing and the kicking timing is higher than an upper limit threshold value, it may be determined that the user is in the way of the slow turnover of the legs, and display or voice such as the content that “you are in the way of the slow turnover of the legs” may be performed or may be output. Alternatively, in a case where the difference between the waist rotation timing and the kicking timing is higher than the upper limit threshold value, for example, display or voice of an advice such as the content that “you are in the way of the slow turnover of the legs; power under the knee is used for running, and thus the calves may become tired soon; intentionally increase a speed of pulling the kicking leg”, may be performed or may be output.

In a case of outputting the timing coincidence, for example, a numerical value of the present timing coincidence or an average value corresponding to several steps may be displayed on the display unit 170, and sound with a volume corresponding to the timing coincidence may be output from the sound output unit 180.

### Energy Loss

In a case where the amount of energy loss is compared with a threshold value which is set in advance, and is higher than the threshold value, it may be determined that the amount of useless energy loss is too large, and display or voice such as the content that “the amount of energy consumed for one step is increasing”, may be performed on the display unit 170 or may be output from the sound output unit 180. Alternatively, in a case where the amount of energy loss is higher than the threshold value, sound or vibration other than voice may be output.

Alternatively, in a case where the amount of energy loss is higher than the threshold value, for example, display or voice of an advice such as the content that “the amount of energy consumed for one step is increasing; minimize useless energy consumption through efficient running”, may be performed on the display unit 170 or may be output from the sound output unit 180.

In a case of outputting information regarding the energy loss, for example, a numerical value of the present energy loss or an average value corresponding to several steps may be displayed on the display unit 170, and sound with a volume corresponding to the energy loss may be output from the sound output unit 180.

### Energy Efficiency

In the same manner as in the energy loss, a numerical value of the energy efficiency is fed back, or in a case where the energy efficiency is higher than a threshold value, it is fed back that the amount of useless energy consumption is too large. Alternatively, in a case where the energy loss is higher than the threshold value, the same advice as in the energy loss may be fed back. In a case of outputting information regarding the energy efficiency, a numerical value of the energy efficiency or an average value corresponding to several steps may be displayed, and sound with a volume corresponding to the energy efficiency may be output.

### Burden on Body

In a case where the burden on the body is compared with a threshold value which is set in advance, and is higher than the threshold value, it may be determined that the level of burden on the body is too high, and display or voice such as the content that “the burden on the body is increasing”, may be performed on the display unit 170 or may be output from the sound output unit 180. Alternatively, in a case where the level of burden on the body is higher than the threshold value, sound or vibration other than voice may be output.

Alternatively, in a case where the level of burden on the body is higher than the threshold value, for example, display or voice of an advice such as the content that “the burden on the body is increasing; take a break; excessive burdens may cause an injury; carefully run so as to minimize the vertical movement and to cause the foot to land directly below the body”, may be performed on the display unit 170 or may be output from the sound output unit 180.

In a case of outputting information regarding the burden on the body, for example, a numerical value of the burden on the body hitherto may be displayed on the display unit 170, and sound with a volume corresponding to the burden on the body may be output from the sound output unit 180.

### Left-Right Difference Ratio

It may be determined whether or not the left-right difference ratio is within a reference range (equal to or higher than a lower limit threshold value (for example, 70%), or equal to or lower than an upper limit threshold value (for example, 130%)) which is set in advance, and, in a case where the timing coincidence is not included in the reference range, display or voice such as the content that “the left and right balance is not good” may be performed on the display unit 170 or may be output from the sound output unit 180.

Alternatively, in a case where the left-right difference ratio is not included in the reference range, display or voice of an advice such as the content that “the bad left and right balance causes an injury; in order to reduce the difference between the left and right sides, you obtain uniform flexibility through stretching or train the muscles or the gluteus medius of the trunk” may be performed on the display unit 170 or may be output from the sound output unit 180.

In a case of outputting information regarding the left-right difference ratio, for example, a numerical value of the present left-right difference ratio or an average value corresponding to several steps for the above-described items may be displayed on the display unit 170, and sound with a volume corresponding to the left-right difference ratio may be output from the sound output unit 180.

### 1-9-5. Display Examples

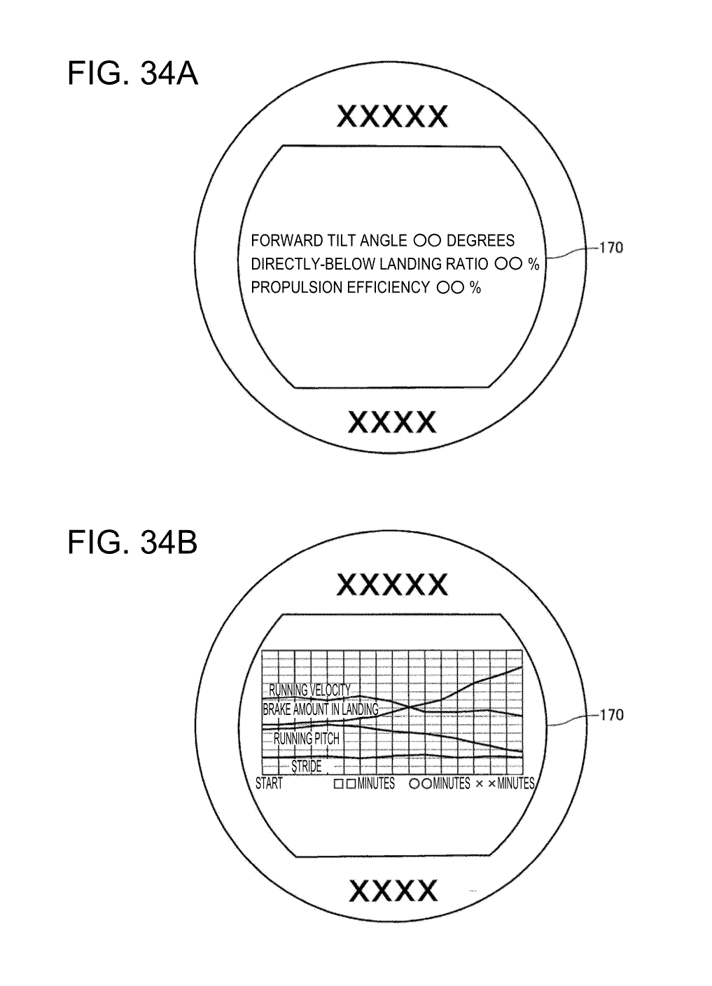

FIGS. 34A and 34B illustrate examples of screens displayed on the display unit 170 of the wrist watch type display apparatus 3 during the user's running. In the example illustrated in FIG. 34A, respective numerical values of the “forward tilt angle”, the “directly-below landing ratio”, and the “propulsion efficiency” are displayed on the display unit 170. In the example illustrated in FIG. 34B, a time-series graph is displayed in which a transverse axis expresses time from starting of running, and a longitudinal axis expresses numerical values of respective items such as the “running velocity”, the “running pitch”, the “brake amount in landing”, and the “stride”. The numerical values of the respective items of FIG. 34A or the graphs of the respective items of FIG. 34B are updated in real time during the user's running. In response to a user's operation, numerical values of other items may be displayed, and the graphs may be scrolled. The items displayed on the screen of FIG. 34A or the screen of FIG. 34B may be items (for example, items within a reference range or items out of the reference range) satisfying a predetermined condition, items of which a notification is performed, or items which are designated by the user in advance. The screen on which the numerical values of the items are displayed as in FIG. 34A and the screen on which the numerical values of the items are displayed as in FIG. 34B may switch through an user's input operation.

The user can run while viewing the screen as in the screen of FIG. 34A or 34B so as to check the present running state. For example, the user can continue to run while being aware of the running way which causes a numerical value of each item to be favorable or the running way which causes an item with a numerical value to be improved, or while objectively recognizing a fatigue state.

### 1-10. Feedback after Running

### 1-10-1. Feedback Information

The running analysis portion 290 outputs, as the output information after running, some or all of the various exercise information pieces generated by the exercise information generation portion 270 during the user's running. In other words, among the plurality of exercise information pieces, exercise information which is not output during the user's running or exercise information which is output during the user's running is fed back after the user finishes running. The running analysis portion 290 outputs information generated after the user finishes running, by using the plurality of exercise information pieces. For example, information regarding an advice for improving running attainments of the user or an advice for improving a running state of the user is fed back after the user's running. Specifically, in the present embodiment, any one of whole analysis information, detail analysis information, and comparison analysis information is selected as the output information after running through a user's selection operation.

### 1-10-2. Feedback Timing

The running analysis portion 290 outputs the output information after running after the user's running in response to a user's input operation. Specifically, if running which is desired to be analyzed is selected by the user from past running history, the running analysis portion 290 transitions to a whole analysis mode so as to perform whole analysis of the running selected by the user, and generates and outputs the whole analysis information as the output information after running. If the user performs an operation of selecting detail analysis, the running analysis portion 290 transitions to a detail analysis mode so as to perform detail analysis corresponding to the subsequent user's operation, and generates and outputs the detail analysis information as the output information after running. If the user performs an operation of selecting comparison analysis, the running analysis portion 290 transitions to a comparison analysis mode so as to perform comparison analysis corresponding to the subsequent user's operation, and generates and outputs the comparison analysis information as the output information after running. If the user performs an operation of selecting whole analysis in the detail analysis mode or the comparison analysis mode, the running analysis portion 290 transitions to the whole analysis mode so as to output the whole analysis information as the output information after running. The running analysis portion 290 may store whole analysis information, detail analysis information, and comparison analysis information generated in the past in the storage unit 30, for example, in a first-in first-out (FIFO) method, and may read the analysis information stored in the storage unit 30 without performing analysis again and may out the analysis information in a case where information regarding an analysis result is stored in the storage unit 30 when whole analysis, detail analysis, or comparison analysis is performed.

### 1-10-3. Feedback Method

The output information after running output from the running analysis portion 290 may be displayed on a screen of the display unit 170 of the display apparatus 3 so as to be fed back to the user. Alternatively, evaluation or an advice regarding the user's running may be fed back in voice from the sound output unit 180 of the display apparatus 3.

### 1-10-4. Display Examples

### Whole Analysis Screen

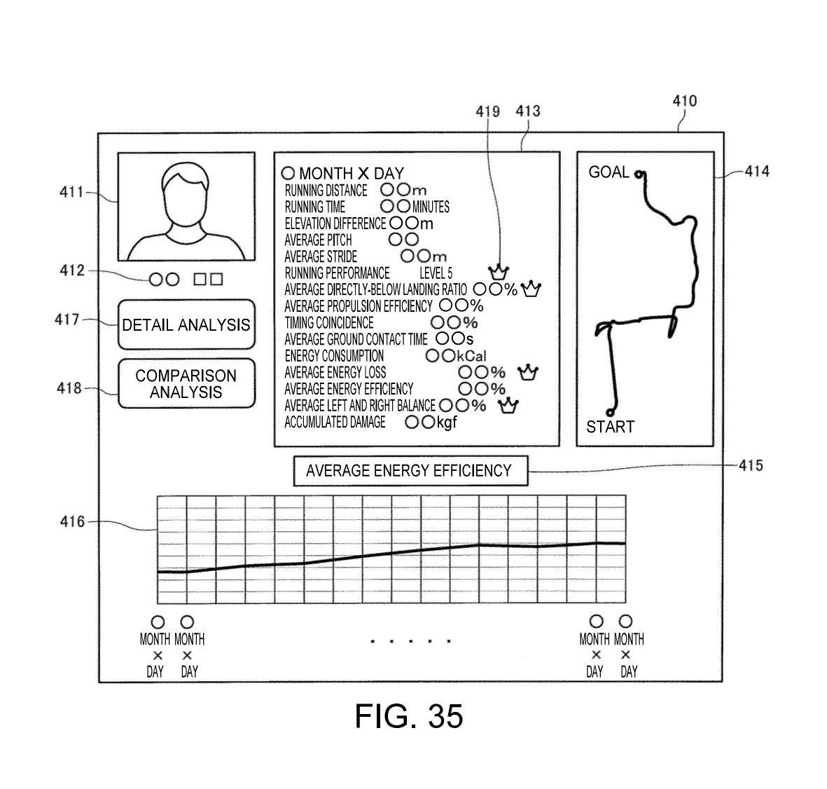

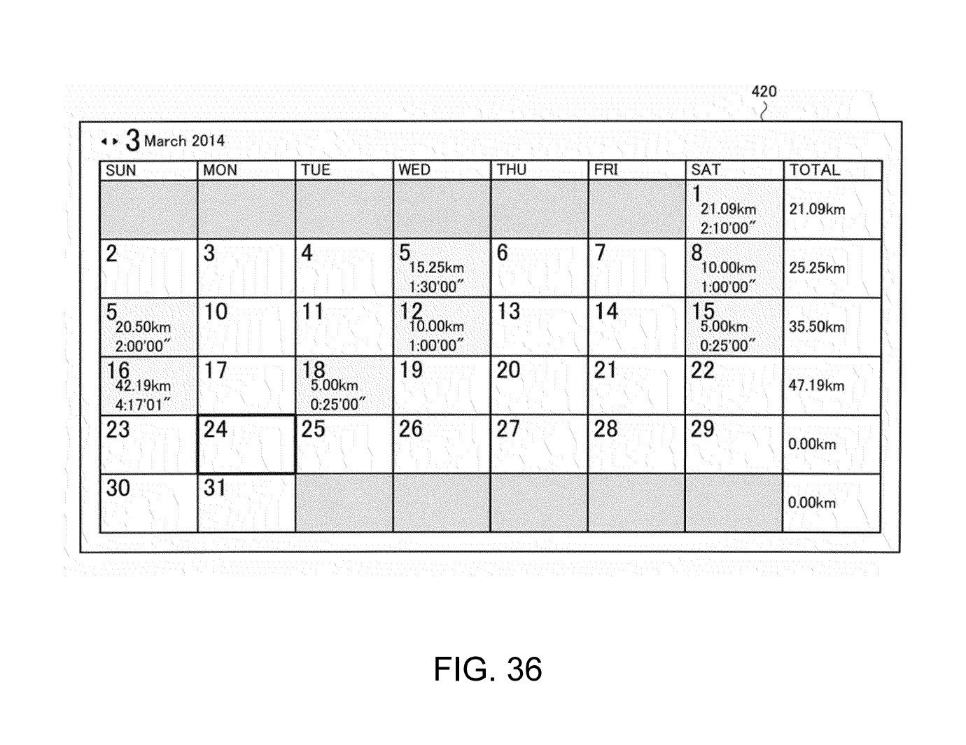

FIGS. 35 and 36 illustrate examples of a screen (whole analysis screen) of the whole analysis information displayed on the display unit 170 of the display apparatus 3. For example, FIG. 35 illustrates a screen of the first page, and FIG. 36 illustrates a screen of the second page. The user may select the screen of FIG. 35 or the screen of FIG. 36 which is then displayed on the display unit 170, by performing a screen scroll operation.

In the example illustrated in FIG. 35, a whole analysis screen 410 (first page) includes a user image 411 and a user name 412 which are registered in advance by the user, a summary image 413 displaying an analysis result of past running selected by the user, a running path image 414 displaying a running path from the start to the goal, an item name 415 of an item selected by the user and time-series data 416 thereof, a detail analysis button 417, and a comparison analysis button 418.

The summary image 413 includes respective numerical values of a “running distance”, a “running time”, an “elevation difference (between the start and the goal)”, an “average pitch (an average value of running pitches)”, an “average stride (an average value of strides)” “running performance”, an “average directly-below landing ratio (an average value of directly-below landing ratios)”, an “average propulsion efficiency (an average value of propulsion efficiency)”, “timing coincidence”, an “average ground contact time (an average value of ground contact times)”, “energy consumption”, an “average energy loss (an average value of energy losses)”, “average energy efficiency (an average value of energy efficiency)”, an “average left and right balance (an average value of left-right difference ratios)”, and an “accumulated damage (burden on the body)”, on the date on which past running was performed and which is selected by the user, and in this running. When analysis is started after running, a whole analysis screen of the latest running data stored in the storage unit 30 may be displayed.

In the summary image 413, a predetermined mark 419 is added beside an item whose numerical value is better than a reference value. In the example illustrated in FIG. 35, the mark 419 is added to the “running performance”, the “average directly-below landing ratio”, the “average energy loss”, and the “average left and right balance”. A predetermined mark may be added to an item whose numerical value is worse than a reference value, or an item whose improvement ratio is higher or lower than a reference value.

The running path image 414 is an image which displays a running path (running corresponding to the summary image 413) from the start point to the goal point in past running selected by the user.

The item name 415 indicates an item selected by the user from the items included in the summary image 413, and the time-series data 416 generates numerical values of the item indicated by the item name 415 as a graph in a time series. In the example illustrated in FIG. 35, the “average energy efficiency” is selected, and a time-series graph is displayed in which a transverse axis expresses the running date, and a longitudinal axis expresses a numerical value of the average energy efficiency. If the user selects one date on the transverse axis of the time-series data 416, an analysis result of the running on the selected date is displayed on the summary image 413.

The detail analysis button 417 is a button for transition from the whole analysis mode to the detail analysis mode, and if the user performs a selection operation (pressing operation) of the detail analysis button 417, transition to the detail analysis mode occurs, and a detail analysis screen is displayed.

The comparison analysis button 418 is a button for transition from the whole analysis mode to the comparison analysis mode, and if the user performs a selection operation (pressing operation) of the comparison analysis button 418, transition to the comparison analysis mode occurs, and a comparison analysis screen is displayed.

In the example illustrated in FIG. 36, history of running which was performed in the past by the user is displayed on a whole analysis screen 420 (second page). In the example illustrated in FIG. 36, a calendar image is displayed as the whole analysis screen 420, today's date (Mar. 24, 2014) is shown by a thick region, and a running distance and a running time are written on the date when the user performed running. A sum value of running distances and a sum value of running time of each week are written on a right column. If the user selects one of the past running items on the whole analysis screen 420, the whole analysis screen 410 illustrated in FIG. 35 changes to a screen which displays a result of whole analysis on the date selected by the user.

By checking the attainments of the running performed in the past while viewing the whole analysis screen illustrated in FIG. 35 or 36, the user can recognize an advantage or a disadvantage of the user's running way, and can practice the running way for improving running attainments or the running way for improving a running state in the next running and thereafter.

### Detail Analysis Screen

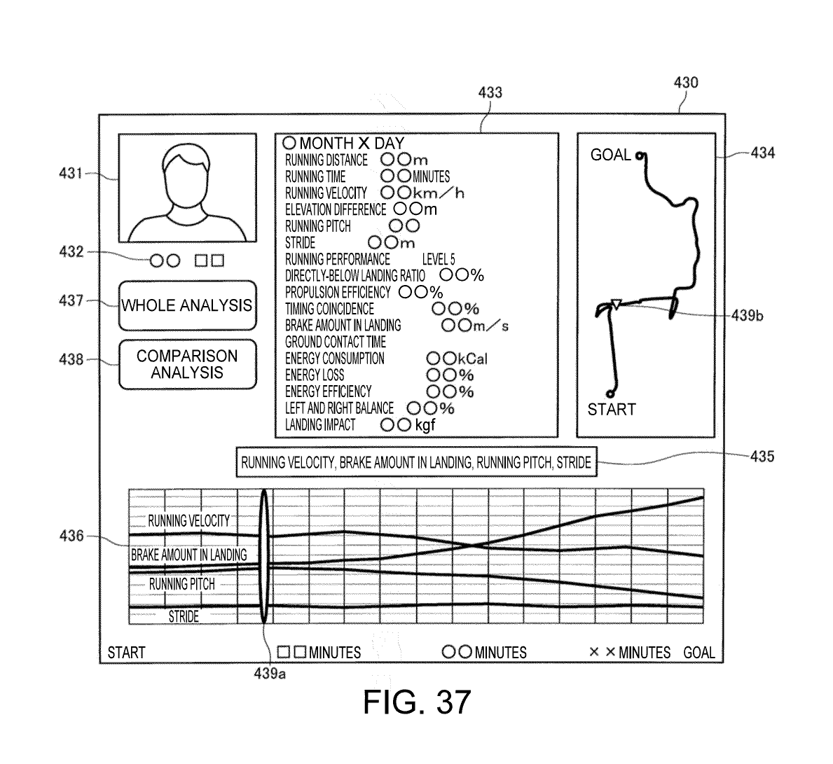

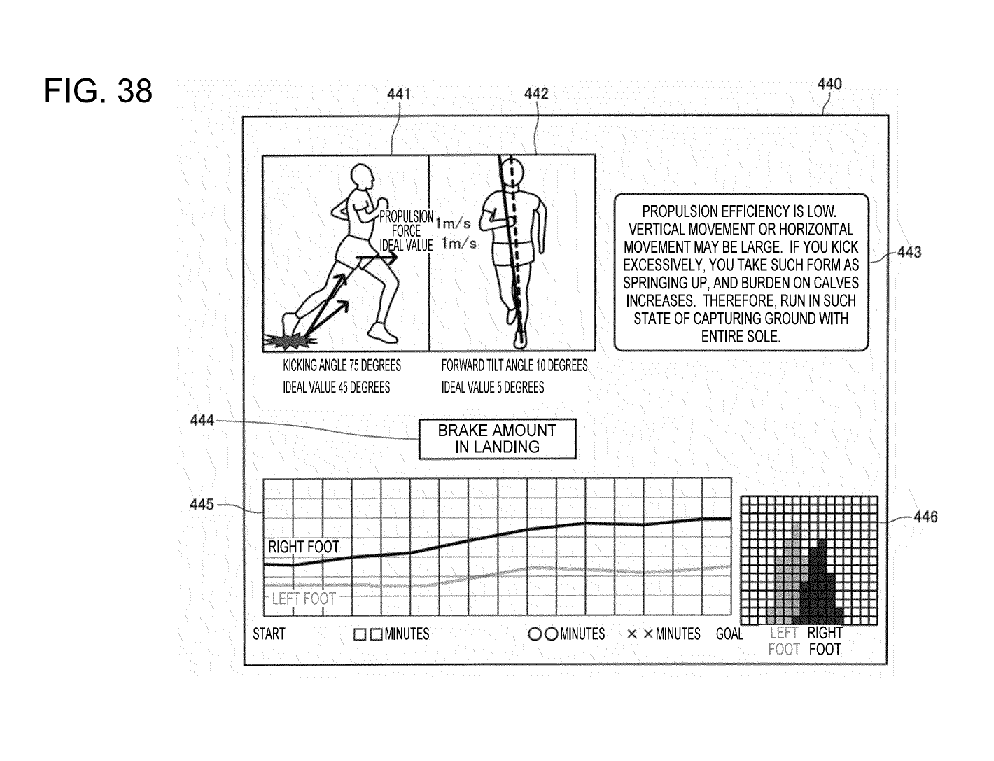

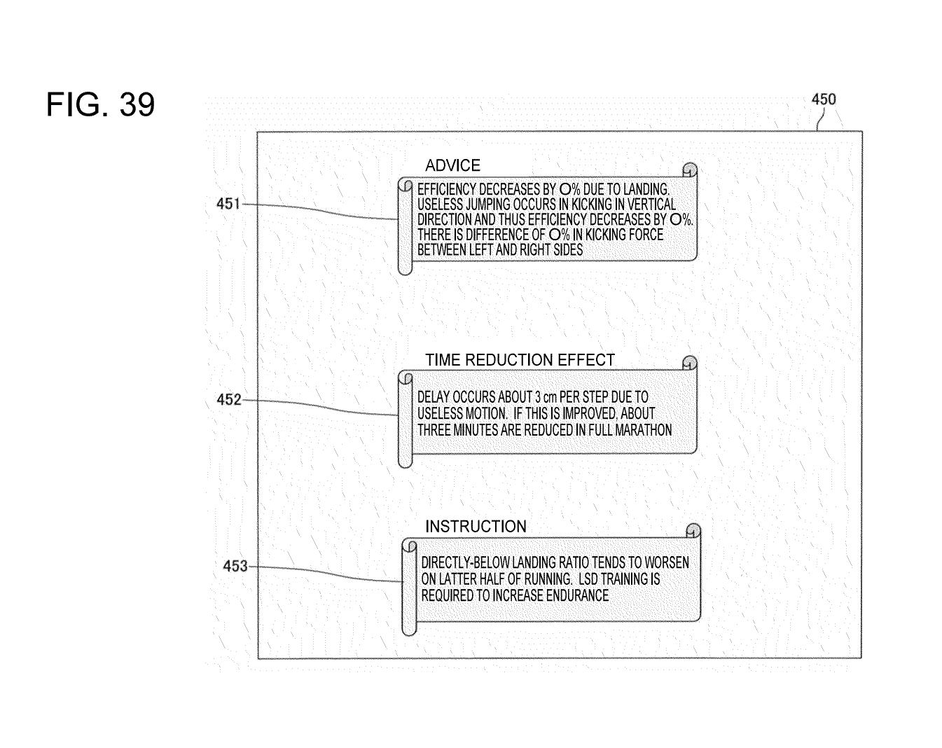

FIGS. 37 to 39 illustrate examples of a screen (detail analysis screen) of detail analysis information displayed on the display unit 170 of the display apparatus 3. The detail analysis screen preferably presents more detailed information than the whole analysis screen. For example, information regarding items more than the whole analysis screen may be presented. Alternatively, the number of items displayed on a single page may be reduced more than on the whole analysis screen, and thus finer duration, a finer numerical value, or the like may be displayed. For example, FIG. 37 illustrates a screen of the first page, FIG. 38 illustrates a screen of the second page, and FIG. 39 illustrates a screen of the third page. The user can select the screen of FIG. 37, the screen of FIG. 38, or the screen of FIG. 39 by performs a screen scroll operation or the like, and can display the selected screen on the display unit 170.

In the example illustrated in FIG. 37, a detail analysis screen 430 (first page) includes a user image 431 and a user name 432 which are registered in advance by the user, a summary image 433 displaying an analysis result at a time point selected by the user in past running selected by the user, a running path image 434 displaying a running path from the start to the goal, an item name 435 of an item selected by the user and time-series data 436 thereof, a whole analysis button 437, and a comparison analysis button 438.

The summary image 433 includes respective numerical values of a “running distance (from the start to a time point selected by the user)”, a “running time (from the start to the time point selected by the user)”, a “running velocity”, an “elevation difference (between the start point and a running position at the selected time point)”, a “running pitch”, a “stride”, “running performance”, a “directly-below landing ratio”, “propulsion efficiency”, “timing coincidence”, a “brake amount in landing”, a “ground contact time”, “energy consumption”, a “energy loss”, “energy efficiency”, an “left and right balance” (left-right difference ratio), and a “landing impact”, at the time point (from the start) selected by the user on the date on which past running was performed and which is selected by the user, and in this running.

The running path image 434 is an image which displays a running path (running corresponding to the summary image 433) from the start point to the goal point in past running selected by the user, and a running position at the time point selected by the user is shown by a predetermined mark 439b.

The item name 435 indicates an item selected by the user from the items included in the summary image 433, and the time-series data 436 generates numerical values of the item indicated by the item name 435 as a graph in a time series. In the example illustrated in FIG. 37, the “running velocity”, the “brake amount in landing”, the “running pitch”, and the “stride” are selected, and a time-series graph is displayed in which a transverse axis expresses time from the start of running, and a longitudinal axis expresses a numerical value of each of the items. A sliding bar 439a which can be moved in the horizontal direction is displayed on the time-series data 436, and the user can select a time point from the start of running by moving the sliding bar 439a. A numerical value of each item of the summary image 433 or a position of a mark 439b of the running path image 434 changes in interlocking with a position (a time point selected by the user) of the sliding bar 439a.

The whole analysis button 437 is a button for transition from the detail analysis mode to the whole analysis mode, and if the user performs a selection operation (pressing operation) of the whole analysis button 437, transition to the whole analysis mode occurs, and a whole analysis screen is displayed.

The comparison analysis button 438 is a button for transition from the detail analysis mode to the comparison analysis mode, and if the user performs a selection operation (pressing operation) of the comparison analysis button 438, transition to the comparison analysis mode occurs, and a comparison analysis screen is displayed.

In the example illustrated in FIG. 38, a detail analysis screen 440 (second page) includes animation images 441 and 442 of the running selected by the user, a message image 443, an item name 444 of an item selected by the user, and a line graph 445 and a histogram 446 which show numerical values related to the right foot and the left foot of the item name 444 in a time series.

The animation image 441 is an image obtained when the user is viewed from the side, and the animation image 442 is an image obtained when the user is viewed from the front. The animation image 441 also includes comparison display between a propulsion force or a kicking angle of the user and an ideal propulsion force or kicking angle. Similarly, the animation image 442 also includes comparison display between a forward tilt angle of the user and an ideal forward tilt angle.

The message image 443 displays evaluation information for a result of the user's running, a message for improving running attainments, or the like. In the example illustrated in FIG. 38, a message of evaluation and an advice is displayed, such as the content that “the propulsion efficiency is low; the vertical movement or the horizontal movement may be large; if you kicks excessively, you takes such a form as springing up, and a burden on the calves increases; therefore, run in such a state of capturing the ground with the entire sole”.

The item name 444 indicates an item selected by the user from the items included in the summary image 433 illustrated in FIG. 37, and the line graph 445 and the histogram 446 generate numerical values related to the right foot and the left foot of the item indicated by the item name 444 as a graph by arranging the numerical values in a time series. In the example illustrated in FIG. 38, the “brake amount in landing” is selected, and the line graph 445 is displayed in which a transverse axis expresses time from the start of running, and a longitudinal axis expresses a numerical value related to the left and right feet. The histogram 446 is displayed in which a transverse axis expresses the brake amount in landing, and a longitudinal axis expresses a frequency in which the left foot and the right foot are differentiated from each other by colors.

In the example illustrated in FIG. 39, a detail analysis screen 450 (third page) includes message images 451, 452 and 453 based on an analysis result of the running selected by the user.

In the example illustrated in FIG. 39, the message image 451 displays a message of evaluation or an advice such as the content that “the efficiency decreases by O % due to landing; useless jumping occurs in kicking and thus the efficiency decreases by O %; there is a difference of O % in a kicking force between the left and right sides”. The message image 452 displays a message of an advice for obtaining a time reduction effect, such as the content that “delay occurs about 3 cm per step due to useless motion; if this is improved, about three minutes are reduced in full marathon”. The message image 453 displays a message of an instruction such as the content that “the directly-below landing ratio tends to worsen on the latter half of the running; LSD training is required to increase the endurance”.

By checking the details, the advices, or the like of the running performed in the past while viewing the detail analysis screens illustrated in FIGS. 37 to 39, the user can recognize an advantage or a disadvantage of the user's running way, and can practice the running way for improving running attainments or the running way for improving a running state in the next running and thereafter.

### Comparison Analysis Screen

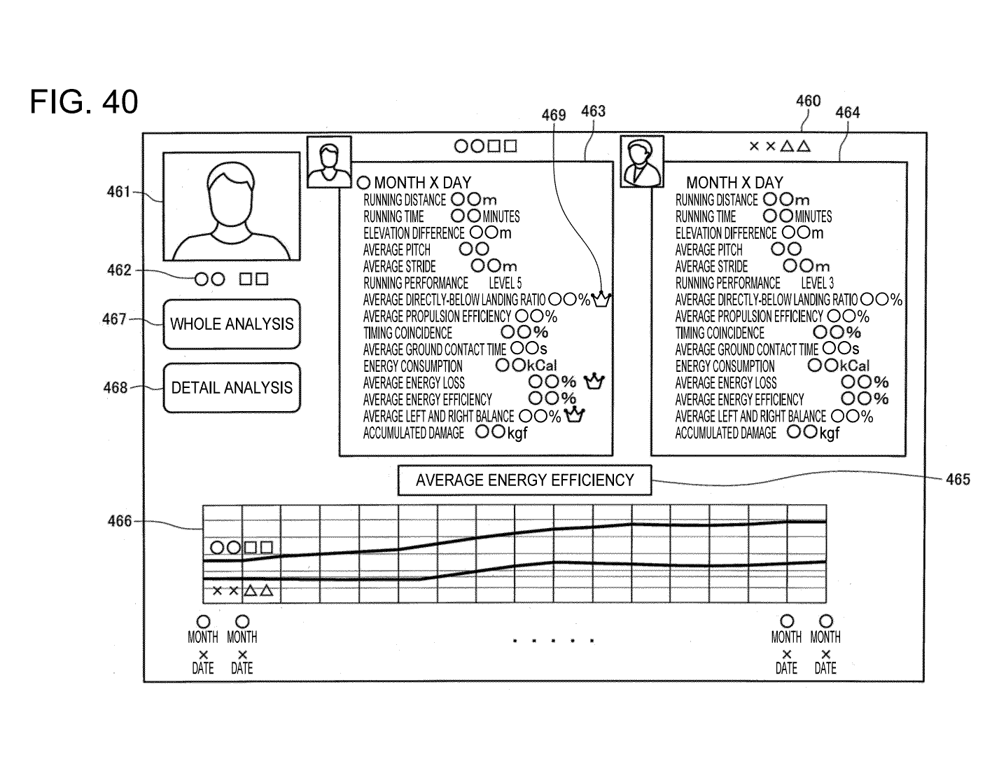

FIG. 40 illustrates an example of a screen (comparison analysis screen) of comparison analysis information displayed on the display unit 170 of the display apparatus 3.

In the example illustrated in FIG. 40, a comparison analysis screen 460 includes a user image 461 and a user name 462 which are registered in advance by the user, a summary image 463 displaying an analysis result of past running selected by the user, a summary image 464 displaying an analysis result of past running of another user, an item name 465 of an item selected by the user and time-series data 466 thereof, a whole analysis button 467, and a detail analysis button 468.

The summary image 463 includes respective numerical values of a “running distance”, a “running time”, an “elevation difference (between the start and the goal)”, an “average pitch (an average value of running pitches)”, an “average stride (an average value of strides)” “running performance”, an “average directly-below landing ratio (an average value of directly-below landing ratios)”, an “average propulsion efficiency (an average value of propulsion efficiency)”, “timing coincidence”, an “average ground contact time (an average value of ground contact times)”, “energy consumption”, an “average energy loss (an average value of energy losses)”, “average energy efficiency (an average value of energy efficiency)”, an “average left and right balance (an average value of left-right difference ratios)”, and an “accumulated damage (burden on the body)”, on the date on which past running was performed and which is selected by the user, and in this running.

In the summary image 463, a predetermined mark 469 is added beside an item whose numerical value is better than a reference value. In the example illustrated in FIG. 40, the mark 469 is added to the “average directly-below landing ratio”, the “average energy loss”, and the “average left and right balance”. A predetermined mark may be added to an item whose numerical value is worse than a reference value, or an item whose improvement ratio is higher or lower than a reference value.

The summary image 464 includes the date on which another user performed past running, and numerical values of the same items as the items included in the summary image 463. In FIG. 40, the name and an image of another user are displayed around the summary image 464.

The item name 465 indicates an item selected by the user from the items included in the summary image 463, and the time-series data 466 generates numerical values of the item indicated by the item name 465 as a graph in a time series. In the example illustrated in FIG. 40, the “average energy efficiency” is selected, and a time-series graph is displayed in which a transverse axis expresses the running date, and a longitudinal axis expresses numerical values of the average energy efficiency of the user and another user. If the user selects one date on the transverse axis of the time-series data 466, an analysis result of the running (for example, the closest running if running is not present on the selected date) of the user and another user on the selected date is displayed on the summary image 463 and the summary image 464.

The whole analysis button 467 is a button for transition from the comparison analysis mode to the whole analysis mode, and if the user performs a selection operation (pressing operation) of the whole analysis button 467, transition to the whole analysis mode occurs, and a whole analysis screen is displayed.

The detail analysis button 468 is a button for transition from the comparison analysis mode to the detail analysis mode, and if the user performs a selection operation (pressing operation) of the detail analysis button 468, transition to the detail analysis mode occurs, and a detail analysis screen is displayed.

By checking the comparison results of the attainments of the running performed in the past and the running attainments of another user while viewing the comparison analysis screen illustrated in FIG. 40, the user can recognize an advantage or a disadvantage of the user's running way, and can practice the running way for improving running attainments or the running way for improving a running state in the next running and thereafter.

### 1-11. Usage Examples of Exercise Analysis System

The user can use the exercise analysis system 1 of the present embodiment for usage as exemplified below.

### Usage Example During Running

The user displays a running pitch or a stride in a time series from the start of running, and performs a running exercise while checking how the running pitch or the stride changes from the start of running.

The user displays a brake amount in landing or a directly-below landing ratio in a time series from the start of running, and performs a running exercise while checking how the brake amount in landing or the directly-below landing ratio changes from the start of running.

The user displays a propulsion force or propulsion efficiency in a time series from the start of running, and performs a running exercise while checking how the propulsion force or the propulsion efficiency changes from the start of running.

The user displays running performance in a time series from the start of running, and performs a running exercise while checking to what extent the running performance changes from the start of running.

The user displays a forward tilt angle in a time series from the start of running, and performs a running exercise while checking how the forward tilt angle changes relative to an ideal value from the start of running.

The user displays timing coincidence of waist rotation in a time series from the start of running, and performs a running exercise while checking how a timing of waist rotation changes relative to an ideal timing from the start of running.

The user displays an amount of energy consumption, an energy loss, energy efficiency, a landing impact, or a left-right difference ratio in a time series from the start of running, and observes, as a reference of running, to what extent the amount of energy consumption for one step, the energy loss for one step, the energy efficiency for one step, the landing impact, or the left-right difference ratio changes. The user displays an accumulated damage (burden on the body) and determines a break timing by referring to the accumulated damage (burden on the body) from the start of running.

Usage Examples after Running

The user selects a whole analysis screen, displays an average pitch or an average stride in a plurality of past running items in a time series in order of the date, and checks the progress, for example, how the pitch or the stride changes relative to an ideal running pitch or stride as a reference of a running exercise. Alternatively, the user selects a detail analysis screen, displays a running pitch or a stride in a certain single running item in a time series in order of time points from the start of the running, and checks how the running pitch or the stride changes in the single running item as a reference of a running exercise.

The user selects a whole analysis screen, displays an average brake amount in landing and an average directly-below landing ratio in a plurality of past running items in a time series in order of the date, and checks the progress, for example, how the brake amount in landing or the directly-below landing ratio changes relative to an ideal value, or whether or not the brake amount in landing is reduced due to improvement in the directly-below landing ratio as a reference of a running exercise. Alternatively, the user selects a detail analysis screen, displays a brake amount in landing and a directly-below landing ratio in a certain single running item in a time series in order of time points from the start of the running, and checks to what extent the brake amount in landing or the directly-below landing ratio changes in the single running item as a reference of a running exercise.

The user selects a whole analysis screen, displays an average propulsion force and average propulsion efficiency in a plurality of past running items in a time series in order of the date, and checks the progress, for example, how the propulsion force or the propulsion efficiency changes relative to an ideal value, or whether or not the propulsion force increases due to improvement in the propulsion efficiency as a reference of a running exercise. Alternatively, the user selects a detail analysis screen, displays a propulsion force and propulsion efficiency in a certain single running item in a time series in order of time points from the start of the running, and checks to what extent the propulsion force or the propulsion efficiency changes in the single running item as a reference of a running exercise.

The user selects a whole analysis screen, displays running performance in a plurality of past running items in a time series in order of the date, checks the progress of the running performance from the past, and enjoys improvement in the performance. Alternatively, the user selects a comparison analysis screen, displays running performance of the user and running performance of a user's friend in a time series, and enjoys improvement in the performance through comparison. Alternatively, the user selects a detail analysis screen, displays running performance in a certain single running item in a time series in order of time points from the start of the running, and checks to what extent the running performance changes in the single running item as a reference of a running exercise.

The user selects a whole analysis screen, displays an average forward tilt angle in a plurality of past running items in a time series in order of the date, and checks the progress, for example, how the forward tilt angle changes relative to an ideal value as a reference of a running exercise. Alternatively, the user selects a detail analysis screen, displays a forward tilt angle in a certain single running item in a time series in order of time points from the start of the running, and checks how the forward tilt angle changes in the single running item as a reference of a running exercise.

The user selects a whole analysis screen, displays timing coincidence of waist rotation in a plurality of past running items in a time series in order of the date, and checks the progress, for example, how a timing of waist rotation changes relative to an ideal timing as a reference of a running exercise. Alternatively, the user selects a detail analysis screen, displays timing coincidence of waist rotation in a certain single running item in a time series in order of time points from the start of the running, and checks how the timing coincidence changes in the single running item as a reference of a running exercise.

The user selects a whole analysis screen, displays energy consumption, an average energy loss, average energy efficiency and an average directly-below landing ratio, or average propulsion efficiency in a plurality of past running items in a time series in order of the date, and checks whether or not an efficient running state is achieved by comparing an amount of energy consumption, an energy loss, or energy efficiency with the directly-below landing ratio or the propulsion efficiency. Alternatively, the user selects a detail analysis screen, displays an amount of energy consumption, an energy loss, or energy efficiency in a certain single running item in a time series in order of time points from the start of the running, and checks how the amount of energy consumption for one step, the energy loss for one step, or the energy efficiency for one step changes in the single running item as a reference of a running exercise.

The user selects a whole analysis screen, displays an landing impact and an average directly-below landing ratio, or average propulsion efficiency in a plurality of past running items in a time series in order of the date, and checks whether or not a danger of injury is reduced by comparing the landing impact with the directly-below landing ratio or the propulsion efficiency. Alternatively, the user selects a detail analysis screen, displays a landing impact in a certain single running item in a time series in order of time points from the start of the running, and checks to what extent the landing impact changes in the single running item as a reference of a running exercise.

The user selects a whole analysis screen, displays an average left-right difference ratio (an average left and right balance) in a plurality of past running items in a time series in order of the date, and observes and enjoys the progress, for example, to what extent the left-right difference ratio improves from the past. Alternatively, the user selects a detail analysis screen, displays a left-right difference ratio in a certain single running item in a time series in order of time points from the start of the running, and checks how the left-right difference ratio changes in the single running item as a reference of a running exercise.

### 1-12. Procedure of Process

FIG. 41 is a flowchart illustrating an example (an example of an exercise analysis method) of procedures of the exercise analysis process performed by the processing unit 20 of the exercise analysis apparatus 2 in the first embodiment during the user's running. The processing unit 20 of the exercise analysis apparatus 2 (an example of a computer) performs the exercise analysis process according to the procedures of the flowchart illustrated in FIG. 41 by executing the exercise analysis program 300 stored in the storage unit 30.

As illustrated in FIG. 41, the processing unit 20 waits for a command for starting measurement to be received (N in step S10), and if the command for starting measurement is received (Y in step S10), first, the processing unit 20 computes an initial attitude, an initial position, and an initial bias by using sensing data and GPS data measured by the inertial measurement unit 10 assuming that the user stops (step S20).

Next, the processing unit 20 acquires the sensing data from the inertial measurement unit 10, and adds the acquired sensing data to the sensing data table 310 (step S30).

Next, the processing unit 20 performs an inertial navigation calculation process so as to generate calculation data including various information pieces (step S40). An example of procedures of the inertial navigation calculation process will be described later.

Next, the processing unit 20 performs an exercise analysis information generation process by using the calculation data generated in step S40 so as to generate exercise analysis information and output information during running, and transmits the output information during running to the display apparatus 3 (step S50). An example of procedures of the exercise analysis information generation process will be described later. The output information during running transmitted to the display apparatus 3 is fed back in real time during the user's running. In the present specification, the “real time” indicates that processing is started at a timing at which processing target information is acquired. Therefore, the “real time” also includes some time difference between acquisition of information and completion of processing of the information.

The processing unit 20 repeatedly performs the processes in step S30 and the subsequent steps whenever the sampling cycle Δt elapses (Y in step S60) from the acquisition of the previous sensing data until a command for finishing the measurement is received (N in step S60 and N in step S70). If the command for finishing the measurement is received (Y in step S70), the processing unit 20 waits for a running analysis starting command for giving an instruction for starting a running analysis process (N in step S80).

If the running analysis starting command is received (Y in step S80), the processing unit 20 performs a running analysis process on the user's past running by using the exercise analysis information generated in step S50 or exercise analysis information which was generated during the past running and was stored in the storage unit 30, and transmits information regarding an analysis result to the display apparatus 3 or other information apparatuses (step S90). An example of procedures of the running analysis process will be described later. If the running analysis process is completed, the processing unit 20 finishes the exercise analysis process.

FIG. 42 is a flowchart illustrating an example of procedures of the inertial navigation calculation process (the process in step S40 of FIG. 41) in the first embodiment. The processing unit 20 (the inertial navigation calculation unit 22) performs the inertial navigation calculation process according to the procedures of the flowchart illustrated in FIG. 42 by executing the inertial navigation calculation program 302 stored in the storage unit 30.

As illustrated in FIG. 42, first, the processing unit 20 removes biases from acceleration and angular velocity included in the sensing data acquired in step S30 of FIG. 41 by using the initial bias calculated in step S20 of FIG. 41 (by using the acceleration bias bₐ and an angular velocity bias b_{ω} after the acceleration bias bₐ and the angular velocity bias b_{ω} are estimated in step S150 to be described later) so as to correct the acceleration and the angular velocity, and updates the sensing data table 310 by using the corrected acceleration and velocity (step S100).

Next, the processing unit 20 integrates the sensing data corrected in step S100 so as to compute a velocity, a position, and an attitude angle, and adds calculated data including the computed velocity, position, and attitude angle to the calculated data table 340 (step S110).

Next, the processing unit 20 performs a running detection process (step S120). An example of procedures of the running detection process will be described later.

Next, in a case where a running cycle is detected through the running detection process (step S120) (Y in step S130), the processing unit 20 computes a running pitch and a stride (step S140). If a running cycle is not detected (N in step S130), the processing unit 20 does not perform the process in step S140.

Next, the processing unit 20 performs an error estimation process so as to estimate a velocity error δv^{e}, an attitude angle errors ε^{e}, a acceleration bias bₐ, an angular velocity bias b_{ω}, and a position error δp^{e} (step S150).

Next, the processing unit 20 corrects the velocity, the position, and the attitude angle by using the velocity error δv^{e}, the attitude angle errors ε^{e}, and the position error δp^{e} estimated in step S150, and updates the calculated data table 340 by using the corrected velocity, position and attitude angle (step S160). The processing unit 20 integrates the velocity corrected in step S160 so as to compute a distance of the e frame (step S170).

Next, the processing unit 20 performs coordinate-converts the sensing data (the acceleration and the angular velocity of the b frame) stored in the sensing data table 310, the calculated data (the velocity, the position, and the attitude angle of the e frame) stored in the calculated data table 340, and the distance of the e frame calculated in step S170 into acceleration, angular velocity, velocity, a position, an attitude angle, and a distance of the m frame, respectively (step S180).

The processing unit 20 generates calculation data including the acceleration, the angular velocity, the velocity, the position, and the attitude angle of the m frame having undergone the coordinate conversion in step S180, and the stride and the running pitch calculated in step S140 (step S190). The processing unit 20 performs the inertial navigation calculation process (the processes in steps S100 to S190) whenever sensing data is acquired in step S30 of FIG. 41.

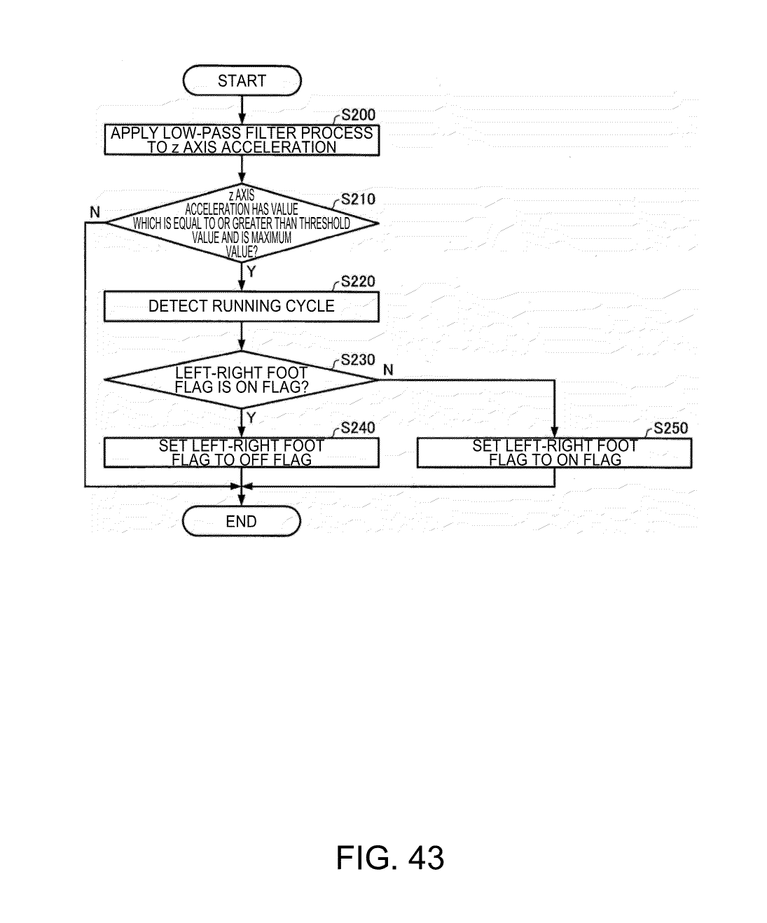

FIG. 43 is a flowchart illustrating an example of procedures of the running detection process (the process in step S120 of FIG. 42). The processing unit 20 (the running detection section 242) performs the running detection process according to the procedures of the flowchart illustrated in FIG. 43.

As illustrated in FIG. 43, the processing unit 20 performs a low-pass filter process on a z axis acceleration included in the acceleration corrected in step S100 of FIG. 42 (step S200) so as to remove noise therefrom.

Next, if the z axis acceleration having undergone the low-pass filter process in step S200 has a value which is equal to or greater than a threshold value and is the maximum value (Y in step S210), the processing unit 20 detects a running cycle at this timing (step S220).

If a left-right foot flag is an ON flag (Y in step S230), the processing unit 20 sets the left-right foot flag to an OFF flag (step S240), and if the left-right foot flag is not an ON flag (N in step S230), the processing unit 20 sets the left-right foot flag to an ON flag (step S250), and finishes the running detection process. If the z axis acceleration has a value which is smaller than the threshold value or is not the maximum value (N in step S210), the processing unit 20 does not perform the processes in steps S220 and the subsequent steps and finishes the running detection process.

FIG. 44 is a flowchart illustrating an example of procedures of the exercise analysis information generation process (the process in step S50 of FIG. 41) in the first embodiment. The processing unit 20 (the exercise analysis unit 24) performs the exercise analysis information generation process according to the procedures of the flowchart illustrated in FIG. 44 by executing the exercise analysis information generation program 304 stored in the storage unit 30.

As illustrated in FIG. 44, first, the processing unit 20 calculates each item of the basic information by using the calculation data generated through the inertial navigation calculation process of the step S40 of FIG. 41 (step S300). The processing unit 20 calculates a running path by using the calculation data so as to generate running path information (step S310).

Next, the processing unit 20 performs a process of detecting a feature point (landing, stepping, taking-off, or the like) in the running exercise of the user by using the calculation data (step S320).

If the feature point is detected through the process in step S320 (Y in step S330), the processing unit 20 calculates a ground contact time and an impact time on the basis of the timing of detecting the feature point (step S340). The processing unit 20 calculates some items (which require information regarding the feature point in order to calculate the items) of the first analysis information on the basis of the timing of detecting the feature point by using some of the calculation data and the ground contact time and the impact time generated in step S340 as input information (step S350). If a feature point is not detected through the process in step S320 (N in step S330), the processing unit 20 does not the processes in steps S340 and S350.

Next, the processing unit 20 calculates remaining items (which does not require the information regarding the feature point in order to calculate the items) of the first analysis information by using the input information (step S360).

Next, the processing unit 20 calculates each item of the second analysis information by using the first analysis information (step S370).

Next, the processing unit 20 calculates a left-right difference ratio for each item of the input information, each item of the first analysis information, and each item of the second analysis information (step S380). The processing unit 20 stores the input information, the basic information, the first analysis information, the second analysis information, the left-right difference ratio, and the running path information in the storage unit 30 as the exercise analysis information 350.

Next, the processing unit 20 generates output information during running by using the input information, the basic information, the first analysis information, the second analysis information, the left-right difference ratio, and the running path information, transmits the generated output information during running to the display apparatus 3 (step S390), and finishes the exercise analysis information generation process.

FIG. 45 is a flowchart illustrating an example of procedures of the running analysis process (the process in step S90 of FIG. 41). The processing unit 20 (the running analysis portion 290) performs the running analysis process according to the procedures of the flowchart illustrated in FIG. 45 by executing the running analysis program 306 stored in the storage unit 30.

As illustrated in FIG. 45, the processing unit 20 selects the whole analysis mode, the processing unit 20 performs whole analysis on past running of the user so as to generate whole analysis information by using the exercise analysis information generated through the exercise analysis process in step S50 of FIG. 41 or exercise analysis information which was generated during the past running and was stored in the storage unit 30, and transmits the whole analysis information to the display apparatus 3 or other information apparatuses as output information after running (step S400).

If a running analysis finishing command for giving an instruction for finishing the running analysis process is received in the whole analysis mode (Y in step S402), the processing unit 20 finishes the running analysis process. If the running analysis finishing command is not received (N in step S402), and transition to the detail analysis mode or the comparison analysis mode does not occur (N in step S404 and N in step S406), the processing unit 20 repeatedly performs the whole analysis process (step S400).

If transition occurs from the whole analysis mode to the detail analysis mode (Y in step S404), the processing unit 20 performs detail analysis so as to generate detail analysis information, and transmits the generated detail analysis information to the display apparatus 3 or other information apparatuses as the output information after running (step S410). The transition from the whole analysis mode to the detail analysis mode occurs, for example, when the user performs a selection operation (pressing operation) of the detail analysis button 417 included in the whole analysis screen 410 illustrated in FIG. 35.

If the running analysis finishing command is received in the detail analysis mode (Y in step S412), the processing unit 20 finishes the running analysis process. If the running analysis finishing command is not received (N in step S412), and transition to the comparison analysis mode or the whole analysis mode does not occur (N in step S414 and N in step S416), the processing unit 20 repeatedly performs the detail analysis process in response to a user's operation (step S410).

If transition occurs from the whole analysis mode to the comparison analysis mode (Y in step S406), or transition occurs from the detail analysis mode to the comparison analysis mode (Y in step S414), the processing unit 20 performs comparison analysis so as to generate comparison analysis information, and transmits the generated comparison analysis information to the display apparatus 3 or other information apparatuses as the output information after running (step S420). The transition from the whole analysis mode to the comparison analysis mode occurs, for example, when the user performs a selection operation (pressing operation) of the comparison analysis button 418 included in the whole analysis screen 410 illustrated in FIG. 35. The transition from the detail analysis mode to the comparison analysis mode occurs, for example, when the user performs a selection operation (pressing operation) of the comparison analysis button 438 included in the detail analysis screen 430 illustrated in FIG. 37.

If the running analysis finishing command is received in the comparison analysis mode (Y in step S422), the processing unit 20 finishes the running analysis process. If the running analysis finishing command is not received (N in step S422), and transition to the whole analysis mode or the detail analysis mode does not occur (N in step S424 and N in step S426), the processing unit 20 repeatedly performs the comparison analysis process in response to a user's operation (step S420).

If transition occurs from the detail analysis mode to the whole analysis mode (Y in step S416), or transition occurs from the comparison analysis mode to the whole analysis mode (Y in step S424), the processing unit 20 performs the whole analysis process in step S400. The transition from the detail analysis mode to the whole analysis mode occurs, for example, when the user performs a selection operation (pressing operation) of the whole analysis button 437 included in the detail analysis screen 430 illustrated in FIG. 37. The transition from the comparison analysis mode to the whole analysis mode occurs, for example, when the user performs a selection operation (pressing operation) of the whole analysis button 467 included in the comparison analysis screen 460 illustrated in FIG. 40.

If transition occurs from the comparison analysis mode to the detail analysis mode (Y in step S426), the processing unit 20 performs the detail analysis process in step S410. The transition from the comparison analysis mode to the detail analysis mode occurs, for example, when the user performs a selection operation (pressing operation) of the detail analysis button 468 included in the comparison analysis screen 460 illustrated in FIG. 40.

### 1-3. Effects

In the first embodiment, the exercise analysis apparatus 2 presents a comparison result between at least one of a plurality of exercise information pieces with a reference value which is set in advance (specifically, presents, to the user, information which is generated on the basis of exercise information satisfying a predetermined condition according to a running state) during the user's running, and thus the user can easily utilize the presented information during running. Since the exercise analysis apparatus 2 presents information which is based on some of the exercise information pieces generated during the user's running, to the user after running, the user can also easily utilize the presented information after running. Therefore, according to the first embodiment, it is possible to assist the user in improving running attainments.

In the first embodiment, the exercise analysis apparatus 2 presents an item in which a running state is good or an item in which a running state is bad, to the user during the user's running. Therefore, according to the first embodiment, the user can run while recognizing an advantage or a disadvantage of the user's running way.

In the first embodiment, the exercise analysis apparatus 2 generates information regarding various evaluation types or advices corresponding to a running state of the user and presents the information the user while the user is running or after the user finishes the running. Therefore, according to the first embodiment, the user can promptly and accurately recognize an advantage or a disadvantage of the user's running way, and can thus efficiently improve running attainments.

According to the first embodiment, the exercise analysis apparatus 2 also presents information which is not presented during the user's running, after running is finished, and thus it is possible to assist the user in improving running attainments.

According to the first embodiment, the exercise analysis apparatus 2 also presents information which is presented during the user's running, after the running is finished, and thus the user can recognize a running state which cannot be recognized during the running, after the running. Therefore, it is possible to assist the user in improving running attainments.

In the first embodiment, the exercise analysis apparatus 2 calculates a ground contact time, an impact time, and some items of the first analysis information which cause a tendency of the way of moving the body during the user's running to be easily extracted with a feature point such as landing, stepping, or taking-off (kicking) of an exercise in the running of the user as a reference by using a detection result from the inertial measurement unit 10. In the first embodiment, the exercise analysis apparatus 2 calculates remaining items of the first analysis information, each item of the second analysis information, and a left-right difference ratio of each item so as to generate various exercise information pieces, and presents output information during running or output information after running which is generated by using the exercise information pieces, to the user. Therefore, according to the first embodiment, it is possible to assist the user in improving running attainments.

Particularly, in the first embodiment, the exercise analysis apparatus 2 generates exercise information which reflects a state of the user's body in a feature point or the way of moving the user's body between two feature points and is effective in order to improve running attainments of the user, by using a detection result from the inertial measurement unit 10 in the feature point in the user's running, or a detection result from the inertial measurement unit 10 between the two feature points, and presents the exercise information to the user. Therefore, according to the first embodiment, the user can check the presented information and can efficiently improve running attainments.

In the first embodiment, the exercise analysis apparatus 2 combines a plurality of items of the first analysis information so as to generate each item (energy efficiency, an energy loss, and a burden on the body) of the second analysis information which reflects the way of moving the user's body during running and which causes the user to easily recognize a running state, and presents each item of the second analysis information to the user. Therefore, according to the first embodiment, the user can continuously run while recognizing whether or not an efficient running way is obtained, or whether or not a risk of injury is low, or can perform checking thereof after running.

In the first embodiment, the exercise analysis apparatus 2 calculates a left-right difference ratio for each item of the input information, the first analysis information, and the second analysis information, and presents the item to the user. Therefore, according to the first embodiment, the user can examine training for improving left and right balance in consideration of a risk of injury.

### 2. Second Embodiment

In a second embodiment, the same constituent elements as those of the first embodiment are given the same reference numerals and will not be described or will be described briefly, and the content which is different from that of the first embodiment will be described in detail.

### 2-1 Summary of Physical Activity Assisting System

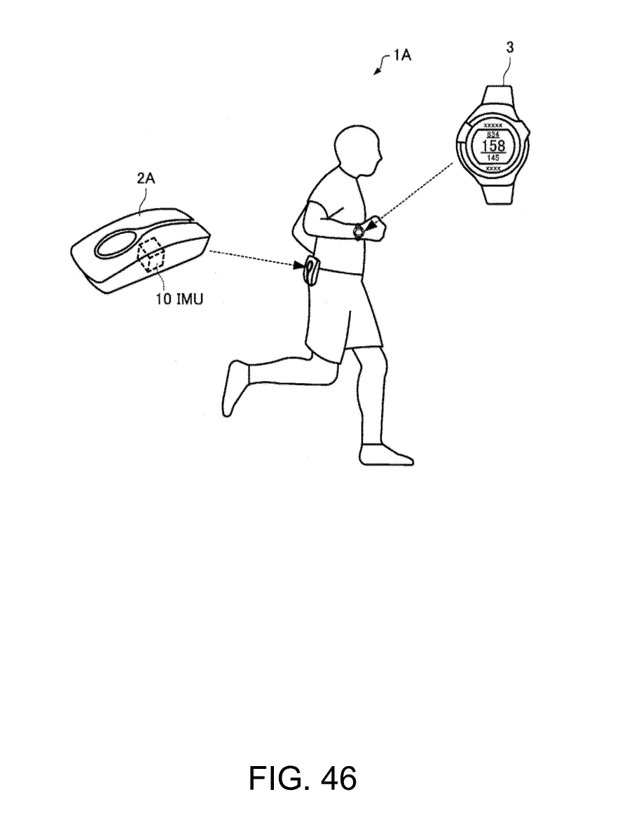

FIG. 46 is a diagram illustrating a summary of a physical activity assisting system 1A of the second embodiment. As illustrated in FIG. 46, the physical activity assisting system 1A of the second embodiment includes a physical activity assisting apparatus 2A and a display apparatus 3. The physical activity assisting apparatus 2A analyzes a user's physical activity (exercise), and presents information for assisting the physical activity to the user via the display apparatus 3. In other words, the physical activity assisting apparatus 2A functions as an exercise analysis apparatus, and the physical activity assisting system 1A functions as an exercise analysis system. Particularly, in the second embodiment, the physical activity assisting system 1A presents information for assisting a user's running (including walking) (an example of a physical activity) to the user.

The physical activity assisting apparatus 2A is mounted on a body part (for example, a right waist, a left waist, or a central part of the waist) of the user. The physical activity assisting apparatus 2A has an inertial measurement unit (IMU) 10 built thereinto, specifies a motion in the user's running so as to compute a velocity, a position, and attitude angles (a roll angle, a pitch angle, and a yaw angle), and analyzes the user's exercise on the basis of such information so as to generate exercise analysis information (an advice regarding running) for assisting the user's running. In the present embodiment, the physical activity assisting apparatus 2A is mounted on the user so that one detection axis (hereinafter, referred to as a z axis) of the inertial measurement unit (IMU) 10 substantially matches the gravitational acceleration direction (vertically downward direction) in a state in which the user stands still. The physical activity assisting apparatus 2A transmits at least some of the exercise analysis information to the display apparatus 3.

The display apparatus 3 is a wrist type (wristwatch type) portable information apparatus and is mounted on a user's wrist or the like. However, the display apparatus 3 may be a portable information apparatus such as a head mounted display (HMD) or a smart phone. The user operates the display apparatus 3 before running, for inputting input information such as an analysis mode, a running distance, and a target time. Then, the user operates the display apparatus 3 so as to instruct the physical activity assisting apparatus 2A to start or stop measurement (an inertial navigation calculation process and an exercise analysis process to be described later). The display apparatus 3 transmits the input information, a command for giving an instruction for starting or stopping the measurement, and the like to the physical activity assisting apparatus 2A. The user may change the input information such as the analysis mode, the running distance, and the target time during running, and, if the input information is changed, the display apparatus 3 transmits the changed input information to the physical activity assisting apparatus 2A.

If the input information is received, the physical activity assisting apparatus 2A selects an advice mode corresponding to the input information from a plurality of advice modes. If the measurement start command is received, the physical activity assisting apparatus 2A causes the inertial measurement unit (IMU) 10 to start the measurement, and analyzes the user's exercise on the basis of a measurement result from the inertial measurement unit (IMU) 10 so as to generate exercise analysis information including advice information in response to the selected advice mode. The physical activity assisting apparatus 2A transmits the generated exercise analysis information to the display apparatus 3. The display apparatus 3 receives the exercise analysis information, and presents the received exercise analysis information to the user in various forms such as text, graphics, sound, and vibration. The user can practice the running way matching a purpose while recognizing the exercise analysis information via the display apparatus 3 during running.

Data communication between the physical activity assisting apparatus 2A and the display apparatus 3 may be wireless communication or wired communication.

In the present embodiment, hereinafter, as an example, a detailed description will be made of a case where the physical activity assisting apparatus 2A presents information for assisting a user's running, but the physical activity assisting system 1A of the present embodiment is also applicable to a case of presenting information for assisting physical activities other than running in the same manner.

### 2-2. Coordinate Systems

Coordinate systems which are necessary in the following description are defined in the same manner as in “1-2. Coordinate Systems” of the first embodiment.

### 2-3. Configuration of Physical Activity Assisting System

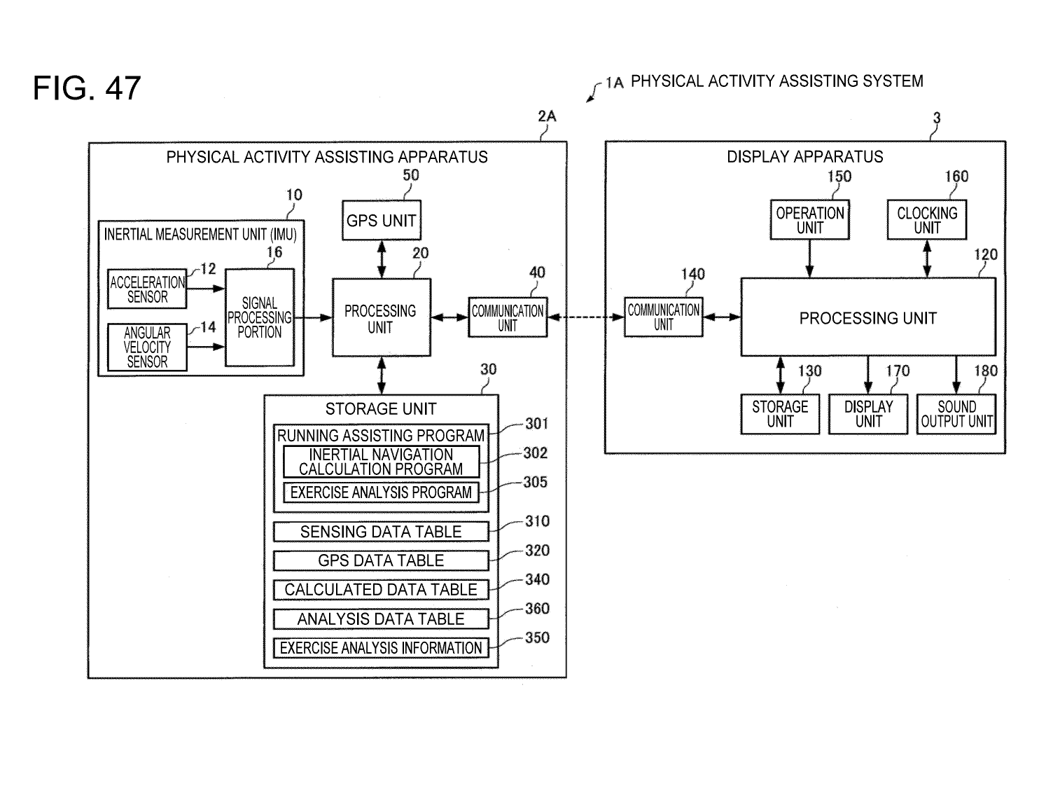

FIG. 47 is a functional block diagram illustrating configuration examples of the physical activity assisting apparatus 2A and the display apparatus 3 of the second embodiment. As illustrated in FIG. 47, the physical activity assisting apparatus 2A includes the inertial measurement unit (IMU) 10, a processing unit 20, a storage unit 30, a communication unit 40, and a global positioning system (GPS) unit 50 (an example of a sensor) in the same manner as the exercise analysis apparatus 2 of the first embodiment. However, the physical activity assisting apparatus 2A of the present embodiment may have a configuration in which some of the constituent elements are deleted or changed, or other constituent elements may be added thereto. A function of the GPS unit 50 is the same as in the first embodiment, and thus description thereof will be omitted.

The inertial measurement unit 10 includes an acceleration sensor 12 (an example of a sensor), an angular velocity sensor 14 (an example of a sensor), and a signal processing portion 16 in the same manner as in the first embodiment (FIG. 2). Each function of the acceleration sensor 12, the angular velocity sensor 14, and the signal processing portion 16 is the same as in the first embodiment, and thus description thereof will be omitted.

The processing unit 20 is constituted of, for example, a CPU, a DSP, or an ASIC, and performs various calculation processes or control processes according to a program stored in the storage unit 30. Particularly, the processing unit 20 receives sensing data and GPS data from the inertial measurement unit 10 and the GPS unit 50, respectively, and calculates a velocity, a position, an attitude angle of the user, and the like by using the data. The processing unit 20 performs various calculation processes by using the calculated information so as to analyze exercise of the user and to generate exercise analysis information. The processing unit 20 transmits the generated exercise analysis information to the display apparatus 3 via the communication unit 40, and the display apparatus 3 outputs the received exercise analysis information in a form of text, an image, sound, vibration, or the like.

The storage unit 30 is constituted of, for example, various IC memories such as a ROM, a flash ROM, or a RAM, or a recording medium such as a hard disk or a memory card.

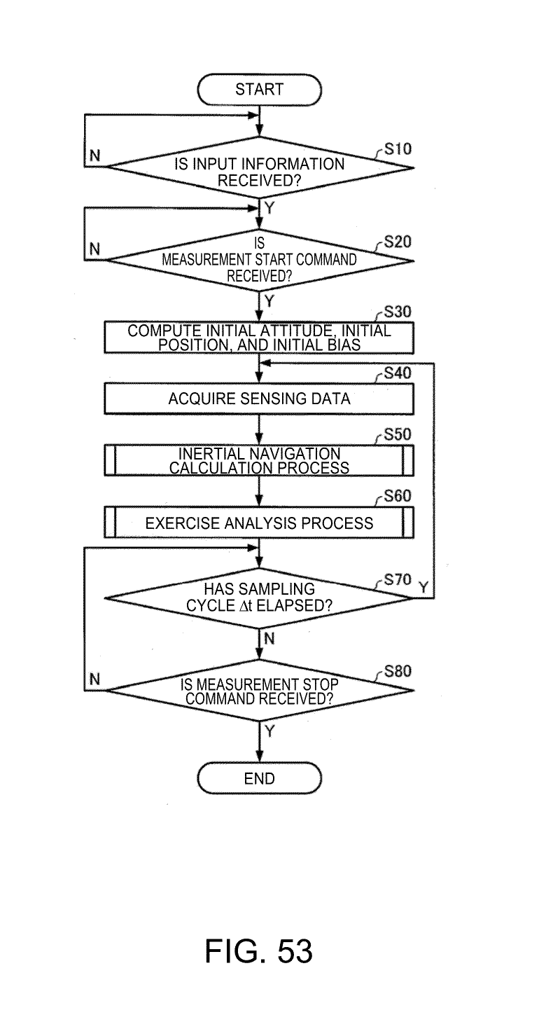

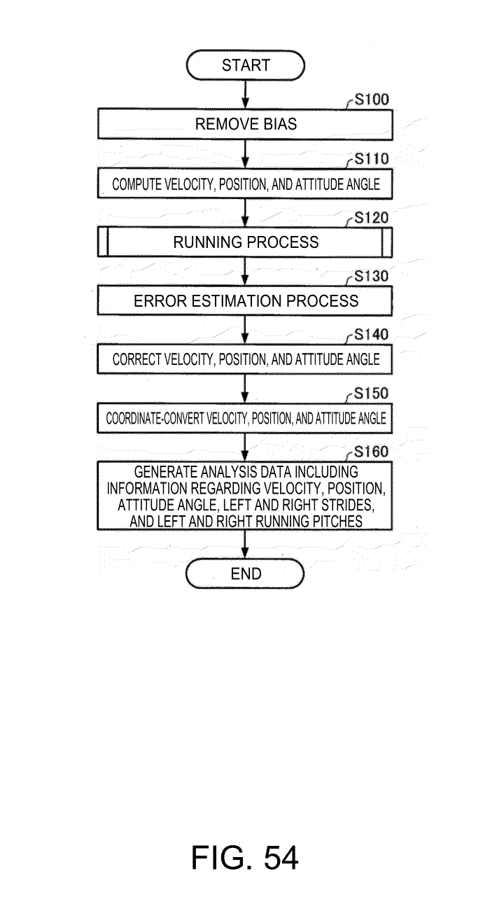

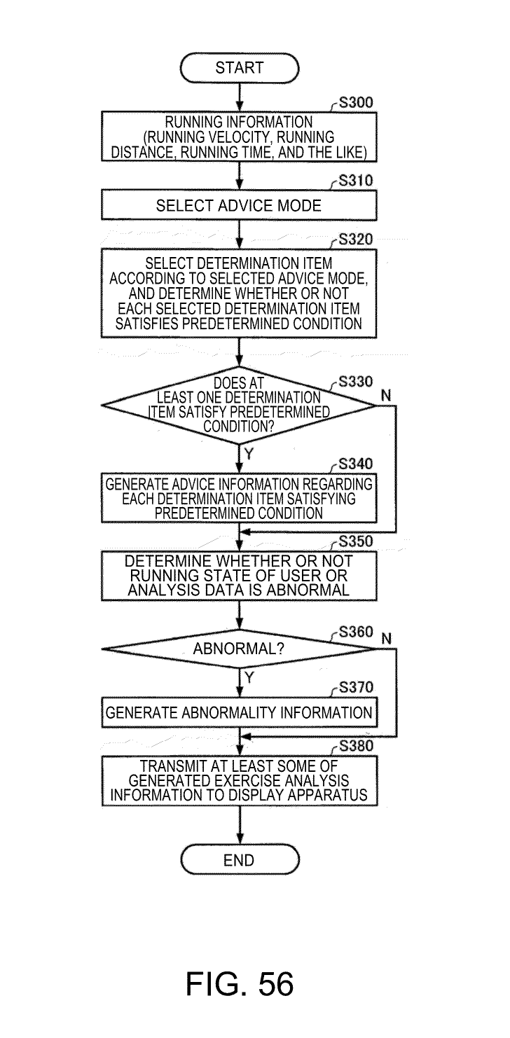

The storage unit 30 stores a running assisting program 301 (an example of a physical activity assisting program) which is read by the processing unit 20 and is used to perform a running assisting process (refer to FIG. 53). The running assisting program 301 includes, as sub-routines, an inertial navigation calculation program 302 for performing an inertial navigation calculation process (refer to FIG. 54), and an exercise analysis program 305 for performing an exercise analysis process (refer to FIG. 56).

The storage unit 30 stores a sensing data table 310, a GPS data table 320, a calculated data table 340, an analysis data table 360, exercise analysis information 350, and the like. Configurations of the sensing data table 310, the GPS data table 320, and the calculated data table 340 are the same as in the first embodiment (FIGS. 3, 4 and 6), and illustration and description thereof will be omitted.

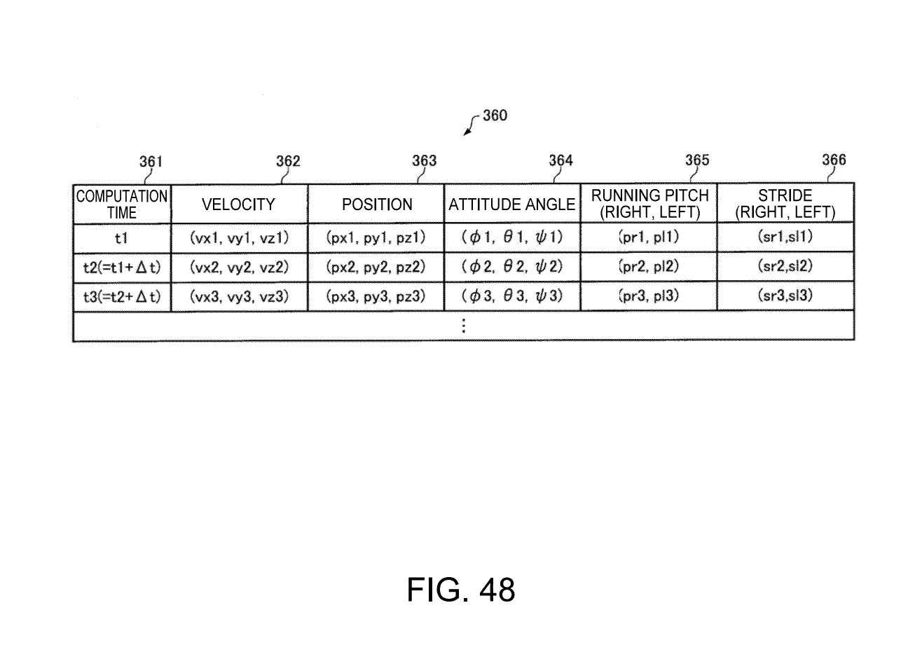

The analysis data table 360 is a data table storing, in a time series, data which is calculated by the processing unit 20 by using the sensing data and is required in exercise analysis. FIG. 48 is a diagram illustrating a configuration example of the analysis data table 360. As illustrated in FIG. 48, the analysis data table 360 is configured so that analysis data items such as a time point 361 at which the processing unit 20 performs computation, a velocity 362, a position 363, an attitude angle 364, a running pitch 365, and a stride 366 are correlated with each other in parallel in a time series. The processing unit 20 coordinate-converts the calculated velocity, position, and attitude angle into exercise analysis data whenever a sampling cycle Δt elapses, calculates a running pitch (the number of steps of per minute) of each of the right foot and the left foot, and a stride (a stride for one step) of each of the right foot and the left foot by using the sensing data, and adds new analysis data to the analysis data table 360.

The exercise analysis information 350 is various information pieces regarding the user's exercise, and includes information regarding a running velocity, a running time, and a running distance generated by the processing unit 20, information regarding evaluation or an advice related to a running state of the user, and the like. Details of the information regarding evaluation or an advice related to a running state of the user will be described later.

FIG. 47 is referred to again. The communication unit 40 performs data communication with the communication unit 140 of the display apparatus 3, and performs a process of receiving exercise analysis information generated by the processing unit 20 and transmitting the exercise analysis information to the display apparatus 3, and a process of receiving input information or a command (a measurement start or stop command, or the like) from the display apparatus 3 and sending the information or the command to the processing unit 20.

In the same manner as in the first embodiment (FIG. 2), the display apparatus 3 of the second embodiment includes a processing unit 120, a storage unit 130, the communication unit 140, an operation unit 150, a clocking unit 160, a display unit 170, a sound output unit 180, and a vibration unit 190. However, the display apparatus 3 of the present embodiment may have a configuration in which some of the constituent elements are deleted or changed, or other constituent elements may be added thereto.

Respective functions of the storage unit 130, the operation unit 150, the clocking unit 160, the display unit 170, the sound output unit 180, and the vibration unit 190 are the same as in the first embodiment, and thus description thereof will be omitted here.

The processing unit 120 performs various calculation processes or control processes according to a program stored in the storage unit 130. For example, the processing unit 120 performs various processes (a process of sending input information or a command for starting or stopping measurement to the communication unit 140, a process of performing display or outputting sound corresponding to the operation data, and the like) corresponding to operation data received from the operation unit 150; a process of receiving exercise analysis information from the communication unit 140 and sending text data or image data corresponding to the exercise analysis information to the display unit 170; a process of sending sound data corresponding to the exercise analysis information to the sound output unit 180; and a process of sending vibration data corresponding to the exercise analysis information to the vibration unit 190. The processing unit 120 performs a process of generating time image data corresponding to time information received from the clocking unit 160 and sending the time image data to the display unit 170, and the like.

The communication unit 140 performs data communication with the communication unit 40 of the physical activity assisting apparatus 2A, and performs a process of receiving input information or a command (a command for starting or stopping measurement or the like) corresponding to operation data from the processing unit 120 and transmitting the input information or the command to the physical activity assisting apparatus 2A, a process of receiving exercise analysis information transmitted from the physical activity assisting apparatus 2A and sending the information to the processing unit 120, and the like.

### 2-4. Functional Configuration of Processing Unit

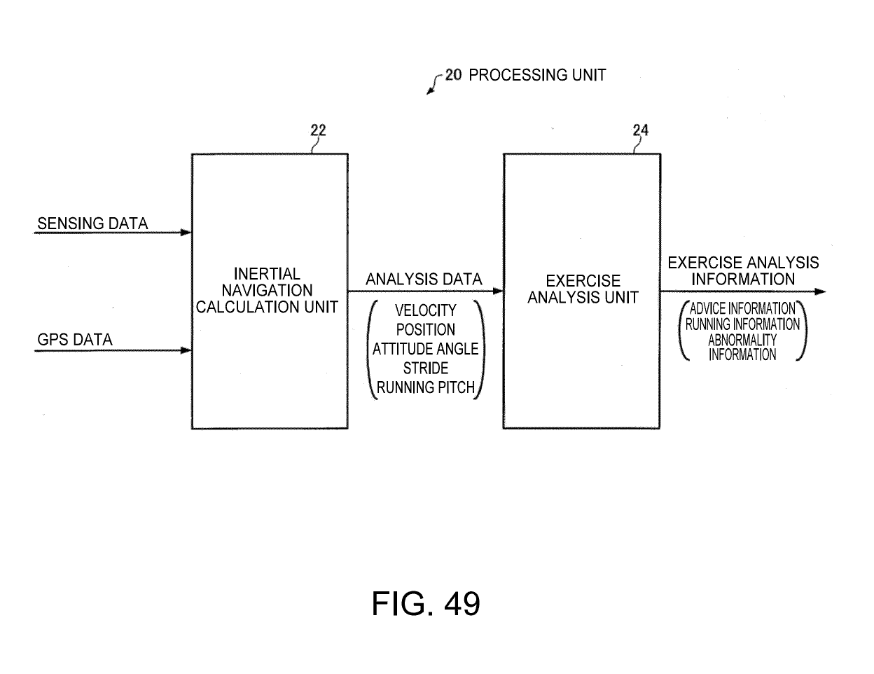

FIG. 49 is a functional block diagram illustrating a configuration example of the processing unit 20 of the physical activity assisting apparatus 2A in the second embodiment. In the second embodiment, the processing unit 20 functions as an inertial navigation calculation unit 22 and an exercise analysis unit 24 by executing the running assisting program 301 stored in the storage unit 30.

The inertial navigation calculation unit 22 (an example of a calculation unit) performs inertial navigation calculation (an example of calculation) by using sensing data (a detection result in the inertial measurement unit 10) and GPS data (a detection result in the GPS unit 50) in the user's running, so as to calculate a velocity, a position, an attitude angle, a stride, and a running pitch, and outputs analysis data including the calculation results. The analysis data output from the inertial navigation calculation unit 22 is stored in the analysis data table 360 of the storage unit 30. Details of the inertial navigation calculation unit 22 will be described later.

The exercise analysis unit 24 analyzes the running exercise of the user by using analysis data (the analysis data stored in the analysis data table 360) output from the inertial navigation calculation unit 22, so as to generate exercise analysis information. Particularly, in the present embodiment, the exercise analysis unit 24 selects any advice mode from a plurality of advice modes in which a determination item is set. For example, the exercise analysis unit 24 may select an advice mode from the plurality of advice modes on the basis of information input by the user. The exercise analysis unit 24 determines whether or not the analysis data (a calculation result in the inertial navigation calculation unit 22) satisfies a determination item set in the selected advice mode. In a case where the analysis data (the calculation result in the inertial navigation calculation unit 22) satisfies the determination item set in the selected advice mode, the exercise analysis unit 24 may generate advice information for sending a notification of a running state. Specifically, the exercise analysis unit 24 determines whether or not the analysis data (the calculation result in the inertial navigation calculation unit 22) satisfies a predetermined condition which corresponds to the selected advice mode and is correlated with a running state (an example of a physical activity state), and generates the advice information for sending a notification of the running state in a case where the predetermined condition is satisfied. The exercise analysis unit 24 also generates abnormality information indicating that running information such as a running velocity, a running distance, and a running time, a running state, or the analysis data is abnormal by using the analysis data. The exercise analysis unit 24 outputs exercise analysis information including the advice information, the running information, and the abnormality information. The exercise analysis information is transmitted to the display apparatus 3, and is presented as information for assisting running via the display apparatus 3 during the user's running.

### 2-5. Functional Configuration of Inertial Navigation Calculation Unit

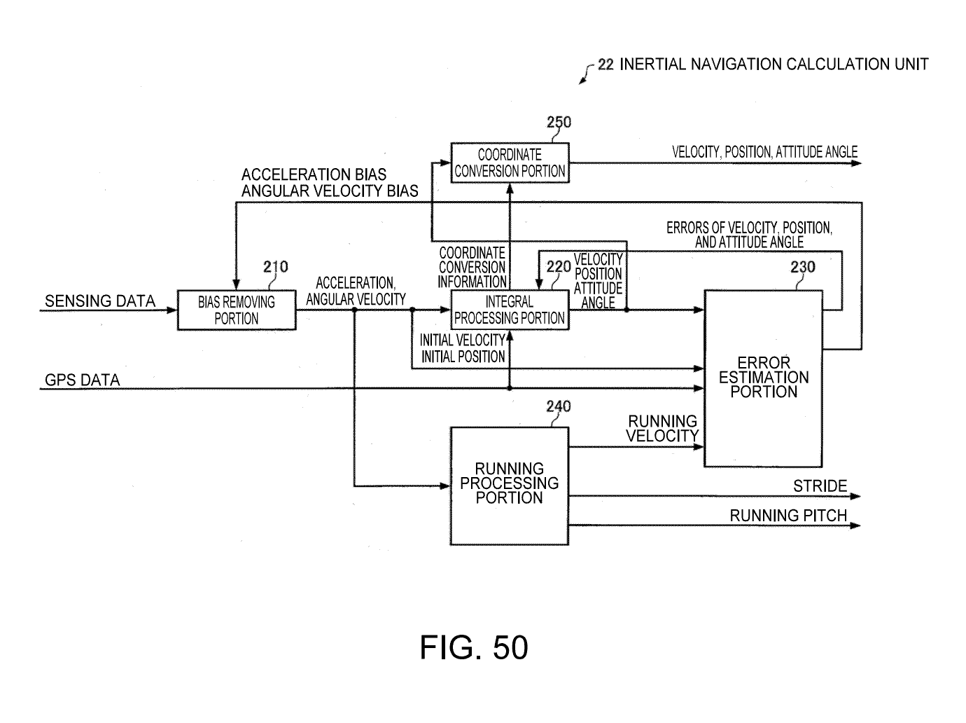

FIG. 50 is a functional block diagram illustrating a configuration example of the inertial navigation calculation unit 22 in the second embodiment. In the same manner as in the first embodiment, also in the second embodiment, the inertial navigation calculation unit 22 includes a bias removing portion 210, an integral processing portion 220, an error estimation portion 230, a running processing portion 240, and a coordinate conversion portion 250. However, the inertial navigation calculation unit 22 of the present embodiment may have a configuration in which some of the constituent elements are deleted or changed, or other constituent elements may be added thereto. Each function of the bias removing portion 210, the integral processing portion 220, and the coordinate conversion portion 250 is the same as in the first embodiment, and thus description thereof will be omitted.

The running processing portion 240 performs a process of calculating a running velocity, a stride, and a running pitch of the user by using a detection result (specifically, sensing data corrected by the bias removing portion 210) in the inertial measurement unit 10. As described with reference to FIGS. 9 and 10, since the user's attitude periodically changes (every two left and right steps) while the user is running, an acceleration detected by the inertial measurement unit 10 also periodically changes. As illustrated in FIG. 11, the three-axis accelerations periodically change, and, particularly, it can be seen that the z axis (the axis in the gravitational direction) acceleration changes periodically and regularly. The z axis acceleration reflects an acceleration obtained when the user moves vertically, and a time period from the time when the z axis acceleration becomes the maximum value which is equal to or greater than a predetermined threshold value to the time when the z axis acceleration becomes the maximum value which is equal to or greater than the predetermined threshold value next corresponds to a time period of one step.

Also in the present embodiment, in the same manner as in the first embodiment, the running processing portion 240 alternately detects a right foot running cycle and a left foot running cycle whenever the z axis acceleration (corresponding to an acceleration obtained when the user moves vertically) detected by the inertial measurement unit 10 becomes the maximum value which is equal to or greater than a predetermined threshold value. In other words, the running processing portion 240 outputs a timing signal indicating that a running cycle is detected, and a left-right foot flag (for example, an ON flag for the right foot, and an OFF flag for the left foot) indicating the corresponding running cycle, whenever the z axis acceleration detected by the inertial measurement unit 10 becomes the maximum value which is equal to or greater than the predetermined threshold value.

In the present embodiment, the running processing portion 240 performs a process of calculating a running velocity (a velocity in the advancing direction) by using the acceleration and the timing signal for the running cycle detected by the inertial measurement unit 10. For example, the running processing portion 240 may calculate an amplitude (a difference between the maximum value and the minimum value) (refer to FIG. 11) of the z axis acceleration in a period between the start of the running cycle and the start of the next running cycle, and may calculate a running velocity by using a correlation between the amplitude of the z axis acceleration and the running velocity, obtained through statistics or the like in advance.

The running processing portion 240 performs a process of calculating a stride for each of the left foot and right foot by using the running velocity, the timing signal for the running cycle, and the left-right foot flag in the same manner as in the first embodiment.

The running processing portion 240 performs a process of calculating a running pitch for each of the left foot and right foot by using the timing signal for the running cycle and the left-right foot flag in the same manner as in the first embodiment.

The error estimation portion 230 estimates an error of an index indicating a state of the user by using the velocity and/or the position, and the attitude angles calculated by the integral processing portion 220, the acceleration or the angular velocity corrected by the bias removing portion 210, the GPS data, and the like. In the same manner as in the first embodiment, as in the present embodiment, the error estimation portion 230 uses the velocity, the attitude angles, the acceleration, the angular velocity, and the position as indexes indicating a state of the user, and estimates errors of the indexes by using the extended Karman filter.

In the present embodiment, in a case where GPS data can be used (for example, right after the GPS data is updated until a predetermined period of time elapses), the error estimation portion 230 estimates an error assuming that the velocity v^{e}, the position p^{e}, or the yaw angle ψ_{be} calculated by the integral processing portion 220 is the same as a velocity, a position, or an azimuth angle (a velocity, a position, or an azimuth angle after being converted into the e frame) which is calculated by using GPS data. In other words, the observation vector Z is a difference between the two velocities, positions, or yaw angles, and the error estimation portion 230 corrects the state vector X according to the update formulae (5) so as to estimate an error.

In a case where GPS data cannot be used, the error estimation portion 230 estimates an error assuming that the velocity v^{e} calculated by the integral processing portion 220 is the same as the running velocity (a running velocity after being converted into the e frame) which is calculated by the running processing portion 240. In other words, the observation vector Z is a difference between the two velocities, and the error estimation portion 230 corrects the state vector X according to the update formulae (5) so as to estimate an error.

The inertial navigation calculation unit 22 outputs analysis data (stores the analysis data in the storage unit 30) including information regarding the velocities, the position, and the attitude angles having undergone the coordinate conversion in the coordinate conversion portion 250, and the left and right strides and the left and right running pitches, calculated by the running processing portion 240.

### 2-6. Advice Mode

In the present embodiment, the user inputs an analysis mode, a running distance, a target time, and the like before running.

As the analysis mode which is input (selected) by the user, a plurality of modes in which running purposes (an example of a purpose of a physical activity) are different from each other, specifically, five types of modes are defined which include a mode of aiming at fast running, a mode of aiming at efficient running (an example of a mode of aiming at improving efficiency of a physical activity), a mode of aiming at running for a long period of time without fatigue, a mode of aiming at a diet (an example of a mode of aiming at energy consumption in a physical activity), and a mode which does not require an advice. Hereinafter, the mode of aiming at fast running is referred to as a “fast running mode”; the mode of aiming at efficient running is referred to as an “efficient running mode”; the mode of aiming at running for a long period of time without fatigue is referred to as an “untired long running mode”; the mode of aiming at a diet is referred to as a “diet mode”; and a mode which does not require an advice is referred to as a “non-advice mode”.

The running distance which is input (selected) by the user is any one of, for example, 50 m, 100 m, 200 m, 400 m, 800 m, 1500 m, 3000 m, 5 km, 10 km, and 20 km, and a “short distance”, a “middle distance”, and a “long distance” are defined as the type of running in correlation with the running distance input (selected) by the user. For example, if a running distance input (selected) by the user is any one of 50 m, 100 m, 200 m, and 400 m (or 400 m or shorter), this corresponds to a “short distance”; if a running distance is any one of 800 m, 1500 m, and 3000 m (or above 400 m and 3000 m or shorter), this corresponds to a “middle distance”; and if a running distance is any one of 5 km, 10 km, and 20 km (or 3 km or longer), this corresponds to a “long distance”.

Alternatively, the user may input any distance as a running distance. In this case, for example, in a case where a running distance input by the user is 400 m or shorter, this may correspond to the “short distance”; in a case where a running distance is longer than 400 m and is equal to or shorter than 3000 m, this may correspond to the “middle distance”; and in a case where a running distance is longer than 3 km, this may correspond to the “long distance”. Alternatively, the user may directly input (select) any one of the “short distance”, the “middle distance”, and the “long distance”.

In the present embodiment, a plurality of advice modes are defined according to a combination of the analysis mode and the type of running. The exercise analysis unit 24 changes an item for determination depending on an advice mode among six types of items such as a running velocity, a running pitch, a stride, vertical movement, left and right deviations, and forward tilt, and generates advice information on the basis of a determination result.

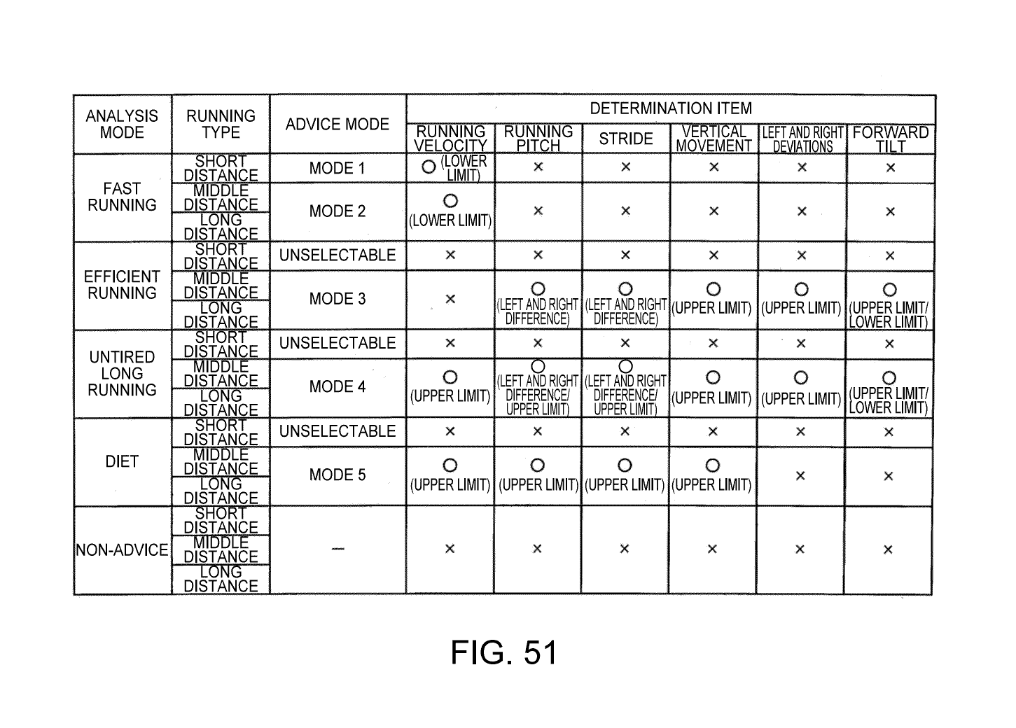

FIG. 51 is a table showing a correspondence relationship between an analysis mode, the type of running, an advice mode, and a determination item in the present embodiment. However, as a correspondence relationship between an analysis mode, the type of running, an advice mode, and a determination item, other correspondence relationships may be employed.

In the example illustrated in FIG. 51, in a case where the “efficient running mode”, the “untired long running mode”, or the “diet mode” is selected, the “short distance” cannot be selected.

In a case where the “fast running mode” is selected, and the “short distance” is also selected, the advice mode is a mode 1, and it is determined whether or not a running velocity is too low (smaller than a lower limit threshold value) in the mode 1. The lower limit threshold value of the running velocity is defined by using a running velocity which is computed on the basis of a distance and a target time which are input (selected) by the user.

In a case where the “fast running mode” is selected, and the “middle distance” or the “long distance” is also selected, the advice mode is a mode 2, and it is determined whether or not a running velocity is too low (smaller than a lower limit threshold value) in the mode 2. The lower limit threshold value of the running velocity is defined by using a running velocity which is computed on the basis of a distance and a target time which are input (selected) by the user. The mode 1 and the mode 2 are different from each other in terms of a method of presenting advice information as will be described later.

In a case where the “efficient running mode” is selected, and the “middle distance” or the “long distance” is also selected, the advice mode is a mode 3, and, in the mode 3, it is determined whether or not a difference between left and right running pitches is too great (greater than an upper limit threshold value), whether or not a difference between left and right strides is too great (greater than an upper limit threshold value), whether or not vertical movement is too considerable (greater than an upper limit threshold value), whether or not left and right deviations are too great (greater than an upper limit threshold value), and whether or not a forward tilt or backward tilt is too great (greater than an upper limit threshold value or smaller than a lower limit threshold value). Each threshold value is set to an appropriate reference value which is set in advance, and the respective threshold values may be changed with each other between the middle distance and the long distance.

In a case where the “untired long running mode” is selected, and the “middle distance” or the “long distance” is also selected, the advice mode is a mode 4, and, in the mode 4, the same determination as in the mode 3 is performed (each threshold value is changed), and further it is determined whether or not a running velocity is too high (greater than an upper limit threshold value), whether or not a running pitch is too high (greater than an upper limit threshold value), and whether or not a stride is too wide (greater than an upper limit threshold value). Each threshold value is set to an appropriate reference value which is set in advance, and the respective threshold values may be changed with each other between the middle distance and the long distance.

In a case where the “diet mode” is selected, and the “middle distance” or the “long distance” is also selected, the advice mode is a mode 5, and, in the mode 5, it is determined whether or not a running velocity is too high (greater than an upper limit threshold value), whether or not a running pitch is too high (greater than an upper limit threshold value), whether or not a stride is too wide (greater than an upper limit threshold value), and whether or not vertical movement is too considerable (greater than an upper limit threshold value). Each threshold value is set to an appropriate reference value which is set in advance, and the respective threshold values may be changed with each other between the middle distance and the long distance.

In a case where the “non-advice mode” is selected, even if any one of the “short distance”, the “middle distance”, and the “long distance” is selected, transition to the advice mode does not occur, and none of the running velocity, the running pitch, the stride, and the vertical movement, the left and right deviations, and the forward tilt are determined. In this case, an advice is not presented to the user during running.

The user may select any advice mode from a plurality of advice modes in which a determination item is set, on the basis of an analysis mode (a purpose of running) and the type of running (a running distance).

### 2-7. Functional Configuration of Exercise Analysis Unit

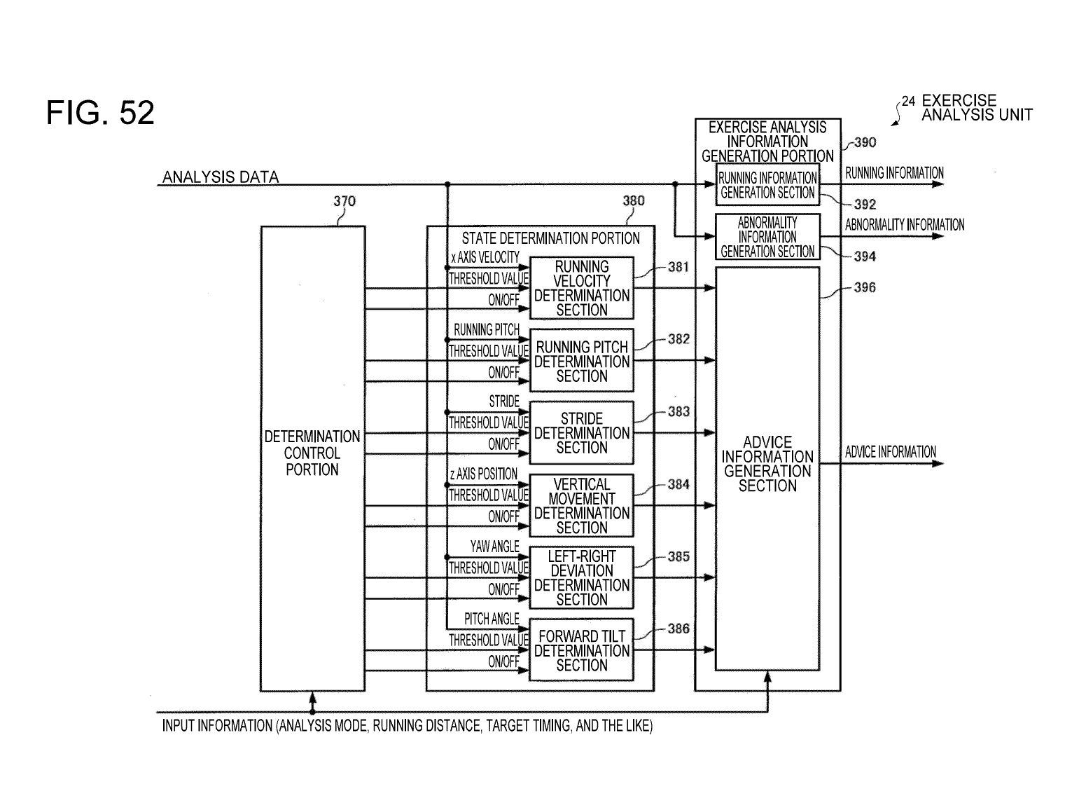

FIG. 52 is a functional block diagram illustrating a configuration example of the exercise analysis unit 24 in the second embodiment. In the present embodiment, the exercise analysis unit 24 includes a determination control portion 370, a state determination portion 380, and an exercise analysis information generation portion 390. However, the exercise analysis unit 24 of the present embodiment may have a configuration in which some of the constituent elements are deleted or changed, or other constituent elements may be added thereto.

The determination control portion 370 determines whether the type of running corresponds to any one of the “short distance”, the “middle distance”, and the “long distance” on the basis of a value of a running distance included in information input by the user, and selects an advice mode according to the table illustrated in FIG. 51 on the basis of the type of running and information regarding an analysis mode included in the input information. On the basis of the advice mode selected according to the table illustrated in FIG. 51, the determination control portion 370 generates respective control signals for controlling ON and OFF of determinations (whether or not each determination is performed) such as a determination of a running velocity, a determination of a running pitch, a determination of a stride, a determination of vertical movement, a determination of left and right deviations, and a determination of forward tilt, performed by the state determination portion 380 (O indicates ON, and X indicates OFF in FIG. 51).

In a case where the advice mode is any one of the mode 3, the mode 4, and the mode 5, the determination control portion 370 sets an upper limit threshold value of each of a right foot running cycle and a left foot running cycle, an upper limit threshold value of a difference between the right foot running pitch and the left foot running pitch, an upper limit threshold value of each of a right foot stride and a left foot stride, an upper limit threshold value of a difference between the right foot stride and the left foot stride, and an upper limit threshold value of vertical movement to appropriate reference values which are predefined for each advice mode. However, in a case where the advice mode is the mode 3, the determination control portion 370 sets the upper limit threshold value of each of the right foot running pitch and the left foot running pitch, and the upper limit threshold value of each of the right foot stride and the left foot stride to extremely high values (and thus a determination of an upper limit of each of the left and right running pitches and a determination of an upper limit of each of the left and right strides are not performed). In a case where the advice mode is the mode 5, the determination control portion 370 sets the upper limit threshold value of the difference between the right foot running pitch and the left foot running pitch, and the upper limit threshold value of the difference between the right foot stride and the left foot stride, to extremely high values (and thus a determination of a difference between the left and right running pitches and a determination of a difference between the left and right strides are not performed). In a case where the advice mode is the mode 3 or the mode 4, the determination control portion 370 further sets the upper limit threshold value of the left and right deviations, and the upper limit threshold value and a lower limit threshold value of the forward tilt to appropriate references which are predefined for each advice mode.

In a case where the advice mode is any one of the mode 1, the mode 2, the mode 4, and the mode 5, the determination control portion 370 computes an average running velocity by dividing the value of the running distance included in the input information by a value of the target time. In the mode 1 or the mode 2, the determination control portion 370 computes and sets a lower limit threshold value of the running velocity on the basis of the average running velocity, and sets, for example, an extremely high value as an upper limit threshold value thereof (and thus a determination of an upper limit is not performed). In the mode 4 or the mode 5, the determination control portion 370 computes and sets an upper limit threshold value of the running velocity on the basis of the average running velocity, and sets, for example, 0 or a negative value as a lower limit threshold value thereof (and thus a determination of a lower limit is not performed).

The state determination portion 380 (an example of a determination unit) includes a running velocity determination section 381, a running pitch determination section 382, a stride determination section 383, a vertical movement determination section 384, a left-right deviation determination section 385, and a forward tilt determination section 386, and determines whether or not a running state satisfies a predetermined condition which corresponds to a selected advice mode and is correlated with the running state, especially, a condition corresponding to a state in which the running state is worse than a reference state. However, the state determination portion 380 may determine whether or not a running state satisfies a condition which corresponds to a selected advice mode and corresponds to a state in which the running state is better than a reference state.

In a case where the advice mode is any one of the mode 1, the mode 2, the mode 4, and the mode 5, the running velocity determination section 381 is turned on, and determines whether or not a velocity in the x axis direction (advancing direction) of the m frame included in the analysis data, that is, a running velocity is higher than an upper limit threshold value, and whether or not the running velocity is lower than a lower limit threshold value. In the mode 1 or the mode 2, an upper limit threshold value of the running velocity is set to an extremely high value, and thus the running velocity determination section 381 does not substantially determine an upper limit of the running velocity. In the mode 4 or the mode 5, a lower limit threshold value of the running velocity is set to 0 or a negative value, and thus the running velocity determination section 381 does not determine a lower limit of the running velocity.

In a case where the advice mode is any one of the mode 3, the mode 4, and the mode 5, the running pitch determination section 382 determines whether or not each of the right foot running pitch and the left foot running pitch included in the analysis data exceeds an upper limit threshold value and whether or not a difference between the right foot running pitch and the left foot running pitch exceeds an upper limit threshold value. In the mode 3, the upper limit threshold value of each of the right foot running pitch and the left foot running pitch is set to an extremely high value, and thus the running pitch determination section 382 does not substantially determine an upper limit of each of the left and right running pitches. In the mode 5, the upper limit threshold value of the difference between the right foot running pitch and the left foot running pitch is set to an extremely high value, and thus the running pitch determination section 382 does not substantially determine a difference between the left and right running pitches.

In a case where the advice mode is any one of the mode 3, the mode 4, and the mode 5, the stride determination section 383 determines whether or not each of the right foot stride and the left foot stride included in the analysis data exceeds an upper limit threshold value and whether or not a difference between the right foot stride and the left foot stride exceeds an upper limit threshold value. In the mode 3, the upper limit threshold value of each of the right foot stride and the left foot stride is set to an extremely high value, and thus the stride determination section 383 does not substantially determine an upper limit of each of the left and right strides. In the mode 5, the upper limit threshold value of the difference between the right foot stride and the left foot stride is set to an extremely high value, and thus the stride determination section 383 does not substantially determine a difference between the left and right strides.

In a case where the advice mode is any one of the mode 3, the mode 4, and the mode 5, the vertical movement determination section 384 is turned on, and determines whether or not a difference between the maximum value and the minimum value of a position in the z axis direction of the m frame included in the analysis data exceeds an upper limit threshold value.

In a case where the advice mode is the mode 3 or the mode 4, the left-right deviation determination section 385 is turned on, and determines whether or not a difference between the maximum value and the minimum value of a yaw angle of the m frame included in the analysis data exceeds an upper limit threshold value.

In a case where the advice mode is the mode 3 or the mode 4, the forward tilt determination section 386 is turned on, and determines whether or not an average value of a pitch angle of the m frame included in the analysis data is greater than an upper limit threshold value, and whether or not the average value of the pitch angle is smaller than a lower limit threshold value.

The exercise analysis information generation portion 390 includes a running information generation section 392, an abnormality information generation section 394, and an advice information generation section 396, and generates exercise analysis information including running information, abnormality information, and advice information.

The running information generation section 392 generates running information including information regarding a running velocity, a running distance, a running time, and the like, by using the analysis data. The running information generation section 392 may compute an average value of a running velocity, and may generate running information including the computed average running velocity. The running information is transmitted to the display apparatus 3, and, for example, respective values of the running velocity, the running distance, the running time are displayed on the display unit 170, or sound with a tempo, a length, or a volume corresponding to the running velocity, or music corresponding to the running velocity is output from the sound output unit 180. Particularly, in a case of the short distance, it is hard for the user to perform running while recognizing the running information displayed on the display unit 170, and thus it is effective to present the running information with sound.

The abnormality information generation section 394 determines whether or not a running state or analysis data is abnormal by using the analysis data, and generates and outputs abnormality information indicating that the running state or the analysis data is abnormal if it is determined that the running state or the analysis data is abnormal. For example, the abnormality information generation section 394 may determine whether or not the user abnormally runs unsteadily on the basis of time-variable information of a velocity, a position, or attitude angles (a roll angle, a pitch angle, and a yaw angle) of the m frame included in the analysis data, and may determine whether or not the user abnormally continuously runs too hard on the basis of time-variable information of a running pitch or a stride. For example, in a case where the analysis data shows a numerical value which cannot be expected in normal times, the abnormality information generation section 394 may determine whether or not the analysis data is abnormal. This determination is performed by comparing a predefined numerical value range as a normal value of each item with a calculated value of the analysis data. For example, the abnormality information generation section 394 may compare sensing data (a determination result in the inertial measurement unit 10) with an upper limit value and a lower limit value within a defined normal range, may determine that the inertial measurement unit 10 fails if the sensing data is not included in the normal range and may thus determine that the analysis data is abnormal. The abnormality information is transmitted to the display apparatus 3. For example, voice such as the content that “you are abnormally running unsteadily; stop running” or “the measurement device fails” is output from the sound output unit 180, or a warning sound is output from the sound output unit 180 (or the vibration unit 190 vibrates), and a message such as the content that “you are abnormally running unsteadily; stop running” or “the measurement device fails” is displayed on the display unit 170.

The advice information generation section 396 (an example of an advice information output unit) generates and outputs advice information for sending a notification of a running state on the basis of a determination result from the state determination portion 380.

Specifically, in a case where it is determined by the running velocity determination section 381 that a running velocity is lower than a lower limit threshold value, the advice information generation section 396 generates advice information including information indicating that the running velocity is low. The advice information is generated when the advice mode is the mode 1 or the mode 2 and is transmitted to the display apparatus 3. In the mode 1, for example, predetermined sound, or voice such as the content that “your velocity is low” is output from the sound output unit 180. In the mode 2, for example, voice such as the content that “your velocity is low” is output from the sound output unit 180, or a warning sound is output from the sound output unit 180 (or the vibration unit 190 vibrates) and a message such as “! low velocity” is displayed on the display unit 170.

In a case where it is determined by the running velocity determination section 381 that a running velocity is higher than an upper limit threshold value, the advice information generation section 396 generates advice information including information indicating that the running velocity is too high. The advice information is generated when the advice mode is the mode 4 or the mode 5 and is transmitted to the display apparatus 3. For example, voice such as the content that “your velocity is too high” is output from the sound output unit 180, or a warning sound is output from the sound output unit 180 (or the vibration unit 190 vibrates) and a message such as “! high velocity” is displayed on the display unit 170.

In a case where it is determined by the running pitch determination section 382 that a right foot running pitch or a left foot running pitch exceeds an upper limit threshold value, the advice information generation section 396 generates advice information including information indicating that the running pitch is too high. The advice information is generated when the advice mode is the mode 4 or the mode 5 and is transmitted to the display apparatus 3. For example, voice such as the content that “your pitch is too high” is output from the sound output unit 180, or a warning sound is output from the sound output unit 180 (or the vibration unit 190 vibrates) and a message such as “! high pitch” is displayed on the display unit 170.

In a case where it is determined by the running pitch determination section 382 that a difference between the right foot running pitch and the left foot running pitch exceeds an upper limit threshold value, the advice information generation section 396 generates advice information including information indicating that the difference between the left and right running pitches is great. The advice information is generated when the advice mode is the mode 3 or the mode 4 and is transmitted to the display apparatus 3. For example, voice such as the content that “the pitches of the right foot and the left foot are greatly different from each other” is output from the sound output unit 180, or a warning sound is output from the sound output unit 180 (or the vibration unit 190 vibrates) and a message such as “! great difference between the left and right pitches” is displayed on the display unit 170.

In a case where it is determined by the stride determination section 383 that a right foot stride or a left foot stride exceeds an upper limit threshold value, the advice information generation section 396 generates advice information including information indicating that the stride is too wide. The advice information is generated when the advice mode is the mode 4 or the mode 5 and is transmitted to the display apparatus 3. For example, voice such as the content that “the stride is too wide” is output from the sound output unit 180, or a warning sound is output from the sound output unit 180 (or the vibration unit 190 vibrates) and a message such as “! wide stride” is displayed on the display unit 170.

In a case where it is determined by the stride determination section 383 that a difference between the right foot stride and the left foot stride exceeds an upper limit threshold value, the advice information generation section 396 generates advice information including information indicating that the difference between the left and right strides is great. The advice information is generated when the advice mode is the mode 3 or the mode 4 and is transmitted to the display apparatus 3. For example, voice such as the content that “the strides of the right foot and the left foot are greatly different from each other” is output from the sound output unit 180, or a warning sound is output from the sound output unit 180 (or the vibration unit 190 vibrates) and a message such as “! great difference between the left and right strides” is displayed on the display unit 170.

In a case where it is determined by the vertical movement determination section 384 that a difference between the maximum value and the minimum value of a position in the z axis direction exceeds an upper limit threshold value, the advice information generation section 396 generates advice information including information indicating that vertical movement is considerable. The advice information is generated when the advice mode is the mode 3, the mode 4, or the mode 5 and is transmitted to the display apparatus 3. For example, voice such as the content that “the vertical movement is considerable” is output from the sound output unit 180, or a warning sound is output from the sound output unit 180 (or the vibration unit 190 vibrates) and a message such as “! considerable vertical movement” is displayed on the display unit 170.

In a case where it is determined by the left-right deviation determination section 385 that a difference between the maximum value and the minimum value of a yaw angle exceeds an upper limit threshold value, the advice information generation section 396 generates advice information including information indicating that the left and right deviations are considerable. The advice information is generated when the advice mode is the mode 3 or the mode 4 and is transmitted to the display apparatus 3. For example, voice such as the content that “the left and right deviations are considerable” is output from the sound output unit 180, or a warning sound is output from the sound output unit 180 (or the vibration unit 190 vibrates) and a message such as “! considerable left and right deviations” is displayed on the display unit 170.

In a case where it is determined by the forward tilt determination section 386 that an average value of a pitch angle is higher than an upper limit threshold value or is lower than a lower limit threshold value, the advice information generation section 396 generates advice information including information indicating that the forward tilt is considerable or the backward tilt is considerable. The advice information is generated when the advice mode is the mode 3 or the mode 4 and is transmitted to the display apparatus 3. For example, voice such as the content that “the forward tilt is considerable” or “the backward tilt is considerable” is output from the sound output unit 180, or a warning sound is output from the sound output unit 180 (or the vibration unit 190 vibrates) and a message such as “! forward tilt attitude” or “! backward tilt attitude” is displayed on the display unit 170.

In a case where the “non-advice mode” is selected by the user, the state determination portion 380 does not operate, and thus the advice information generation section 396 does not generate message information. In this case, advice voice is not output from the sound output unit 180 of the display apparatus 3, and running information is displayed but message information is not displayed on the display unit 170.

The running information, the abnormality information, and the advice information may be displayed together on the display unit 170 of the display apparatus 3, and, for example, the abnormality information or the advice information may be preferentially displayed, and the running information may be displayed when there is no abnormality information or advice information.

### 2-8. Procedures of Process

FIG. 53 is a flowchart illustrating an example (an example of a physical activity assisting method) of the running assisting process performed by the processing unit 20 of the physical activity assisting apparatus 2A during the user's running. The processing unit 20 of the physical activity assisting apparatus 2A (an example of a computer) performs the running assisting process according to the procedures of the flowchart illustrated in FIG. 53 by executing the running assisting program 301 stored in the storage unit 30.

As illustrated in FIG. 53, the processing unit 20 waits for input information (an analysis mode, a running distance, and a target time) which is input by the user operating the display apparatus 3, to be received (N in step S10). If the input information is received (Y in step S10), the processing unit 20 waits a measurement start command to be received (N in step S20).

If the measurement start command is received (Y in step S20), first, the processing unit 20 computes an initial attitude, an initial position, and an initial bias by using sensing data and GPS data measured by the inertial measurement unit 10 assuming that the user stops (step S30).

Next, the processing unit 20 acquires the sensing data from the inertial measurement unit 10, and adds the acquired sensing data to the sensing data table 310 (step S40).

Next, the processing unit 20 performs an inertial navigation calculation process so as to generate analysis data including various information pieces (step S50). An example of procedures of the inertial navigation calculation process will be described later.

Next, the processing unit 20 performs an exercise analysis process by using the analysis data generated in step S50 so as to generate exercise analysis information (running information, advice information, warning information, and the like), and transmits the exercise analysis information to the display apparatus 3 (step S60). An example of procedures of the exercise analysis process will be described later. The exercise analysis information transmitted to the display apparatus 3 is fed back in real time during the user's running.

The processing unit 20 repeatedly performs the processes in step S40 and the subsequent steps whenever the sampling cycle Δt elapses (Y in step S70) from the acquisition of the previous sensing data until a measurement stop command is received (N in step S70 and N in step S80). If the measurement stop command is received (Y in step S80), the processing unit 20 finishes the running assisting process.

FIG. 54 is a flowchart illustrating an example of procedures of the inertial navigation calculation process (the process in step S50 of FIG. 53) in the second embodiment. The processing unit 20 (the inertial navigation calculation unit 22) performs the inertial navigation calculation process according to the procedures of the flowchart illustrated in FIG. 54 by executing the inertial navigation calculation program 302 stored in the storage unit 30.

As illustrated in FIG. 54, first, the processing unit 20 removes biases from acceleration and angular velocity included in the sensing data acquired in step S40 of FIG. 53 by using the initial bias calculated in step S30 of FIG. 53 (by using the acceleration bias bₐ and an angular velocity bias b_{ω} after the acceleration bias bₐ and the angular velocity bias b_{ω} are estimated in step S130) so as to correct the acceleration and the angular velocity, and updates the sensing data table 310 by using the corrected acceleration and velocity (step S100).

Next, the processing unit 20 integrates the sensing data corrected in step S100 so as to compute a velocity, a position, and an attitude angle, and adds calculated data including the computed velocity, position, and attitude angle to the calculated data table 340 (step S110).

Next, the processing unit 20 performs a running process (step S120) so as to calculate a running velocity, left and right strides, and left and right running pitches. An example of procedures of the running process will be described later.

Next, the processing unit 20 performs an error estimation process by using GPS data or the running velocity calculated through the running process (step S120), so as to estimate a velocity error δv^{e}, an attitude angle errors ε^{e}, a acceleration bias bₐ, an angular velocity bias b_{ω}, and a position error δp^{e} (step S130).

Next, the processing unit 20 corrects the velocity, the position, and the attitude angle by using the velocity error δv^{e}, the attitude angle errors ε^{e}, and the position error δp^{e} estimated in step S130, and updates the calculated data table 340 by using the corrected velocity, position and attitude angle (step S140).

Next, the processing unit 20 performs coordinate-converts the calculated data (the velocity, the position, and the attitude angle of the e frame) stored in the calculated data table 340, into a velocity, a position, and an attitude angle of the m frame, respectively (step S150).

The processing unit 20 generates analysis data including the velocity, the position, and the attitude angle of the m frame having undergone the coordinate conversion in step S150, and the left and right strides and the left and right running pitches calculated in step S120 (step S160). The processing unit 20 performs the inertial navigation calculation process (the processes in steps S100 to S160) whenever sensing data is acquired in step S40 of FIG. 53.

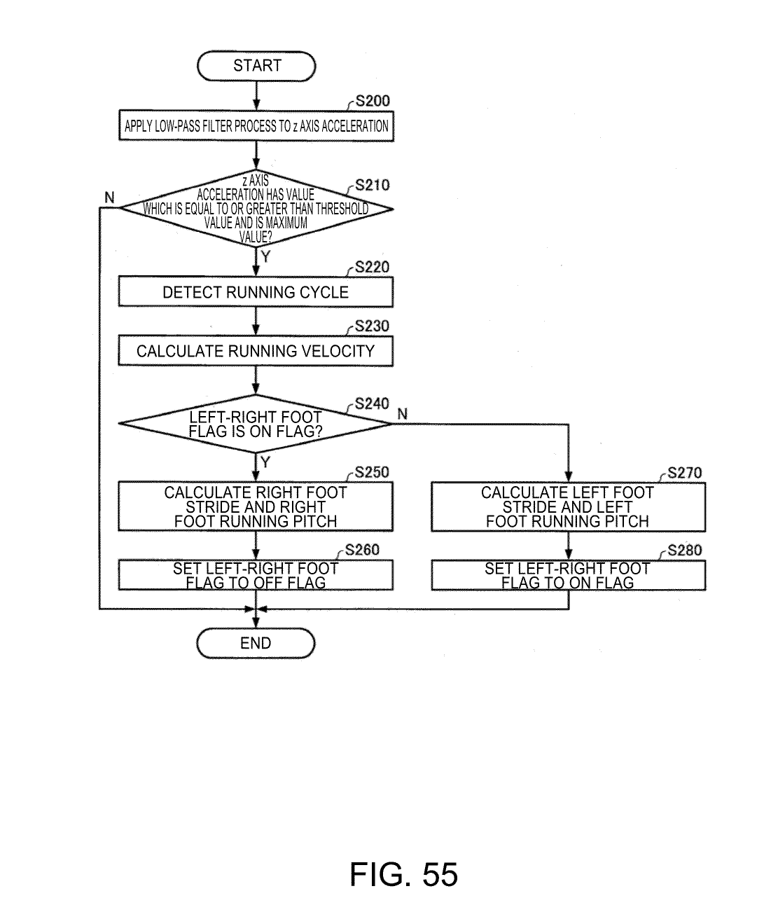

FIG. 55 is a flowchart illustrating an example of procedures of the running process (the process in step S120 of FIG. 54). The processing unit 20 (the running processing portion 240) performs the running process according to the procedures of the flowchart illustrated in FIG. 55.

As illustrated in FIG. 55, the processing unit 20 performs a low-pass filter process on a z axis acceleration included in the acceleration corrected in step S100 of FIG. 54 (step S200) so as to remove noise therefrom.

Next, if the z axis acceleration having undergone the low-pass filter process in step S200 has a value which is equal to or greater than a threshold value and is the maximum value (Y in step S210), the processing unit 20 detects a running cycle at this timing (step S220) and calculates a running velocity (step S230).

If a left-right foot flag is an ON flag (Y in step S240), the processing unit 20 calculates a right foot stride and a right foot running pitch (step S250), sets the left-right foot flag to an OFF flag (step S260), and finishes the running process. If the left-right foot flag is not an ON flag (N in step S240), the processing unit 20 calculates a left foot stride and a left foot running pitch (step S270), sets the left-right foot flag to an ON flag (step S280), and finishes the running process. If the z axis acceleration has a value which is smaller than the threshold value or is not the maximum value (N in step S210), the processing unit 20 does not perform the processes in steps S220 and the subsequent steps and finishes the running process.

FIG. 56 is a flowchart illustrating an example of procedures of the exercise analysis process (the process in step S60 of FIG. 53) in the second embodiment. The processing unit 20 (the exercise analysis unit 24) performs the exercise analysis process according to the procedures of the flowchart illustrated in FIG. 56 by executing the exercise analysis program 305 stored in the storage unit 30.

As illustrated in FIG. 56, first, the processing unit 20 calculates running information (a running velocity, a running distance, a running time, and the like) by using the analysis data generated through the inertial navigation calculation process of the step S50 of FIG. 53 (step S300).

Next, the processing unit 20 selects an advice mode by using the analysis mode and the running distance included in the input information (step S310).

Next, the processing unit 20 selects a determination item according to the advice mode selected in step S310, and determines whether or not each selected determination item satisfies a predetermined condition (whether or not a value of each determination item is greater than an upper limit threshold value or whether or not the value of each determination item is smaller than a lower limit threshold value) (step S320).

If at least one determination item satisfies the predetermined condition (Y in step S330), the processing unit 20 generates advice information regarding each determination item satisfying the predetermined condition (step S340). If none of the determination items satisfy the predetermined condition (N in step S330), the processing unit 20 does not perform the advice information generation process (step S340).

Next, the processing unit 20 determines whether or not a running state of the user or analysis data is abnormal by using the analysis data (step S350). If it is determined that the running state of the user or the analysis data is abnormal (Y in step S360), the processing unit 20 generates abnormality information (step S370), and if it is determined that the running state of the user or the analysis data is not abnormal (N in step S360), the processing unit 20 does not generate abnormality information.

Next, the processing unit 20 transmits at least some exercise analysis information including the running information generated in step S300, the advice information generated in step S340, and the abnormality information generated in step S370, to the display apparatus 3 (step S380). For example, in a case where the abnormality information is generated (Y in step S360), the processing unit 20 does not transmit the running information and the advice information to the display apparatus 3 but transmits the abnormality information thereto. In a case where the abnormality information is not generated (N in step S360), the running information and the advice information may be transmitted to the display apparatus 3. For example, the processing unit 20 may transmit the running information and the advice information to the display apparatus 3 regardless of whether or not the abnormality information is generated, and may further transmit the abnormality information to the display apparatus 3 if the abnormality information is generated. The processing unit 20 performs the exercise analysis process (steps S300 to S380) whenever sensing data is acquired in step S40 of FIG. 53.

### 2-9. Effects

In the second embodiment, the physical activity assisting apparatus 2A determines an item corresponding to an advice mode which is selected on the basis of information input by the user during the user's running, among the running velocity, the running pitch, the stride, the vertical movement, the left and right deviations, and the forward tilt. The physical activity assisting apparatus 2A generates advice information regarding an item (an item worse than a reference) satisfying a predetermined condition among determination items, and presents the item to the running user via the display apparatus 3. Therefore, the running user can easily understand a method of improving a corresponding item by utilizing the presented information, and thus it is possible to effectively assist the user's running.

Particularly, in the second embodiment, the user can input (select) any one of the “short distance”, the “middle distance”, and the “long distance”, and any one of the “fast running mode”, the “efficient running mode”, the “untired long running mode”, the “diet mode”, and the “non-advice mode”. The physical activity assisting apparatus 2A can select an advice mode corresponding to the user's input (selection) and can present effective advice information which is suitable for the type and a purpose of the user's running.

In the second embodiment, in a case where a running state of the user or analysis data is abnormal during the user's running, the physical activity assisting apparatus 2A generates abnormality information indicating that the running state of the user or the analysis data is abnormal and presents the abnormality information to the running user via the display apparatus 3. Therefore, for example, the user can stop running by taking a break at an appropriate timing, or can perform running without depending on wrong information.

### 3. Modification Examples

The invention is not limited to the above-described respective embodiments, and may be variously modified within the scope of the invention. Hereinafter, modification examples will be described. The same constituent elements as those in the respective embodiments are given the same reference numerals, and repeated description will be omitted.

### 3-1. Sensors

In the above-described respective embodiments, the acceleration sensor 12 and the angular velocity sensor 14 are integrally formed as the inertial measurement unit 10 and are built into the exercise analysis apparatus 2 or the physical activity assisting apparatus 2A, but the acceleration sensor 12 and the angular velocity sensor 14 may not be integrally formed. Alternatively, the acceleration sensor 12 and the angular velocity sensor 14 may not be built into the exercise analysis apparatus 2 or the physical activity assisting apparatus 2A, and may be directly mounted on the user. In either case, for example, a sensor coordinate system of one sensor may be set to the b frame of the embodiments, the other sensor coordinate system may be converted into the b frame, and the embodiments may be applied thereto.

In the above-described respective embodiments, a part of which the sensor (the exercise analysis apparatus 2 or the physical activity assisting apparatus 2A (the IMU 10)) is mounted on the user has been described to be the waist, but the sensor may be mounted on parts other than the waist. A preferable mounting part is the user's trunk (parts other than the limbs). However, a mounting part is not limited to the trunk, and may be mounted on, for example, the user's head or leg other than the arms. The number of sensors is not limited to one, and additional sensors may be mounted on other parts of the body. For example, the sensors may be mounted on the waist and the leg, or the waist and the arm.

In the second embodiment, the physical activity assisting apparatus 2A includes the acceleration sensor 12, the angular velocity sensor 14, and the GPS unit 50 as sensors used to generate information for assisting the user's running, but may includes other sensors, for example, a geomagnetic sensor, a pressure sensor, and a heart rate sensor.

### 3-2. Inertial Navigation Calculation

In the above-described respective embodiments, the integral processing portion 220 calculates a velocity, a position, and an attitude angle, of the e frame, and the coordinate conversion portion 250 coordinate-converts the parameters into a velocity, a position, and an attitude angle of the m frame, but the integral processing portion 220 may calculate a velocity, a position, and an attitude angle of the m frame. In this case, the exercise analysis unit 24 preferably performs an exercise analysis process by using the velocity, the position, and the attitude angle of the m frame calculated by the integral processing portion 220, and thus coordinate conversion of a velocity, a position, and an attitude angle in the coordinate conversion portion 250 is not necessary. The error estimation portion 230 may estimate an error by using the extended Karman filter on the basis of the velocity, the position, and the attitude angle of the m frame.

In the above-described respective embodiments, the inertial navigation calculation unit 22 performs a part of the inertial navigation calculation (for example, an error estimation process) by using a signal from a GPS satellite, but may use a signal from a positioning satellite of a global navigation satellite system (GNSS) other than the GPS, or a positioning satellite other than the GNSS. For example, one, or two or more satellite positioning systems such as a wide area augmentation system (WAAS), a quasi zenith satellite system (QZSS), a global navigation satellite system (GLONASS), GALILEO, a Beidou navigation satellite system (BeiDou) may be used. An indoor messaging system (IMES) may also be used.

In the above-described respective embodiments, the running processing portion 240 (particularly, in the first embodiment, the running detection section 242) detects a running cycle at a timing at which a vertical acceleration (z axis acceleration) of the user becomes the maximum value which is equal to or greater than a threshold value, but the detection of a running cycle is not limited thereto, and, for example, a running cycle may be detected at a timing at which the vertical acceleration (z axis acceleration) changes from a positive value to a negative value (or a timing changes from a negative value to a positive value). Alternatively, the running processing portion 240 may integrate the vertical acceleration (z axis acceleration) so as to calculate a vertical velocity (z axis velocity), and may detect a running cycle by using the calculated vertical velocity (z axis velocity). In this case, the running processing portion 240 may detect a running cycle at a timing at which, for example, the velocity crosses a threshold value around a median value between the maximum value and the minimum value by increasing or decreasing a value. For example, the running processing portion 240 may calculate a combined acceleration of the x axis, y axis and z axis accelerations and may detect a running cycle by using the calculated combined acceleration. In this case, the running processing portion 240 may detect a running cycle at a timing at which, for example, the combined acceleration crosses a threshold value around a median value between the maximum value and the minimum value by increasing or decreasing a value.

In the above-described respective embodiments, the error estimation portion 230 uses a velocity, an attitude angle, an acceleration, an angular velocity, and a position as indexes indicating a user's state, and estimates errors of the indexes by using the extended Karman filter, but may estimate the errors thereof by using some of the velocity, the attitude angle, the acceleration, the angular velocity, and the position as indexes indicating a user's state. Alternatively, the error estimation portion 230 may estimate the errors thereof by using parameters (for example, a movement distance) other than the velocity, the attitude angle, the acceleration, the angular velocity, and the position as indexes indicating a user's state.

In the above-described respective embodiments, the extended Karman filter is used to estimate an error in the error estimation portion 230, but other estimation filters such as a particle filter or H∞ (H infinity) may be used.

### 3-3. Exercise Analysis

The exercise analysis information generated by the exercise analysis unit 24 may include items other than the items described in the first embodiment. For example, the exercise analysis information may include respective items such as “air-stay time”, a “ground contact distance”, and an “air-stay distance”. The air-stay time is computed as the air-stay time=(time per step−ground contact time). The ground contact distance is computed as the ground contact distance=(ground contact time×average velocity), (taking-off position−ground contact position), or (stride−air-stay distance). The air-stay distance is computed as the air-stay distance=(air-stay time×average velocity), (ground contact position−taking-off position), or (stride−ground contact distance). The exercise analysis information may include, for example, “air-stay time/ground contact time”, “ground contact time/time per step”, and, “air-stay time/time per step”.

For example, the exercise analysis information may include respective items such as “stride-to-height”, “vertical movement”, “waist movement distance”, “position of waist”, and “deviation of body”. The stride-to-height is computed by stride/height. The vertical movement is computed as the amplitude of a position of the waist (in the gravitational direction). The waist movement distance is computed as a movement distance between landing and taking-off. The position of the waist is computed as a displacement of a position of the waist with an upright stance as a reference. The deviation of the body is computed as a sum of an amount of change in an attitude, and the amount of change in an attitude is absolute values corresponding to three axes in a predetermined period, or an absolute value corresponding to any one of the three axes in a predetermined period. The predetermined period is, for example, time per step, a period between the start and the finish of running, or one minute.

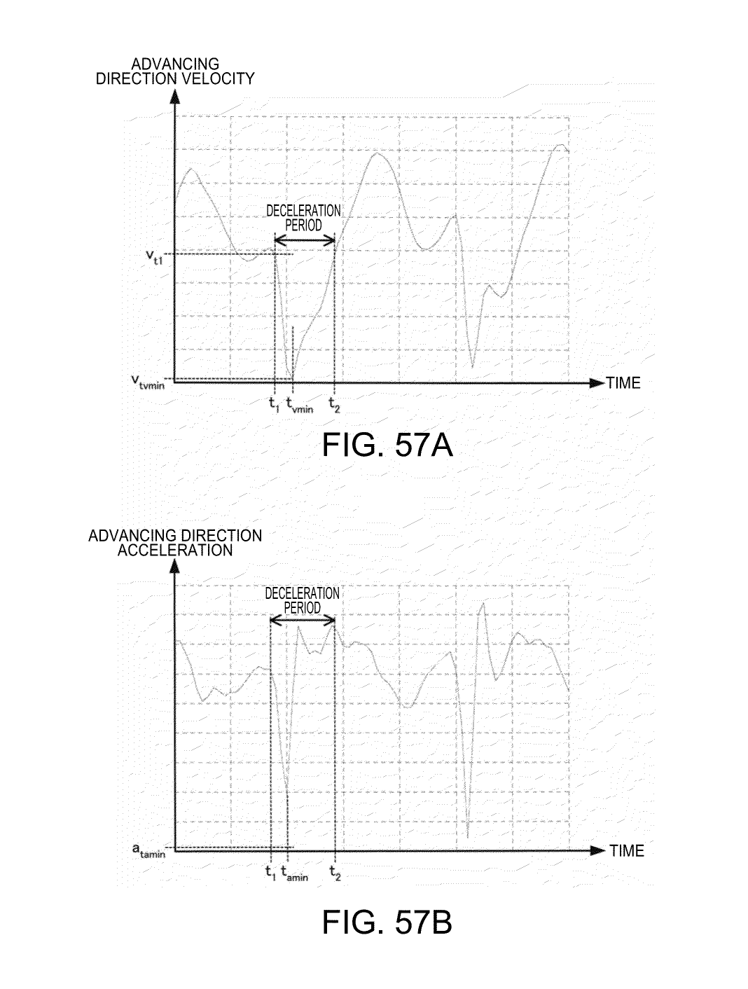

For example, the exercise analysis information may include an item such as a “deceleration amount”. A description will be made of an example of a method of computing the deceleration amount using an advancing direction velocity with reference to FIG. 57A. In FIG. 57A, a transverse axis expresses time, and a longitudinal axis expresses an advancing direction velocity. As illustrated in FIG. 57A, when a start time point (landing time point) of a deceleration period is denoted by t₁, a finish time point of the deceleration period is denoted by t₂, the advancing direction velocity is denoted by v, and a sampling cycle is denoted by Δt, the deceleration amount may be approximately computed according to Equation (7).

Deceleration Amount=∫ₜ_{₁}^{t}^{₂}vdt≈ΣvΔt (7)

### Deceleration Amount

Alternatively, when a start time point (landing time point) of a deceleration period is denoted by t₁, a finish time point of the deceleration period is denoted by t₂, a time point at which an advancing direction velocity is the minimum after landing is denoted by tᵥₘᵢₙ, an advancing direction velocity in landing is denoted by vₜ₁, an advancing direction velocity when the deceleration period finishes is denoted by vₜ₂, and the advancing direction lowest velocity after landing is denoted by vₜᵥₘᵢₙ, the deceleration amount may also be approximately computed according to Equation (8).

Deceleration Amount=∫ₜ_{₁}^{t}^{₂}vdt≈½(vₜᵥₘᵢₙ−vₜ₁)(tᵥₘᵢₙ−t₁)+½(vₜ₂−vₜᵥₘᵢₙ)(t₂−tᵥₘᵢₙ) (8)

Assuming that, in Equation (8), the first term of the right side is the same as the second term of the right side, the deceleration amount may also be approximately computed according to Equation (9).

Deceleration Amount≈(vₜᵥₘᵢₙ−vₜ₁)(tᵥₘᵢₙ−t₁) (9)

Alternatively, when a start time point (landing time point) of a deceleration period is denoted by t₁, a finish time point of the deceleration period is denoted by t₂, the number of data with the advancing direction velocity v between the time points t₁ and t₂ is denoted by N, and a sampling cycle is denoted by Δt, the deceleration amount may also be approximately computed according to Equation (10).

$$Deceleration Amount = {v}_{avg} Δ t \cdot N = \frac{\sum v}{N} Δ t \cdot N = \frac{\sum v}{N} ( {t}_{2} - {t}_{1} ) \qquad ( 10 )$$

A description will be made of an example of a method of computing the deceleration amount using an advancing direction acceleration with reference to FIG. 57B. In FIG. 57B, a transverse axis expresses time, and a longitudinal axis expresses an advancing direction acceleration. As illustrated in FIG. 57B, when a start time point (landing time point) of a deceleration period is denoted by t₁, a finish time point of the deceleration period is denoted by t₂, a time point at which an advancing direction acceleration is the minimum after landing is denoted by tₐₘᵢₙ, an advancing direction acceleration is denoted by a, and the advancing direction lowest acceleration after landing is denoted by aₜₐₘᵢₙ, the deceleration amount may also be approximately computed by using the advancing direction acceleration according to Equation (11) which is modified from Equation (9).

$$\begin{matrix}Deceleration Amount \approx ( {v}_{tvmin} - {v}_{t 1} ) ( {t}_{vmin} - {t}_{1} ) \\ = ( {\int }_{{t}_{1}}^{{t}_{vmin}} a d t ) ( {t}_{vmin} - {t}_{1} ) \\ \approx ( 2 {\int }_{{t}_{1}}^{{t}_{amin}} a d t ) ( {t}_{vmin} - {t}_{1} ) \\ = {a}_{tamin} ( {t}_{amin} - {t}_{1} ) ( {t}_{vmin} - {t}_{1} )\end{matrix} \qquad ( 11 )$$

In Equations (7) to (11), the deceleration amounts are all computed in terms of a distance (m), but the deceleration amount may be computed in terms of a velocity (m/s) (for example, an average value of the lowest velocity in a deceleration period, or an average velocity only in a deceleration period). For example, information such as the content that the entire average velocity of the user is 10 km/h, and information such as the content that the average velocity only in the deceleration period is 2 km/h are presented together, and thus the user can easily intuitively recognize to what extent the velocity decreases in landing.

In the above-described respective embodiments, for example, the user may wear a wrist watch type pulsimeter, or may wind a heart rate sensor on the chest with a belt so as to perform running, and the exercise analysis unit 24 may calculate a heart rate during the user's running as the first item of the exercise analysis information by using a value measured by the pulsimeter or the heart rate sensor.

In the second embodiment, the exercise analysis unit 24 (the abnormality information generation section 394) determines whether or not a running state of the user is abnormal on the basis of analysis data which is obtained through the inertial navigation calculation. However, for example, the user may wear a wrist watch type pulsimeter, or may wind a heart rate sensor on the chest with a belt so as to perform running, and the exercise analysis unit 24 may determine whether or not a running state of the user is abnormal on the basis of a value measured by the pulsimeter or the heart rate sensor.

In the above-described respective embodiments, an exercise in human running is an object of analysis, but the invention is not limited thereto, and is also applicable to exercise analysis in walking or running of a moving body such as an animal or a walking robot. The invention is not limited to running, and is applicable to various exercises (physical activities) such as climbing, trail running, skiing (including cross-country and ski jumping), snowboarding, swimming, bicycling, skating, golf, tennis, baseball, and rehabilitation. As an example, if the first embodiment is applied to skiing, it may be determined whether clear curving was performed or a ski board was deviated on the basis of a variation in the vertical acceleration when the ski board was pressed, and it may be determined whether or not there is a difference between the right foot and the left foot, or sliding performance may be determined on the basis of a trajectory of the variation in the vertical acceleration when the ski board is pressed and released. Alternatively, it may be determined whether or not a user can ski by analyzing to what extent a trajectory of the variation in the acceleration in the yaw direction is close to a sine wave, and it may be determined whether or not smooth sliding is performed by analyzing to what extent a trajectory of the variation in the acceleration in the roll direction is close to a sine wave.

In the first embodiment, the exercise analysis is performed separately for the left and right sides, but the exercise analysis may be performed without differentiating the left and right sides from each other. In this case, determination of the left foot and the right foot, or analysis using comparison between the left and right sides may be omitted.

In the second embodiment, the advice information is a message such as voice, text, or a symbol, but is not limited thereto, and may be, for example, videos of a virtual trainer who runs in an ideal pace or running way in order to run a running distance input by the user under a target time.

In the second embodiment, the exercise analysis unit 24 may determine whether or not the user can run a running distance included in input information under a target time, and may generate advice information (for example, a message such as the content that “impossible” and “the running velocity reaches 40 km/h”) if it is determined that the user cannot run the running distance.

In the second embodiment, the exercise analysis unit 24 may calculate a target running pitch on the basis of a running distance and a target time included in input information, and may output sound at a cycle corresponding to the target running pitch from the sound output unit 180 of the display apparatus 3. Alternatively, in the “fast running mode”, the exercise analysis unit 24 may output sound at a cycle which is shorter than the target running pitch from the sound output unit 180 of the display apparatus 3 in order to prompt the user to perform fast running.

In the second embodiment, the exercise analysis unit 24 generates advice information in a case where a running state of the user is worse than a reference, but may generate the advice information in a case where the running state of the user is better than the reference. The user can learn a better running way by utilizing such advice information.

In the second embodiment, the exercise analysis unit 24 performs the exercise analysis process during the user's running, but, along therewith, may present information regarding an analysis result to the user by performing detailed running analysis after finishing running by using analysis data which is stored in a time series in the storage unit 30 during running. For example, at short-distance running, the user cannot accurately recognize a lot of information during the user's running, and thus it is effective to provide detailed analysis information after the running is finished. The running analysis performed after the running is finished may not be performed by the physical activity assisting apparatus 2A. For example, the physical activity assisting apparatus 2A may transmit analysis data which is calculated during running and is stored in the storage unit 30, to an information apparatus such as a personal computer or a smart phone after the user finishes the running, and the information apparatus may perform analysis by using the analysis data and may output information regarding an analysis result to a display unit thereof or the like. Alternatively, the physical activity assisting apparatus 2A may transmit analysis data which is calculated and is stored during running, to an information apparatus such as a personal computer or a smart phone after the user finishes the running, and the information apparatus may transmit the received analysis data to a network server via a communication network such as the Internet. The network server may perform analysis by using the received analysis data and may transmit information regarding an analysis result to the information apparatus, and the information apparatus may receive the information regarding the analysis result and may output the information to the display unit thereof or the like. Alternatively, the physical activity assisting apparatus 2A may store analysis data which is calculated during running, in a recording medium such as a memory card, and an information apparatus such as a personal computer or a smart phone may read the analysis data from the memory card and may analyze the analysis data, or may transmit the analysis data to a network server.

### 3-4. Notification Process

In the above-described respective embodiments, the processing unit 20 transmits output information during running or exercise analysis information to the wrist watch type display apparatus 3, but is not limited thereto, and may transmit the output information during running or the exercise analysis information a portable apparatus (head mounted display (HMD)) other than the wrist watch type mounted on the user, an apparatus (which may be the exercise analysis apparatus 2 or the physical activity assisting apparatus 2A) mounted on the user's waist, or a portable apparatus (a smart phone or the like) which is not a mounting type apparatus, so that the information is presented (feedback) to the user. Alternatively, the processing unit 20 may transmit the output information during running or the exercise analysis information to a personal computer, a smart phone, or the like so that the information is presented (feedback) to people (a coach or the like) other than the user who is running.

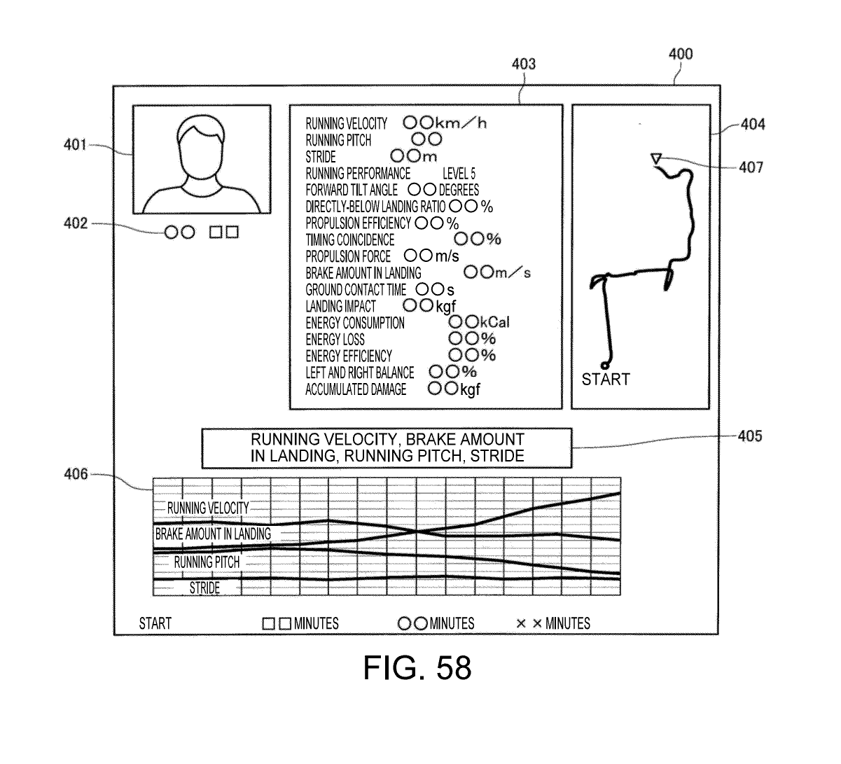

In a case where the output information during running is displayed on a head mounted display (HMD), a smart phone, or a personal computer, a display unit of such an apparatus is sufficiently larger than the display unit of the wrist watch type display apparatus 3, and thus the information illustrated in FIGS. 34A and 34B or other information can be displayed on the same screen. FIG. 58 illustrates an example of a screen displayed on a display unit of a head mounted display (HMD), a smart phone, or a personal computer during the user's running. In the example illustrated in FIG. 58, a screen 400 is displayed on the display unit. The screen 400 includes a user image 401 and a user name 402 which are registered in advance by the user, a summary image 403 displaying a running state of the user, a running path image 404 displaying a running path from the start hitherto, an item name 405 of an item selected by the user, and time-series data 406 thereof.

The summary image 403 includes respective numerical values of the “running velocity”, the “running pitch”, the “stride”, the “running performance”, the “forward tilt angle”, the “directly-below landing ratio”, the “propulsion efficiency”, the “timing coincidence”, the “propulsion force”, the “brake amount in landing”, the “ground contact time”, the “landing impact”, the “energy consumption”, the “energy loss”, the “energy efficiency”, the “left and right balance (left-right difference ratio)”, and the “accumulated damage (burden on the body)”, which are the respective items of the basic information, the first analysis information, and the second analysis information. Such numerical values are updated in real time during the user's running.

The summary image 403 may include numerical values of all the items of the basic information, the first analysis information, and the second analysis information, may include only some items selected by the user, and may include only items (for example, only an item within a reference range, or only an item out of a reference range) which satisfy a predetermined condition.

The running path image 404 is an image which displays a running path hitherto after the user starts running, and the present location is indicated by a predetermined mark 407.

The item name 405 indicates an item selected by the user from the items included in the summary image 403, and the time-series data 406 generates numerical values of the item indicated by the item name 405 as a graph in a time series. In the example illustrated in FIG. 58, the “running velocity”, the “running pitch”, the “brake amount in landing”, and the “stride” are selected, and a time-series graph is displayed in which a transverse axis expresses time from the start of running, and a longitudinal axis expresses a numerical value of the average energy efficiency.

For example, if the user wearing the head mounted display (HMD) performs running while viewing the screen as illustrated in FIG. 58, the user can check the present running state, and can continuously perform running while being aware of the running way of causing a numerical value of each item to become better or the running way of improving an item with a bad numerical value, or while objectively recognizing a fatigue state.

As feedback information using the head mounted display (HMD), not only the various information pieces described in the first embodiment, but also, for example, the present location may be displayed, and videos in which a virtual runner created on the basis of time performs running may be displayed. The time may be time set by the user, a record of the user, a record of a celebrity, a world record, or the like.

A feedback timing using the head mounted display (HMD) may be the same as the feedback timing described in the embodiments. A feedback method using the head mounted display (HMD) may be, for example, screen display such as easily understandable display with a still image, animation display, text display, or display on a map, or voice. Alternatively, information regarding a timing such as a waist rotation timing, a running pitch, or a kicking timing may be fed back in short sound such as “beep beep” or as an image.

Feedback information or feedback timing using the apparatus mounted on the user's waist may be the same as that in the first embodiment. As a feedback method using the apparatus mounted on the user's waist, information to be delivered may be fed back in voice; sound may be output in a case where all items are good; and sound may be output in a case where there is a bad item. Information regarding a good item may be fed back, and information regarding a bad item may be fed back. Alternatively, running performance or the like may be fed back by changing a musical scale according to a level thereof, and may be fed back by changing the number of types of sound such as “beep beep” for a predetermined period of time. Alternatively, information regarding a timing such as a waist rotation timing, a running pitch, or a kicking timing may be fed back in short sound such as “beep beep” or as an image.

Feedback information, a feedback timing, and a feedback method using the portable apparatus which is a mounting type apparatus may be the same as those in the first embodiment.

### 3-5. Running Analysis

In the first embodiment, the running analysis program 306 is executed by the exercise analysis apparatus 2 as a sub-routine of the exercise analysis program 300, but may be a program which is different from the exercise analysis program 300, and may not be executed by the exercise analysis apparatus 2. For example, the exercise analysis apparatus 2 may transmit exercise analysis information which is analyzed and generated during running, to an information apparatus such as a personal computer or a smart phone after the user's running, and the information apparatus may execute the running analysis program 306 by using the received exercise analysis information and may output information regarding an analysis result to the display unit thereof or the like. Alternatively, the exercise analysis apparatus 2 may transmit exercise analysis information which is analyzed and generated during running, to an information apparatus such as a personal computer or a smart phone after the user's running, and the information apparatus may transmit the received exercise analysis information to a network server via a communication network such as the Internet. The network server may execute the running analysis program 306 by using the received exercise analysis information and may transmit information regarding an analysis result to the information apparatus, and the information apparatus may receive the information regarding the analysis result and may output the information to the display unit thereof or the like. Alternatively, the exercise analysis apparatus 2 may store exercise analysis information which is analyzed and generated during running, in a recording medium such as a memory card, and an information apparatus such as a personal computer or a smart phone may read the exercise analysis information from the memory card and may execute the running analysis program 306, or may transmit the exercise analysis information to a network server which executes the running analysis program 306.

In the first embodiment, the running analysis program 306 is a program for performing whole analysis, detail analysis, or comparison analysis with other people in terms of the running user, that is, a program for managing personal running history, but, may be a program for performing whole analysis or detail analysis of running of a plurality of members, for example, in terms of a manager of a team, that is, a program for performing group management of running history of a plurality of members.

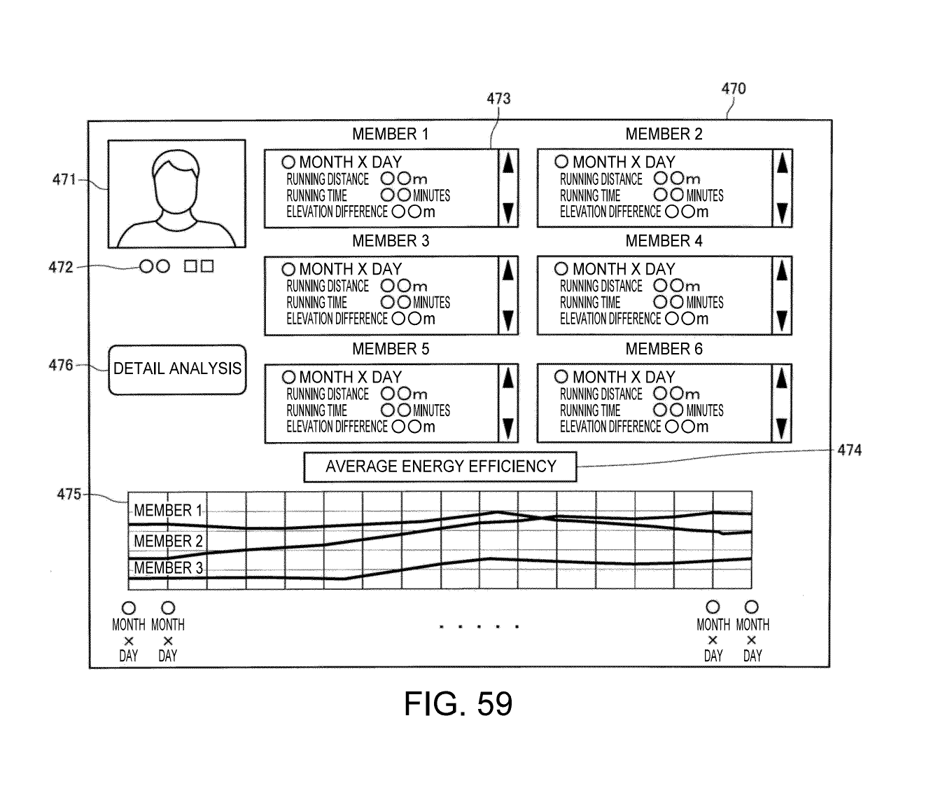

FIG. 59 illustrates an example of a whole analysis screen in a program for performing group management of running history of a plurality of members. In the example illustrated in FIG. 59, a whole analysis screen 470 (first page) includes a user image 471 and a user name 472 which are registered in advance by a user (manager), a plurality of summary images 473 which respectively display running analysis results of members on the date selected by the user, an item name 474 of an item selected by the user, a time-series graph 475 in which a selected item for a member selected by the user is displayed in a time series, and a detail analysis button 476.

The content of each summary image 473 may be the same as the content of the summary image 413 illustrated in FIG. 35. In the example illustrated in FIG. 59, the item name 474 is “average energy efficiency”, and the time-series graph 475 which has a transverse axis expressing the running date and a longitudinal axis expressing a numerical value of the average energy efficiency, and displays the average energy efficiency for members 1, 2 and 3 in a time series. If the user selects any one of the dates on the transverse axis in the time-series graph 475, a running analysis result on the selected date is displayed on each summary image 473.

The detail analysis button 476 is a button for transition from the whole analysis mode to the detail analysis mode, and if the user selects the date and a member, and performs a selection operation (pressing operation) of the detail analysis button 476, transition to the detail analysis mode occurs, and a detail analysis screen related to running on the selected date of the selected member is displayed. The detail analysis screen may be the same as the detail analysis screen illustrated in FIGS. 37 to 39, for example. A calendar image as illustrated in FIG. 36 may be displayed on the second page of the whole analysis screen.

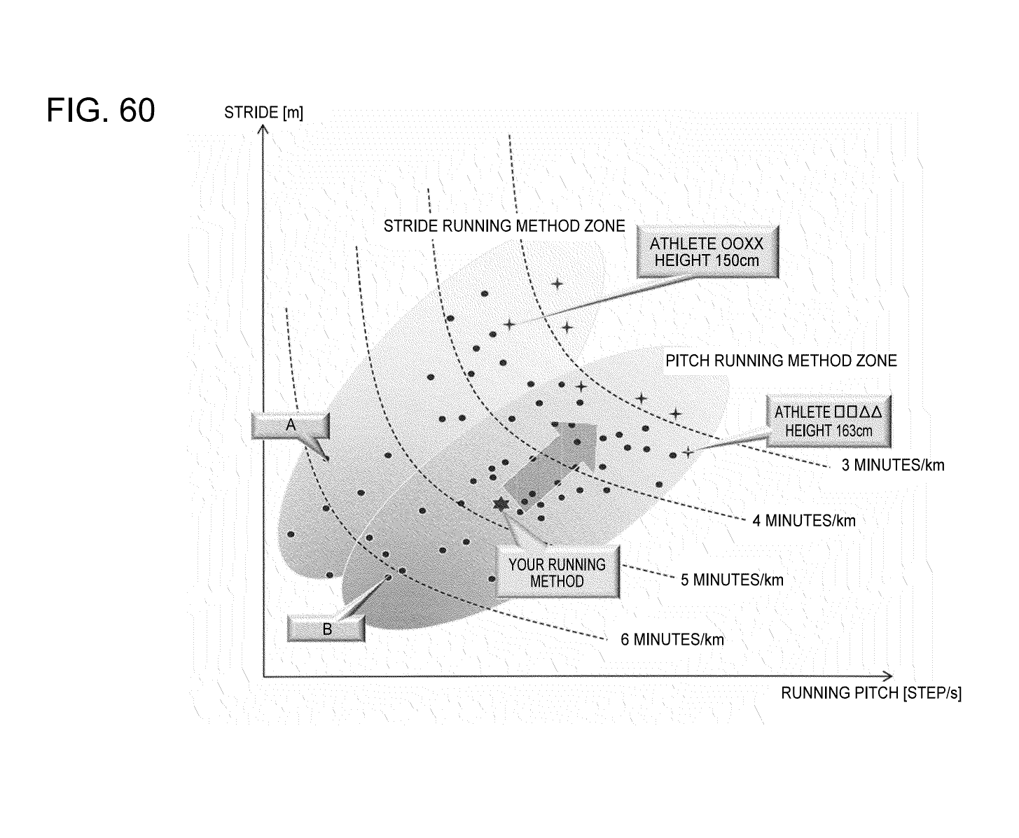

Not only the comparison analysis in the first embodiment or the modification example but also various other comparison analysis may be used. For example, FIG. 60 is a graph in which relationships between running pitches and strides of a plurality of runners are plotted, in which a transverse axis expresses a running pitch [step/s], and a longitudinal axis expresses a stride [m]. FIG. 60 also illustrates a range included in a stride running method (stride running method zone) and a range included in a pitch running method (pitch running method zone). FIG. 60 also illustrates curves corresponding to running velocities of 3 min/km, 4 min/km, 5 min/km, and 6 min/km with dashed lines. A point (shown as “your running method”) indicating a running pitch and a stride of the user is included in the pitch running zone, and a running velocity is located between 4 min/km and 5 min/km. The stride running method zone includes “A” who is slower than the user, and an athlete “XX” who is faster than the user, and the pitch running method zone includes “B” who is slower than the user, and an athlete “YY” who is faster than the user. The user can understand a running method at which the user aims by observing the graph having such running method distributions. For example, as indicated by an arrow in FIG. 60, the user can aim at a running velocity of 4 min/km or lower in the running way of increasing the running pitch and the stride without changing the pitch running method.

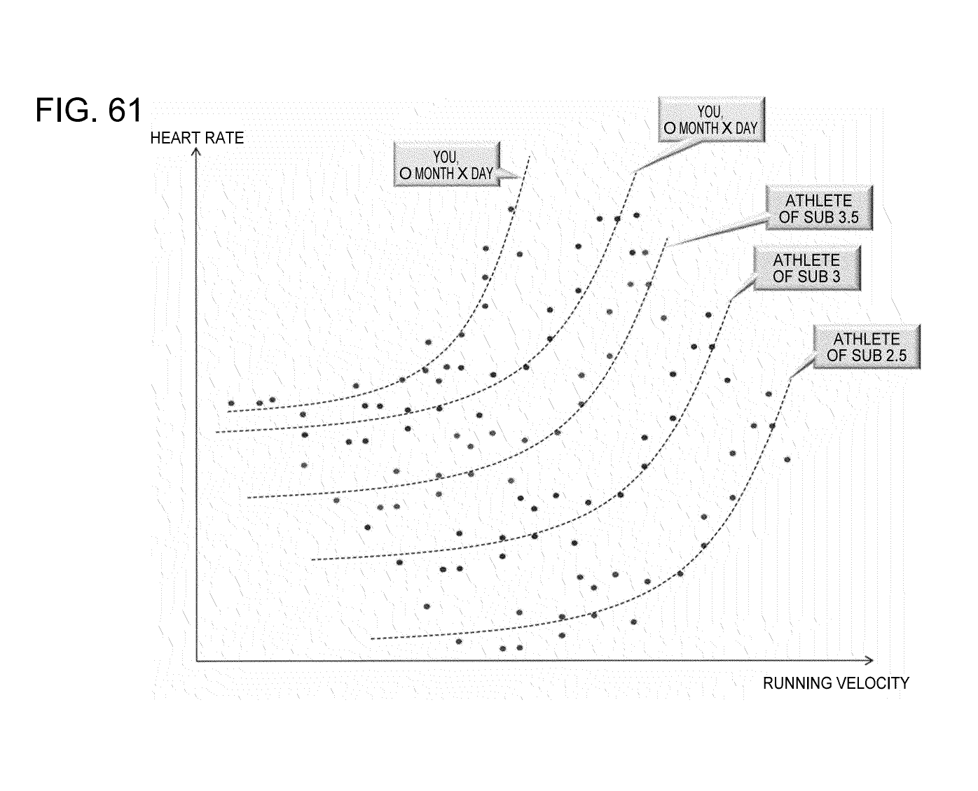

For example, FIG. 61 is a graph in which a relationship between a running velocity and a heart rate in one-time running of a plurality of runners is plotted, a transverse axis expresses the running velocity, and a longitudinal axis expresses the heart rate. FIG. 61 illustrates a curve of the user (shown as “you, 0 month X day”), a curve of athletes who run a marathon under 3.5 hours (shown as “athletes of sub 3.5”), a curve of athletes who run a marathon under 3 hours (shown as “athletes of sub 3”), and a curve of athletes who run a marathon under 2.5 hours (shown as “athletes of sub 2.5”), obtained by approximating the running velocity and the heart rate during one-time running, with dashed lines. For example, if the curve shifts to the lower right side whenever running is repeatedly performed, the user can recognize that exercise performance improves since the heart rate does not increase even if the running velocity is high, and can also understand how close to an athlete with a target time the user is.

### 3-6. Others

For example, scores of the user may be computed on the basis of the input information or the analysis information, and the user may be notified of the computed scores during running or after running. For example, a numerical value of each item (each exercise index) is divided into a plurality of stages (for example, five stages or ten stages), and a score defined for each stage. A user's score in a corresponding stage may be displayed in correlation with the item of any one of the analysis screens. For example, a score may be given or a total score may be computed according to the type of item or the number thereof with favorable attainments, and may be displayed.

In the first embodiment, an example of displaying the animation image 441 has been described, but display of animation or an image is not limited to an aspect of the embodiment. For example, animation for emphasizing a user's exercise tendency may be displayed. For example, in a case where the user's body tilts forward more than an ideal state, an image is displayed in which the user's body tilts forward with an angle which is greater than an actual forward tilt angle. The user can easily understand a user's exercise tendency. The animation image 441 may display information regarding parts other than the arm. A motion of the arm may be unlikely to be estimated on the basis of information from a sensor (the exercise analysis apparatus 2) mounted on the waist. By presenting information limited to body parts of which motions can be estimated on the basis of information from the sensor, the user can understand a user's motion more accurately. For example, a 3D image may be displayed, and the image may be checked from a desired angle through a user's operation.

In the above-described respective embodiments, the GPS unit 50 is provided in the exercise analysis apparatus 2 or the physical activity assisting apparatus 2A but may be provided in the display apparatus 3. In this case, the processing unit 120 of the display apparatus 3 may receive GPS data from the GPS unit 50 and may transmit the GPS data to the exercise analysis apparatus 2 or the physical activity assisting apparatus 2A via the communication unit 140, and the processing unit 20 of the exercise analysis apparatus 2 or the physical activity assisting apparatus 2A may receive the GPS data via the communication unit 40 and may add the received GPS data to the GPS data table 320.

In the above-described respective embodiment, the exercise analysis apparatus 2 or the physical activity assisting apparatus 2A and the display apparatus 3 are separately provided, but an exercise analysis apparatus or a physical activity assisting apparatus in which the exercise analysis apparatus 2 or the physical activity assisting apparatus 2A and the display apparatus 3 are integrally provided may be used.

In the above-described respective embodiments, the exercise analysis apparatus 2 or the physical activity assisting apparatus 2A is mounted on the user but is not limited thereto. For example, an inertial measurement unit (inertial sensor) or a GPS unit may be mounted on the user's body or the like, the inertial measurement unit (inertial sensor) or the GPS unit may transmit a detection result to a portable information apparatus such as a smart phone or an installation type information apparatus such as a personal computer, and such an apparatus may analyze an exercise of the user by using the received detection result. Alternatively, an inertial measurement unit (inertial sensor) or a GPS unit which is mounted on the user's body or the like may record a detection result on a recording medium such as a memory card, and an information apparatus such as a smart phone or a personal computer may read the detection result from the recording medium and may perform an exercise analysis process.

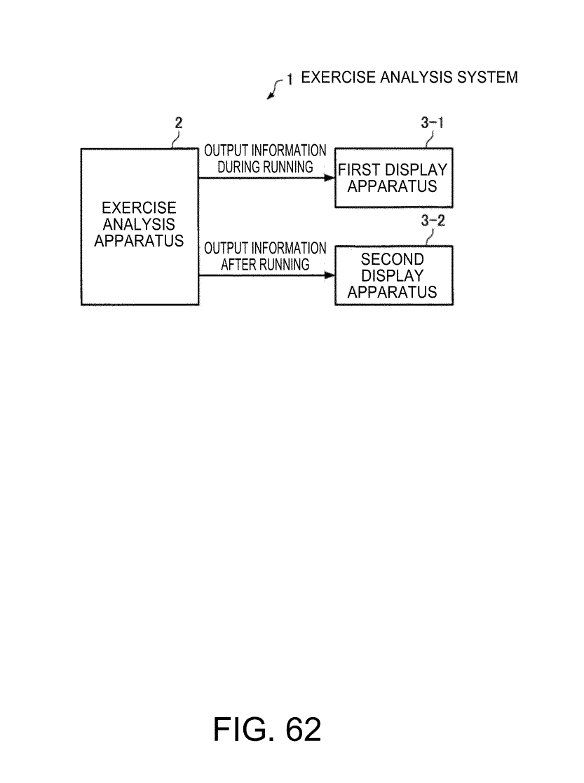

In the first embodiment, the display apparatus 3 receives output information during running or output information after running, generates data such as an image, sound, or vibration corresponding to the information, and presents (delivers) the data to the user via the display unit 170, the sound output unit 180, and the vibration unit 190. In other words, the display apparatus 3 functions as a first display apparatus which outputs the output information during running which is exercise information satisfying a predetermined condition during the user's running among a plurality of exercise information pieces of the user generated by the exercise analysis apparatus 2, and also functions as a second display apparatus which outputs the output information after running which is at least one exercise information piece after the user finishes the running among the plurality of exercise information pieces of the user generated by the exercise analysis apparatus 2. However, for example, as illustrated in FIG. 62, the first display apparatus and the second display apparatus may be provided separately from each other. In FIG. 62, the exercise analysis system 1 includes the exercise analysis apparatus 2, a first display apparatus 3-1, and a second display apparatus 3-2. A configuration of the exercise analysis apparatus 2 may be the same as the configuration of the exercise analysis apparatus 2 illustrated in FIG. 2, and each configuration of the first display apparatus 3-1 and the second display apparatus 3-2 may be the same as the configuration of the display apparatus 3 illustrated in FIG. 2. The first display apparatus 3-1 may be, for example, a wrist apparatus such as a wrist watch type, or a portable apparatus such as a head mounted display (HMD) or a smart phone. The second display apparatus 3-2 may be, for example, information apparatus such as a smart phone or a personal computer.

According to the exercise analysis system 1 illustrated in FIG. 62, during the user's running, the first display apparatus 3-1 outputs output information during running which satisfies a predetermined condition corresponding to a running state among a plurality of exercise information pieces generated by the exercise analysis apparatus 2, and thus the user can easily utilize the presented information during running. The second display apparatus 3-2 outputs output information after running which is based on some of the exercise information pieces generated by the exercise analysis apparatus 2 during the user's running, after the user finishes running, and thus the user can also easily utilize the presented information after running is finished. Therefore, it is possible to assist the user in improving running attainments.

The above-described respective embodiments and modification examples are only examples, and the invention is not limited thereto. For example, the respective embodiments and modification examples may be combined with each other as appropriate.

The invention includes the substantially same configuration (for example, a configuration having the same function, method, and result, or a configuration having the same object and effect) as the configuration described in the embodiments. The invention includes a configuration in which a non-essential part of the configuration described in the embodiments is replaced. The invention includes a configuration which achieves the same operation and effect or a configuration which can achieve the same object as the configuration described in the embodiments. The invention includes a configuration in which a well-known technique is added to the configuration described in the embodiments.

The entire disclosure of Japanese Patent Application No. 2014-157200, filed Jul. 31, 2014 and No. 2014-157202, filed Jul. 31, 2014 and No. 2015-115209, filed Jun. 5, 2015 are expressly incorporated by reference herein.

What is claimed is:

1. An exercise analysis method comprising:
analyzing an exercise of a user by using a detection result from an inertial sensor, and generating a plurality of exercise information pieces of the user during the exercise;
presenting a comparison result between at least one of the plurality of exercise information pieces and a reference value which is set in advance during the user's exercise; and
presenting at least one of the plurality of exercise information pieces after the user's exercise is finished.

2. An exercise analysis method comprising:
analyzing an exercise of a user by using a detection result from an inertial sensor, and generating a plurality of exercise information pieces of the user during the exercise;
presenting at least one of the plurality of exercise information pieces during the user's exercise; and
presenting at least one of the plurality of exercise information pieces after the user's exercise is finished,
wherein the exercise information presented during the user's exercise includes information regarding an advice for improving exercise attainments of the user.

3. The exercise analysis method according to claim 1, wherein the exercise information presented after the user's exercise is finished includes exercise information which is not presented during the user's exercise among the plurality of exercise information pieces.

4. The exercise analysis method according to claim 1, wherein the exercise information presented after the user's exercise is finished includes exercise information which is presented during the user's exercise among the plurality of exercise information pieces.

5. The exercise analysis method according to claim 1, wherein the exercise information presented after the user's exercise is finished includes information regarding an advice for improving exercise attainments of the user.

6. The exercise analysis method according to claim 1, wherein the exercise information presented after the user's exercise is finished includes information which is generated after the user's exercise is finished.

7. An exercise analysis apparatus comprising:
an exercise information generation unit that analyzes an exercise of a user by using a detection result from an inertial sensor, and generates a plurality of exercise information pieces of the user during the exercise;
an output-information-during-exercise generation unit that generates output information during exercise which is output during the user's exercise on the basis of a comparison result between at least one of the plurality of exercise information pieces and a reference value which is set in advance; and
an output-information-after-exercise generation unit that generates output information after exercise which is information output after the user's exercise is finished, on the basis of at least one of the plurality of exercise information pieces.

8. An exercise analysis system comprising:
an exercise analysis apparatus that analyzes an exercise of a user by using a detection result from an inertial sensor, and generates a plurality of exercise information pieces of the user during the exercise;
a first display apparatus that outputs a comparison result between at least one of the plurality of exercise information pieces and a reference value which is set in advance during the user's exercise; and
a second display apparatus that outputs at least one of the plurality of exercise information pieces after the user's exercise is finished.

9. An exercise analysis program causing a computer to execute:
analyzing an exercise of a user by using a detection result from an inertial sensor, and generating a plurality of exercise information pieces of the user during the exercise;
outputting a comparison result between at least one of the plurality of exercise information pieces and a reference value which is set in advance during the user's exercise; and
outputting at least one of the plurality of exercise information pieces after the user's exercise is finished.

10. A physical activity assisting method comprising:
detecting a physical activity of a user with a sensor, and performing calculation regarding the physical activity by using a detection result from the sensor;
selecting a certain advice mode from a plurality of advice modes in which determination items are set; and
determining whether or not a result of the calculation satisfies the determination item which is set in the selected advice mode.

11. The physical activity assisting method according to claim 10, wherein, in a case where the result of the calculation satisfies the determination item which is set in the selected advice mode, advice information for sending a notification of a state of the physical activity is presented.

12. The physical activity assisting method according to claim 10, wherein the plurality of advice modes include a plurality of modes in which purposes of the physical activity are different from each other.

13. The physical activity assisting method according to claim 10, wherein the plurality of advice modes include at least a mode of aiming at improving efficiency of the physical activity and a mode of aiming at energy consumption in the physical activity.

14. The physical activity assisting method according to claim 10, wherein the plurality of advice modes include a plurality of modes in which the types of physical activities are different from each other.

15. The physical activity assisting method according to claim 14, wherein the types of physical activities are the types of running.

16. The physical activity assisting method according to claim 10, wherein the certain advice mode is selected on the basis of a purpose of running and a distance of the running.

17. The physical activity assisting method according to claim 10, further comprising:
determining whether or not a state of the physical activity or the result of the calculation is abnormal by using the result of the calculation; and
presenting information indicating that the state of the physical activity or the result of the calculation is abnormal in a case where it is determined that the state of the physical activity or the result of the calculation is abnormal.

18. The physical activity assisting method according to claim 10, wherein the sensor is an inertial sensor.

19. A physical activity assisting apparatus comprising:
a calculation unit that detects a physical activity of a user with a sensor, and performs calculation regarding the physical activity by using a detection result from the sensor; and
a detection unit that selects a certain advice mode from a plurality of advice modes in which determination items are set, and determines whether or not a result of the calculation satisfies the determination item which is set in the selected advice mode.

20. A physical activity assisting program causing a computer to execute:
detecting a physical activity of a user with a sensor, and performing calculation regarding the physical activity by using a detection result from the sensor;
selecting a certain advice mode from a plurality of advice modes in which determination items are set; and
determining whether or not a result of the calculation satisfies the determination item which is set in the selected advice mode.
